(19) United States
(12) Patent Application Publication
(10) Pub. No.: US 2012/0267432 A1
(43) Pub. Date: Oct. 25, 2012

(54) SECURE PAYMENTS WITH GLOBAL MOBILE VIRTUAL WALLET

(76) Inventor: Avinash KUTTUVA, Robbinsville, NJ (US)

(21) Appl. No.: 13/533,542

(22) Filed: Jun. 26, 2012

Related U.S. Application Data
(63) Continuation-in-part of application No. 13/337,293, filed on Dec. 27, 2011.
Application No. 13/337,293 is a continuation-in-part of application No. 13/295,039, filed on Nov. 11, 2011.
(60) Provisional application No. 61/427,381, filed on Dec. 27, 2010.
(60) Provisional application No. 61/427,381, filed on Dec. 27, 2010.
(60) Provisional application No. 61/412,919, filed on Nov. 12, 2010.

(51) Int. Cl. G06Q 20/26; G06Q 20/10

(52) U.S. Cl. 235/379

(57) ABSTRACT

A mobile payment system for facilitating secure financial transactions in person-to-person, person-to-business, business-to-business, person-to-a-group-of-people, group-of-people-to-a-person, etc. using mobile and non-mobile user interfaces for online and physical points of transaction using a standard procedure for various circumstances locally and internationally. The system involves use of a specially-configured QR code which is displayed by a payee, and scanned by a payor using a specially-configured software application running on a smartphone or other computing devices. The QR code communicates a payee-identification code and instructions for initiating a payment transaction. The application interprets the QR code and processes the data contained therein to complete a payment transaction in accordance with the instructions.

### CROSS-REFERENCE TO RELATED APPLICATIONS

This application is a continuation-in-part of U.S. application Ser. No. 13/337,293, filed Dec. 27, 2011, which claims priority to U.S. Provisional Patent Application No. 61/427,381, filed Dec. 27, 2010 and a continuation-in-part of U.S. application Ser. No. 13/295,039 filed Nov. 11, 2011, which claims priority to aforementioned U.S. Provisional Patent Application No. 61/427,381, filed Dec. 27, 2010 as well as to U.S. Provisional Patent Application No. 61/412,919, filed Nov. 12, 2010, all of which are hereby incorporated by reference in its entirety.

### FIELD OF THE INVENTION

The invention pertains to electronic commerce. More particularly, the invention pertains to a method and apparatus for electronic payment for goods or services. Even more particularly, the present invention relates to the completion of financial transactions via mobile and non-mobile devices, such as a smart phone, itouch, tablet computer, etc, and, more particularly, to a mobile payment transfer infrastructure and method for transferring payment. The invention relates to a financial payment platform and more particularly to a closed-loop payment system for person-to-person, consumer-to-merchant, and merchant-to-consumer transactions.

### BACKGROUND

In traditional payment systems, a person who intends to buy and pay for an item has relied on payment instruments such as currency, checks, credit cards, or debit cards. Unfortunately, these types of payment instruments have many security issues. Fraud prevention is a significant problem and the cause of extensive losses to financial institutions. When cash is lost or stolen, there is usually no recourse but to accept the loss. With other payment instruments, loss may not be a major issue to the individual, but fraud causes significant losses for the payment industry. Credit card, debit card and check fraud continue to be major problems for the payment industry.

The reason check fraud is common at present is the difficulty in instantly verifying the account balance in a funding source account as various financial institutions are not directly connected to each other or do not have access to each other's customer account data. In addition, the use of checks exposes the account holder's personal and financial information as well as a sample of the account holder's signature, for use by criminals. When a check is accepted in a financial transaction, the funds are not guaranteed. Further, it is difficult for banks to instantly recognize a fraudulent check. Banks frequently cash a fraudulent check when presented to a bank teller. A check is simply a piece of paper that does not provide any details to validate the bank that it is drawn on or the available balance, and therefore must be separately verified together with the account and the signature that is used to authorize the payment.

With a credit or debit card, the user may not be authorized, but is still capable of using the cards for purchases until the owner or issuer realizes that his or her credit card has been stolen or compromised and has deactivated the account. Many times, the merchants end up losing the money, since most associates do not check the payer's identification documents due to fear of intimidating the customer.

An invention in this space is needed to make transactions more secure, reliable, convenient and mobile.

Although the existing payment instruments have functioned well in the past, mainly due to the fact that the card associations have been protecting the consumers by passing on losses to merchants and banks, it is clear that banks, merchants and consumers desire a simple, secure method to conduct financial transactions. The mass adoption of credit cards provides ample evidence that consumers prefer to use plastic cards rather than carry around cash or write multiple checks for small purchases. As the mobile computing capabilities and development of robust wireless network infrastructure merge, it is clear that there is an increasing desire for faster, cheaper, secure and more convenient electronic payment systems to conduct financial transactions similar to cash transactions.

There is also a great need for conducting financial transactions between individuals without having to depend on institutional assistance.

Most people have access to mobile or non-mobile computing devices, such as smart phones, tablets, computers, and similar devices. These devices have grown in capability to perform multiple functions, such as text messaging, photography, and listening to music as mobile devices have evolved to include integrated PDA, MP3, paging, player, and e-mail capabilities, which, at one point in time, required multiple devices. The computing devices that exist today not only replaced the other devices but outperformed the devices that are dedicated to specific tasks while adding convenience in many ways.

People seem to be willing and remember to carry their smart phones and other personal portable electronic devices with them, even as they forget to carry their wallets and car keys. Smart computing devices are becoming ubiquitous in the U.S. and in many countries around the world. As a result, there is a great need for a system to permit mobile phones to send and receive payment, just like cash, and provide other financial and mobile banking transactions.

There have been attempts to create a mobile payment system using cellular devices with mixed success primarily because cell phones in the past were not as sophisticated as they are today and needed additional circuit devices (or “chips”) that were used to store user account data. Also, the majority of the phones had limited features and wireless infrastructure was in its infancy, which made mobile activities inefficient and less desirable.

Credit cards use proprietary networks with high costs. The cost of a credit card transaction is also affected by the involvement of multiple parties, namely the issuer, acquirer, merchant, gateway and other marketing entities.

Merchants account holders pay high monthly service charge in addition to transaction charges to accept credit cards and provide convenience to their customers, and are left exposed to chargebacks. Many smaller merchants are unable to justify the combination of the monthly service charge and the per-transaction interchange charge. For larger merchants, the interchange fee may be tolerable but still it eats into their profits.

Credit and debit cards also expose the merchant to substantial fraud and abuse. For example, if a credit card is stolen, it may be used online or at a POS terminal by anyone wanting to commit fraud. To prevent this, many POS terminals now include a request that the consumer enter his/her postal zip code for added security. Unfortunately, postal information is not a replacement for a password and an ID theft expert is not discouraged by the additional information request to complete the transaction. However, the owner of the account is annoyed to enter the zip codes, especially since the practice is not required by every merchant.

Finally, the credit card system is not adaptable to peer-to-peer transactions and the interface is unintuitive, unlike a mobile computing payment interface that can continuously evolve to accommodate intuitive features.

A majority of e-commerce and m-commerce sites on the internet use ad hoc payment methods. For example, if a person wants to purchase coffee online, that person has to register and create an account with an online coffee merchant by entering his personal and financial information on websites. Further, this account creation process must be repeated with other vendors for other purchases. This process is inconvenient to all parties involved. The merchant must maintain a dedicated account management and payment system. The customer must establish separate accounts with numerous merchants, in addition to remembering the username and password information for each merchant's website. At present it is not possible to maintain a universal username and password as each website has different requirements. Some merchants require a username to be an email address, while others have different requirements. Some merchants require the password to have an upper case letter, while they may require at least one special character, a number, etc. Even if the customers are allowed to maintain a universal username and password in every online merchant's site, it is extremely unsafe.

Further, there are security issues since the majority of consumers have limited knowledge about the technology behind e-commerce, it is easy for frauds to create a fake or disguising websites to steal people's personal identity and financial details for fraudulent activities.

In addition to these problems, it is also more work for customers to remember or keep track of past purchases and what they paid etc., in one place for easy accessibility and reconciliation.

Due to these inconveniences, customers are often reluctant to purchase items with credit cards, debit cards, checks, ACH online or offline from smaller or relatively unknown merchants and hesitate to provide their addresses to the merchants. Even if a service is created to address this particular problem, unless the service has a wide range of other functionalities, consumer adaptability may be limited. For example, if the system only addresses the issues related to online purchases, and the consumers have to depend on a separate service to perform an offline transaction, the effort needed to utilize a service with only limited functionality becomes unjustifiable for the majority of the population who shop online only occasionally.

As technology evolves, businesses are increasingly challenged to keep up with it. The majority of businesses were brick and mortar until the year 2000. As the internet grew, the consumer started expressing a preference for doing business online. Businesses started establishing web presences. Although a majority of businesses have an online presence, not all have had this luxury.

The next area of explosive growth is the mobile internet. Consumers are showing that they prefer not only to do things online but would prefer to have the convenience of doing things on their mobile smart phones especially as a mobile application (“app”) because mobile applications are richer and more engaging than just visiting a website that is simply optimized for mobile access. Most large businesses that already have online presences are also making their services available via smart phones and mobile apps. However, the small businesses that just spent the money to establish a web presence and the other businesses who cannot afford even a web presence are frustrated. To address these issues, there is a need in the art for a mobile commerce system that alleviates these concerns and allows smaller or lesser-known merchants to compete with larger merchants, when the differentiating factor is being present where customers want to shop.

Even if every business establishes a mobile presence by creating a mobile app it is not likely that customers will install an application unless they are going to use that app multiple times every day. If someone is visiting a merchant only once, he or she is not likely to search, download and install the app and even if he/she did, he/she they would likely have to delete it soon, since the mobile device can only hold so many apps due to its limited memory for storing such apps.

Multiple credit cards, multiple debit cards, multiple store specific cards, healthcare spending accounts, gift cards, coupons, check, cash, etc. provide people with many options. However, they create too many things to carry and too many things to remember, which makes it difficult to instantly select the right funding method for each transaction, which makes everyone an owner of a stale gift card or a store credit that is forgotten forever. With the introduction of mobile payment methods, the payment instrument is much smarter and more capable than the conventional non-interactive payment instruments and has the capability to solve this problem.

What is needed is a mobile smart wallet app that integrates customized commercial application for businesses around the world that can be instantly accessed on-demand.

### SUMMARY

One aspect of the present invention (sometimes referred to herein as Payintele or the Payintele system) is a compelling alternate payment tool that addresses security flaws associated with existing payment methods such as credit cards, checks, cash and also upcoming technologies such as NFC's and card scanners.

Payintele users can store their encrypted banking and credit card information (in third party payment processing companies that are linked to Payintele servers) and make personal and business transactions with minimal effort.

The system is designed to prevent exposure of financial or personally identifying information of the paying parties to the receiving parties. This, by itself, has the potential for eliminating or significantly reducing fraudulent activities in addition to significantly reducing the time and steps required to process payments. The users may authorize each transaction with a PIN (Personal Identification Number). Merchants may receive payment notification along with a picture of the payor for payor identification and verification purposes.

Aspects of the present invention include:

(a) Hardware—No additional hardware other than common personal accessories already owned by the majority of the population, such as smart phones, tablets or similar devices with camera interfaces, and business/personal computers with internet connectivity.

(b) Software—Free mobile and desktop applications for individuals and businesses available for download via the internet, app stores and market place.

(c) Adding money to Payintele accounts (preloading)—In order to use some services, users need to have money in their account. The invention offers various methods to users to preload funds to their Payintele accounts. This includes via credit card, bank account and payments from other users.

(d) Withdrawing money from Payintele accounts—It is expected that users, especially businesses, will wish to move their money from their Payintele account to their bank accounts. This is facilitated by ACH. There is no cost for this transaction.

(e) A consumer mobile application that enables users to access their account details, such as account balance, real time payment notifications, real time alerts, send and receive payments to and from other users (both businesses and consumers), control and manage account settings, add friends, conduct financial interactions, review payment activities, keep users engaged in their day-to-day financial activities and allow the user to be in full control of their finances.

The problems that this invention addresses include providing an alternate to carrying cash, functional versatility compared to the non-interactive credit cards and checks, facilitation of transactions in a secure manner, and prevention of exposure of personal and financial data.

The present invention can provide a consistent method to make payments across various situations, locally and internationally.

The present invention can provide a mobile wallet that helps the user to select the most appropriate source to fund each transaction.

The present invention can provide a method that integrates consumer's mobile wallets and customized commercial business interface in a universal mobile application.

Other features and benefits of the invention will be apparent from consideration of the description and drawings herein.

The Payintele system may allow users to make payments consistently in various circumstances as follows.

| Circumstance | Payment procedure |
|---|---|
| Peer to peer | scans . . . select/verify transaction parameters and |
| static QR code | protocols . . . execute transaction |
| Retail checkout | scans . . . select/verify transaction parameters and |
| counter static QR | protocols . . . execute transaction |
| code | |
| Retail self-checkout | scans . . . select/verify transaction parameters and |
| static QR code | protocols . . . execute transaction |
| Retail Payintele | scans . . . select/verify transaction parameters and |
| checkout static | protocols . . . execute transaction |
| QR code | |
| custom-module | |
| Restaurant - dine in | scans . . . select/verify transaction parameters and |
| static QR code | protocols . . . execute transaction |
| Restaurant - take out | scan . . . select/verify transaction parameters and |
| static QR code | protocols . . . execute transaction |
| Restaurant Payintele | scan . . . select/verify transaction parameters and |
| order | protocols . . . execute transaction |
| static QR code | |
| Custom module | |
| Invoice sent to | scans . . . select/verify transaction parameters and |
| customer static | protocols . . . execute transaction |
| QR code | |
| Scheduled and | Payment request received . . . select/verify |
| recurrent payments | transaction parameters and protocols . . . execute |
| Transaction | transaction |
| automatically | |
| initiated according to | |
| schedule | |
| Payments on delivery | scans . . . select/verify transaction parameters and |
| static QR code | protocols . . . execute transaction |
| Payintele order for | scans . . . select/verify transaction parameters and |
| delivery | protocols . . . execute transaction |
| static QR code | |
| custom module | |
| Payment for in home | scans . . . select/verify transaction parameters and |
| service static QR code | protocols . . . execute transaction |
| In-flight payment | scans . . . select/verify transaction parameters and |
| static QR code | protocols . . . execute transaction |
| Garage sale | scans . . . select/verify transaction parameters and |
| static QR code | protocols . . . execute transaction |
| Farm market | scans . . . select/verify transaction parameters and |
| static QR code | protocols . . . execute transaction |
| Gas station | scans . . . select/verify transaction parameters and |
| static QR code | protocols . . . execute transaction |
| Vending machine | scans . . . select/verify transaction parameters and |
| static QR code | protocols . . . execute transaction |
| custom module | |
| Online checkout | scans . . . select/verify transaction parameters and |
| dynamic QR code | protocols . . . execute transaction |
| Drive thru | scans . . . select/verify transaction parameters and |
| static QR code | protocols . . . execute transaction |
| shopping from printed | scans . . . select/verify transaction parameters and |
| material static QR | protocols . . . execute transaction |
| code custom module | |
| Shopping on television | scans . . . select/verify transaction parameters and |
| static QR code | protocols . . . execute transaction |
| custom module | |
| Shopping from | scans . . . select/verify transaction parameters and |
| billboard ads | protocols . . . execute transaction |
| Static QR code | |
| Custom module | |
| Airport cart vending | scans . . . select/verify transaction parameters and |
| machine static | protocols . . . execute transaction |
| QR code | |
| Online selling | . . . select/verify transaction parameters and |
| static QR code | protocols . . . execute transaction |
| optional custom | |
| module | |
| Online auctions | scans . . . select/verify transaction parameters and |
| static QR code | protocols . . . execute transaction |
| custom module | |

### BRIEF DESCRIPTION OF THE DRAWINGS

FIG. 1 is a series of exemplary screen shots of a user interface for the payment process in accordance with an embodiment of the Payintele system.

FIG. 2 shows how the account balance of any user may be displayed via a web browser in accordance with an embodiment of the Payintele system.

FIG. 3 shows a view of a web interface displaying the details of foreign currencies in accordance with an embodiment of the Payintele system.

FIG. 4 shows a view of a web interface displaying details of friends and sharing properties in accordance with an embodiment of the Payintele system.

FIGS. 5-10 show a series of graphical user interfaces for sharing funds with others including selecting a friend, selecting available funds, selecting denomination, setting limits and authorizing sharing setup in accordance with an embodiment of the Payintele system.

FIG. 11 shows a graphical user interface for a “mouse over action” relating to funds available in foreign currencies in accordance with an embodiment of the Payintele system.

FIG. 12 shows a detailed web view of foreign currencies and the interface that gives the users an option to convert the foreign currencies to the user's local currency in accordance with an embodiment of the Payintele system.

FIG. 13 shows a summary of the foreign currency conversion details with applicable fees in accordance with an embodiment of the Payintele system.

FIG. 14 shows results of the foreign currency conversion in accordance with an embodiment of the Payintele system.

FIG. 15 shows the updated details of available foreign currency. (following the currency conversion transaction) in accordance with an embodiment of the Payintele system.

FIG. 16 shows the updated details of available funds (following the currency conversion transaction) in accordance with an embodiment of the Payintele system.

FIG. 17-19 shows the Web Interface for a user to check the value of his funds in different foreign currencies in accordance with an embodiment of the Payintele system.

FIG. 20 shows the Mobile Payment Interface when used to make a payment at a foreign business in accordance with an embodiment of the Payintele system.

FIG. 21 shows the Mobile Payment Interface when used to make a payment at a foreign business.

FIGS. 22-24 show a series the Mobile Payment Interfaces by which a user can easily override the default funds selected by the Mobile Payment App in accordance with an embodiment of the Payintele system.

FIG. 25 shows the Mobile Payment interface when used to make a payment at a particular business in accordance with an embodiment of the Payintele system, in which the Mobile Payment App auto selects the funds most appropriate for the transaction without any effort from the user.

FIG. 26 shows the business interface with available custom modules in accordance with an embodiment of the Payintele system.

FIGS. 27-33 show a series of graphical user interfaces demonstrating how a custom module is created by the business owner in accordance with an embodiment of the Payintele system.

FIG. 34 shows the details of the custom module with the QR code that is specific for that businesses custom module in accordance with an embodiment of the Payintele system.

FIG. 35 shows how a business may use the custom module QR code (in this example) FIG. 35-A A restaurant embeds the custom module QR code on their menu. FIG. 35-B The QR code is installed by the counter so that it can be scanned by the customers with Payintele App. FIG. 35-C, D, shows the Mobile ordering interfaces of the Custom Module and FIG. 35-E, F shows the payment interfaces that proceeds after the customer completes the ordering process.

FIG. 36 shows a Conceptual Mobile Interface series of a Custom Module designed to enable shopping, paying in the aisles, checking out of retail stores and an easy way for the associates to monitor shoppers using this method to shop and pay in accordance with an embodiment of the Payintele system.

FIGS. 37-38 show screen shots of ecommerce sites and how the Mobile payment app can be used to make online payments in accordance with an embodiment of the Payintele system.

FIG. 39 is a flow chart of payment process in a variety of examples demonstrating the payment process can be completed in a consistent manner in accordance with an embodiment of the Payintele system.

FIGS. 40-106 show the conceptual web interfaces for many additional functions in accordance with an embodiment of the Payintele system.

### DETAILED DESCRIPTION

The main objective of the Payintele payment system is to facilitate a secure, convenient and reliable payment platform that people can use on-the-go to accomplish various financial tasks. The financial tasks include sending money to and receiving money from other users of the Payintele system, making payments to businesses for purchases and services, generating notifications and alerts pertaining to the users' financial activities, real time account activity updating, checking balances, functioning as a mobile wallet, adding and withdrawing funds to and from the wallet, assembling all liquid financial assets in local and international denominations, in one place to manage them more efficiently, prevent exposure of personal and financial data, and provide peace of mind to its users.

Exemplary embodiments of the present invention are discussed below with reference to the Figures, for illustrative, and not limiting, purposes.

The present invention relates to a computer system comprised of hardware and software infrastructure that acts as a platform by which users can connect using their mobile devices and a client application that is executed in their devices.

User Registration

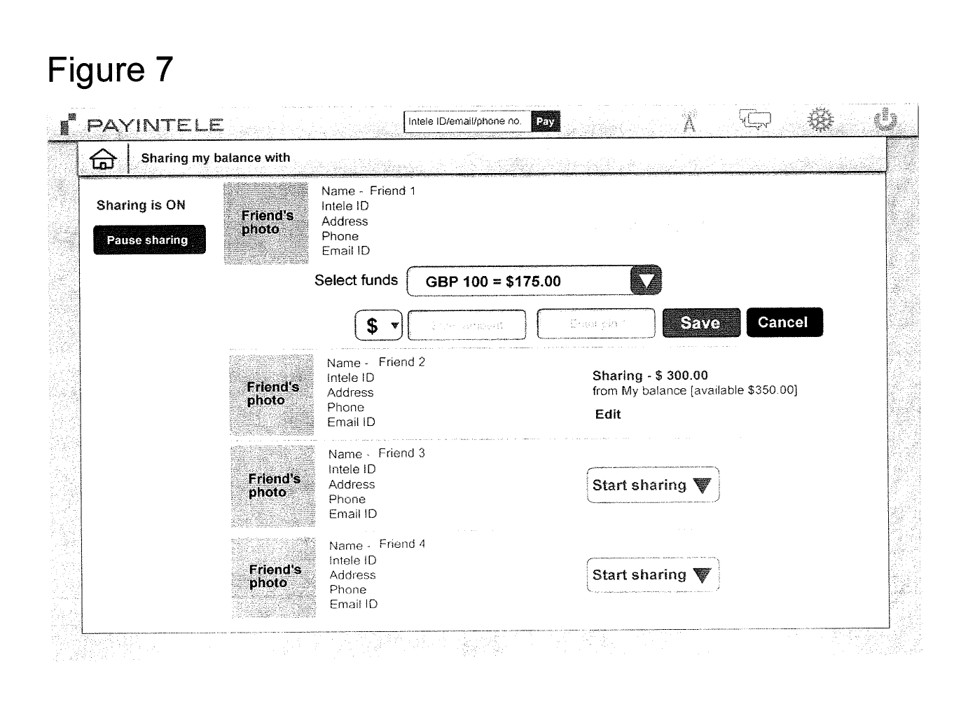

New users who wish to use the Payintele payment system to either send or receive payments must first register as a user of the system. New users can enroll to use the Payintele system by using a web or other interface to create user accounts by registering themselves and creating their usernames, passwords and PIN codes by visiting the Payintele website, e.g., via the Payintele software application, which may be downloaded, for example, to a smartphone, tablet PC or the like, as known in the art. New users may have limited privileges, such as an associated dollar limit for transactions (see FIG. 7). Users may upgrade their accounts by confirming their identity, by going through an ID verification process and/or taking the challenge to prove that the user is, in fact, the owner of the bank account through an instant account verification process or micro-deposit method.

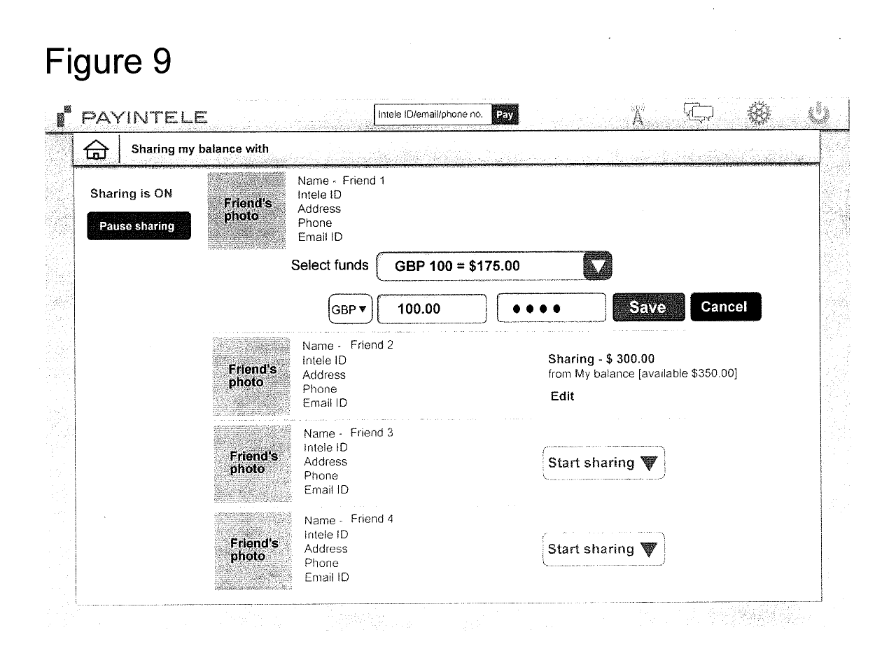

Each user may access his or her account control panel (FIG. 9, first screen) through an application that is executed on a compact mobile device, such as a smartphone and from web browsers of mobile and non-mobile computing devices, such as computers, tablets and other devices connected to the internet.

The Payintele application will allow users to perform actions similar to those they perform with their traditional wallet or pocketbook. Since users carry their phones with them all the time, users may have fewer reasons to carry their normal wallets. Users can send and receive money anytime and anywhere they wish and do much more than what they are used to in the past. Users will be able to make payments for services and purchases, split lunch expenses, chip in for office parties, send cash gifts, send or receive money in case of emergency instantly from friends and family, add money from credit cards or bank accounts to pay an individual or merchant that does not accept credit cards due to high merchant account costs, withdraw money from their Payintele accounts to their banks, etc.

### Mobile Payment Interface

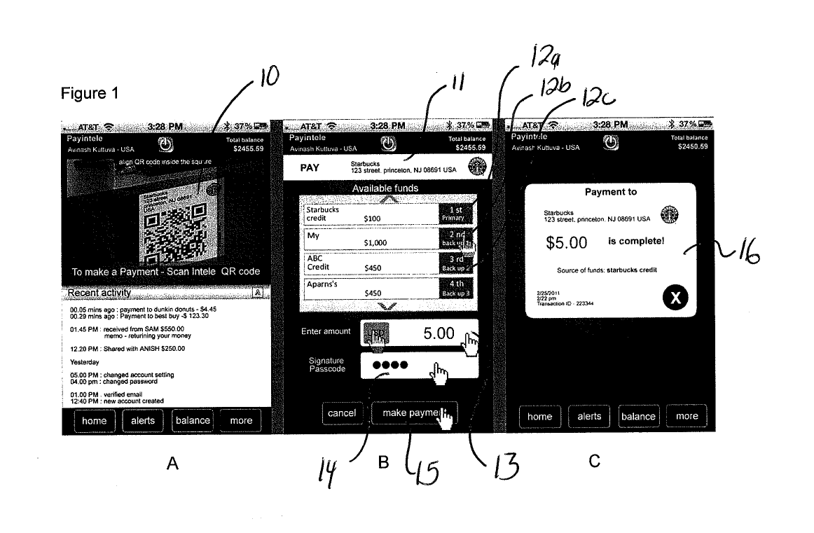

Referring now to FIG. 1, a series of screen shots A, B, C of an exemplary Payintele mobile wallet app displaying exemplary graphical user interface windows displayable on a smartphone or other computing device as part of the Payintele app are shown for illustrative purposes. A typical payment process includes merchant selection, funds selection, entering payment amount, authorization and payment confirmation.

In this example, use of the system involves a retailer or other payee displaying a code for use within the system. The code uniquely identifies the user with the system in a manner, which, by itself, is not sufficient to infer any other information about the user or the user's payment information. Rather, the code need only uniquely identify the payee. Accordingly, the code may be static and reusable, and may be displayed publicly and disseminated widely, without compromising financial security.

In this exemplary mobile payment system, the code is a QR-type two-dimensional bar code. The QR code is generated by or on behalf of an operator of the Payintele system. The QR code may be created using conventional QR code creation technology well-known in the art. Preferably, a unique QR code is created for each user (business and personal) of the Intele payment system, although they are required only for receipt of payments by payees. The QR code is specially-configured in accordance with the present invention to store (and communicate when scanned) the payee's account number for payment purposes. Further, each QR code is specially-configured in accordance with the present invention to store (and communicate when scanned) an instruction set for the Payintele app used by the payor. The instruction set is configured to communicate to the Payintele app information about the type of transaction that needs to be performed by the Payintele app when it is scanned.

For business users, in addition to the Payintele account number, the QR code may also store the business address, telephone number, email, web site etc. Alternatively, such information may be retrieved from the Payintele server after the QR code is scanned. Details of instructions (commands) stored in the QR code to execute a specific transaction are discussed below. For personal users, the QR code may also store other identifying information, such as a facial photograph of the payor, which can be used for identification purposes.

The QR code is displayed by a payee who wishes to receive payments via the Payintele system. By way of example, a certain retail store's QR code may be displayed on a placard or sign at the retail store, as part of a video or commercial, on a print advertisement or product packaging, or on any other suitable medium such that the QR code may be used by payors for the payment purposes described herein.

A transaction can be initiated by a purchaser (payor) using any imaging-device (e.g., camera)-equipped computing device, such as a smartphone, running the Payintele payment app. While executing the app, the payor may initiate a transaction by scanning the QR code displayed by the payee. Such scanning typically involves operation of the computing device to take a digital photograph of the QR code, or simply pointing the device's camera at the QR code so that it is viewable within a viewing window of the app. Screen shot A of FIG. 1 shows a user interface field showing a digital image of a QR code 10 displayed via a computing device's camera. The QR code contains not only the payee's account number but also instructions/commands to tell the payor's Payintele app to proceed to a suitable next step for tendering payment to the payor.

Alternatively, the transaction may be initiated by the payor by manually entering the payee's Payintele account number in the appropriate field of the Payintele app. By way of example, the Payintele account number may be displayed by the payee or communicated to the payor in similar or other suitable manners. FIG. 99 shows an exemplary QR code 22 displayed on a placard 20 along with an associated Payintele account number 24.

In a retail establishment, it may be advisable to treat each cash register/check-out terminal as a unique payee identified by a unique scannable code (although multiple payees may be linked to a common bank account, etc.) for purposes described herein. FIG. 100 shows an exemplary QR code 22a displayed on a placard 20 along with an associated Payintele account number 24a. The use of terminal-specific QR codes and/or account numbers allows for direct communication of confirmatory messages directly to a specific terminal, as described further herein.

Since the QR code that was scanned in FIG. 1A is configured to cause acceptance of payments from the payor (operating the computing device) to the payee (displaying the QR code), the app proceeds to the next screen, B, in which payment details may be entered by the payor. The screen preferably displays the payee's name and address 11 so that the payor can verify the payee's information.

Screen B, FIG. 1, is configured to allow for selection of a funding source and a payment amount. In a preferred embodiment, the Payintele app is configured with predefined logic to identify and present a list of alternative funding sources, preferably in a preference-ranked order. This logic is built in to the Payintele app, but any suitable logic may be used. For example, the logic may check to see if the payor has any store credit at the payee's establishment, and to recommend such store credit as a most highly-preferred funding source if available. Coupons/vouchers, a store-specific credit card, non-specific credit cards, bank accounts in the same country/currency, bank accounts in other countries/currencies may also be listed, is a predetermined preference order.

The app may be further configured to automatically select, in accordance with predefined logic, the most preferred funding source 12a that is appropriate to complete the transaction, and to display the most preferred funding source as the most highly-ranked, and/or first-listed, funding source in a list of funding sources. However, the app may be further configured to permit the payor o override the app's recommendation and select a different funding source 12b, 12c for completion of the transaction by scrolling down until the preferred source can be selected, by clicking on the buttons labeled 1st, 2nd, 3^{rd}, etc. If the payor wishes to use the funding source selected by the application, the user may simply proceed to complete the transaction without making any changes. The available funding sources may be pre-identified and pre-stored as part of establishment of the payor's user account, after which the payor need not enter account information, etc. in connection with each payment transaction.

The payor may then enter a payment amount into an amount window 13 of the app. The entered payment amount will be deducted from the selected payment source and the associated funds will be transferred to the payee/merchant identified by the QR code, e.g. after entering a confirmatory passcode, as shown in window 14, and/or selecting an appropriate button 15 to initiate the payment. The Payintele app communicates with a payintele back end server and/or suitable banking, credit card, ACH and/or other payment processing systems to effect the necessary payment transfers, as discussed below. After completion of the payment, a confirmatory message 16 may be displayed to the payor via the payor's computing device.

Additionally, a corresponding Payintele payment notification application may be running on the cash register and/or companion hardware (such as a smartphone, tablet PC, etc.) associated with the cash register/terminal or the retail store, etc. For example, each cash register may be assigned a unique QR code, so that a message confirming receipt of payment from the payor by the payee may be displayed at the associated cash register/companion hardware, so that the store's clerk knows when the payment transaction has been completed and that the purchased goods should be delivered to the purchaser/payor, etc.

Funding Sources

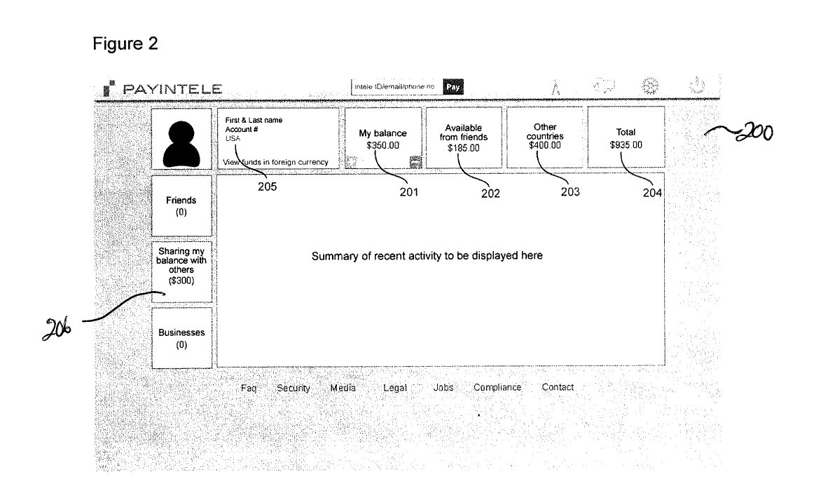

A user may have various accounts that hold currencies of many different countries. The user may also have access to funds from other users across the globe that share their funds. FIG. 2 shows how the account balance of any payor may be displayed in a web browser window 200 in accordance with an embodiment of the Payintele system. By way of example, the account balance may be displayed in the payor's home country's currency and can be switched to local currency while roaming in different countries for convenience.

The My Balance window 201 shows the total of: Money preloaded by the user from external accounts such as credit cards and bank accounts, etc.; and Money received from other Payintele users.

The Available from Friends window 202 shows the total amount of money available from other Payintele users (father, mother, brother, husband or friends etc.) The availability of this balance is controlled by the owners of the funds and is subject to availability in the friend's Payintele accounts.

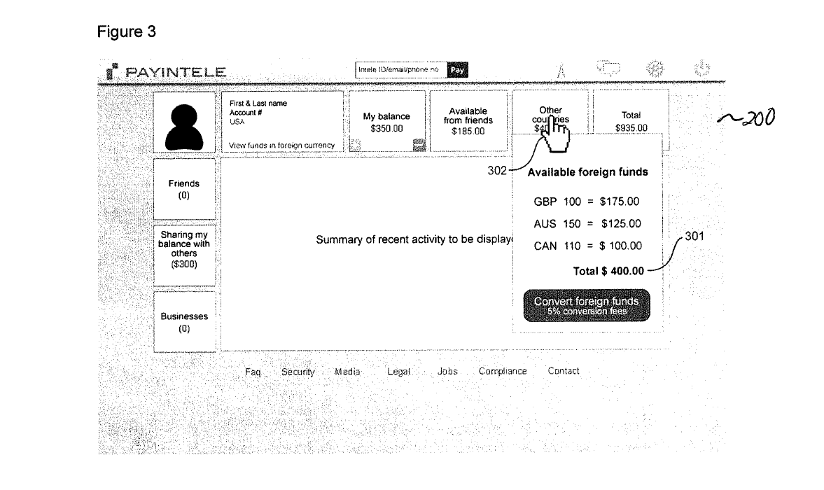

The Other Countries window 203 shows the total of all foreign currencies that is available to the user in the user home country's currency. The user may also share foreign funds with other users. Users may hover over the “other countries” window 203 to obtain a snapshot of various foreign currencies and the respective amounts, as shown at 301 in FIG. 3. The total window 204 sows the total from the multiple funding sources.

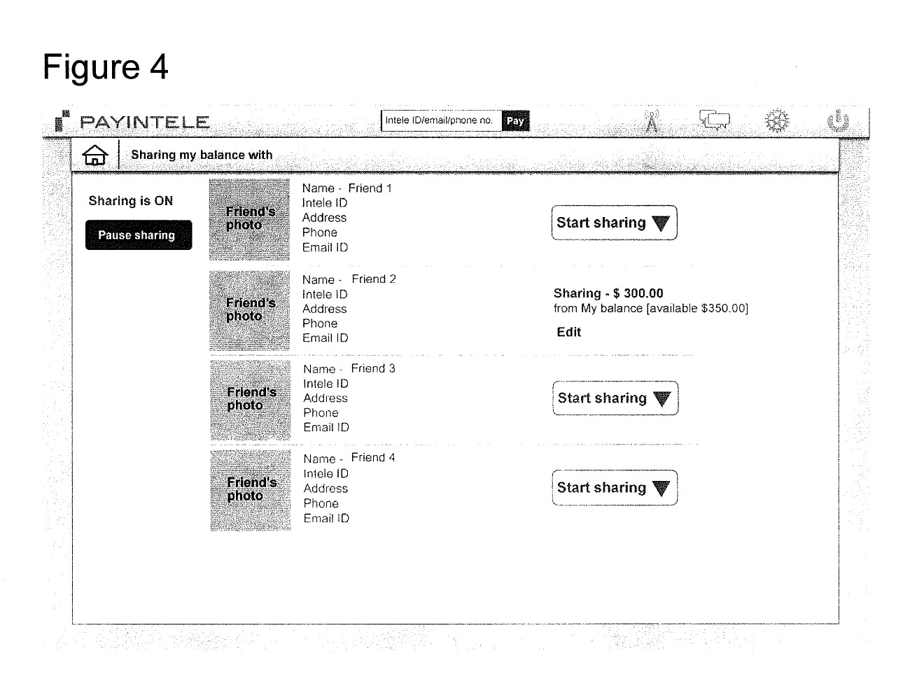

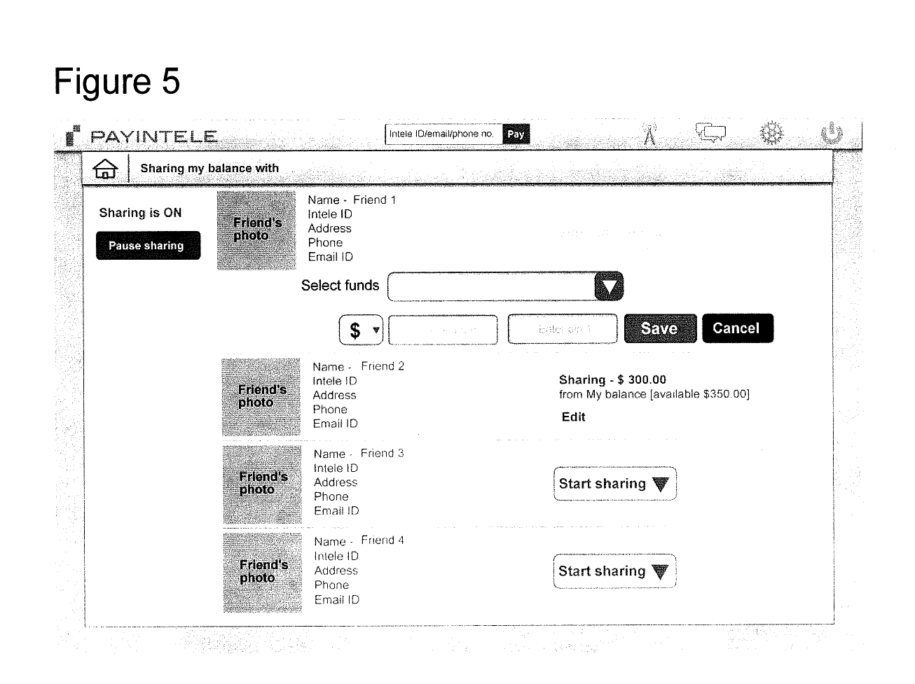

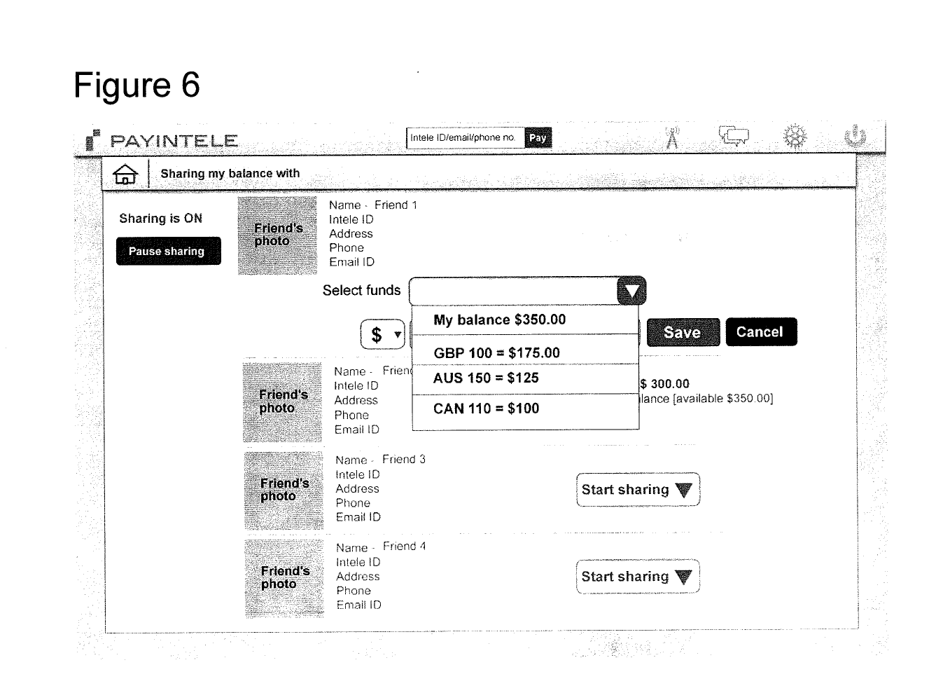

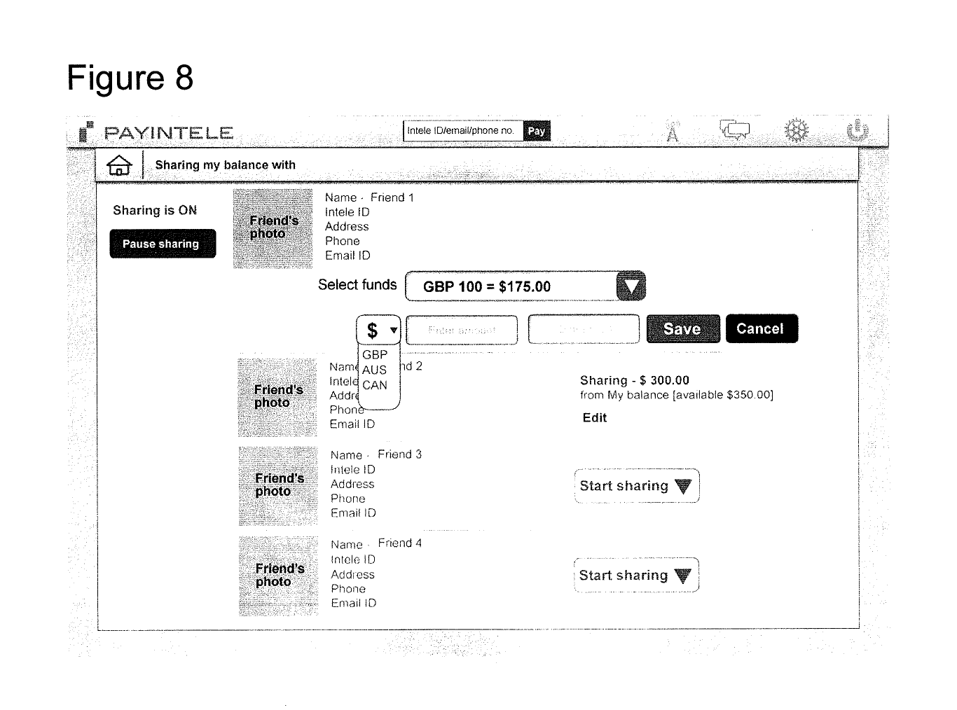

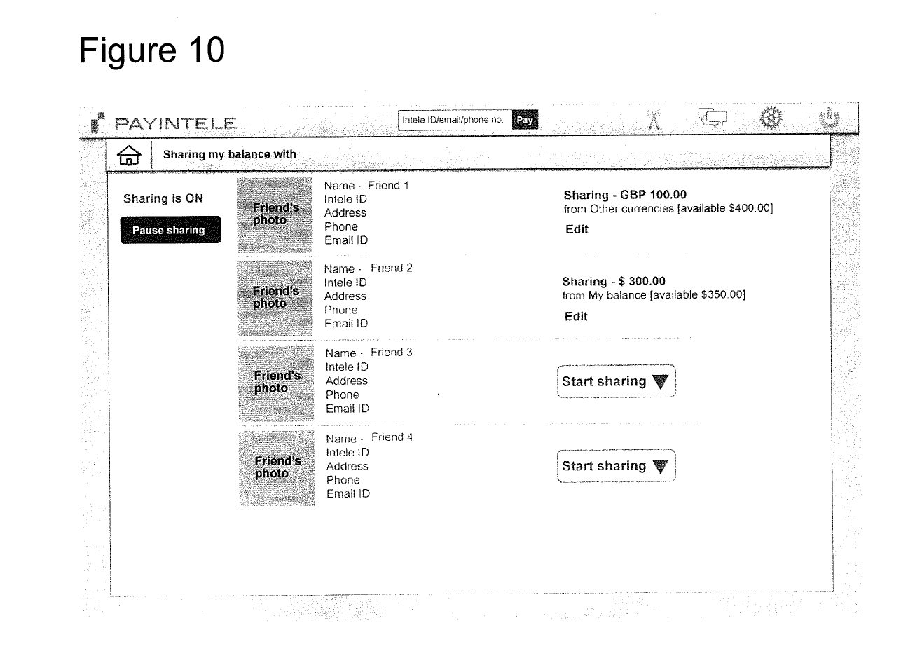

The Sharing My Balance With Others button 206 allows users/payors to see a more detailed view and options available to manage these funds. For example, selection of this button 206 allows a user to share a specific (shown in the following images) or all foreign currency with a friend. This may be performed by navigating user interface windows shown in FIGS. 4-10 to select a friend/person for receiving shared funds (FIG. 4), and specifying a shared funding source, amount and currency (FIGS. 5-10). These shared amounts become available for use to make payments using the Payintele app by the recipients of the shared funds.

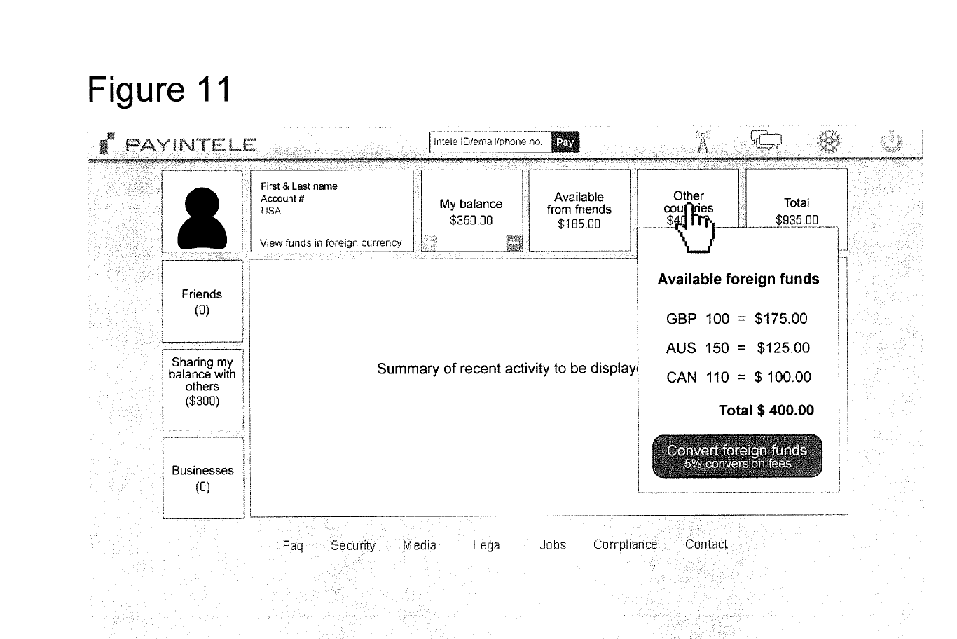

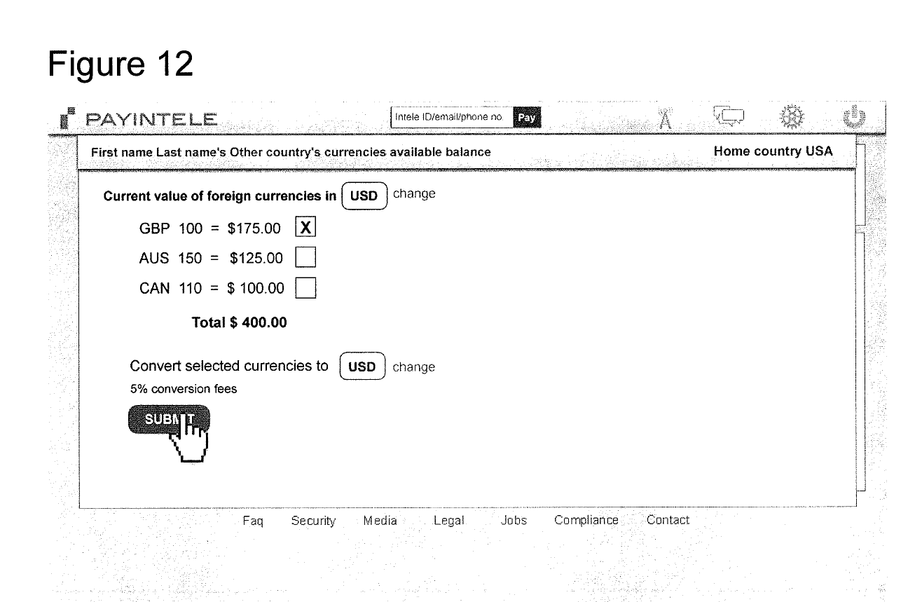

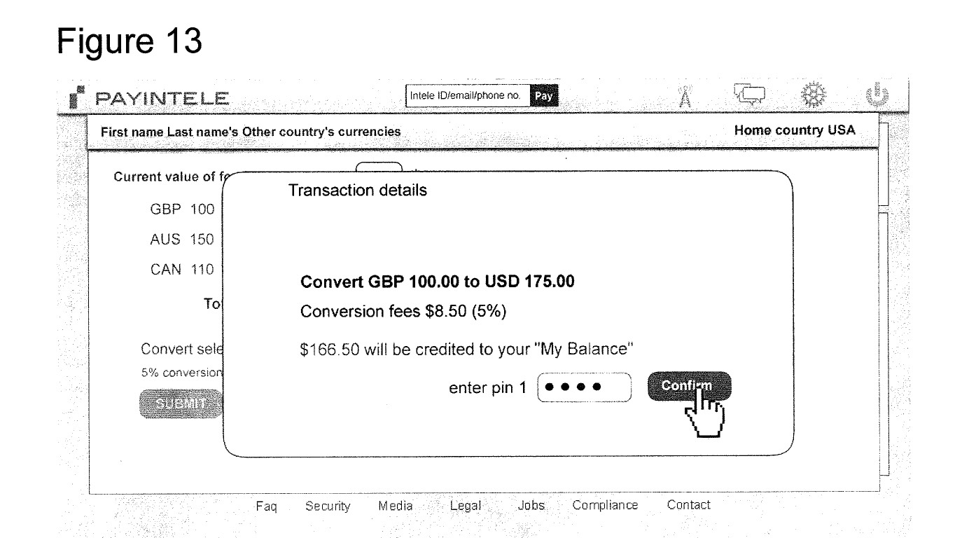

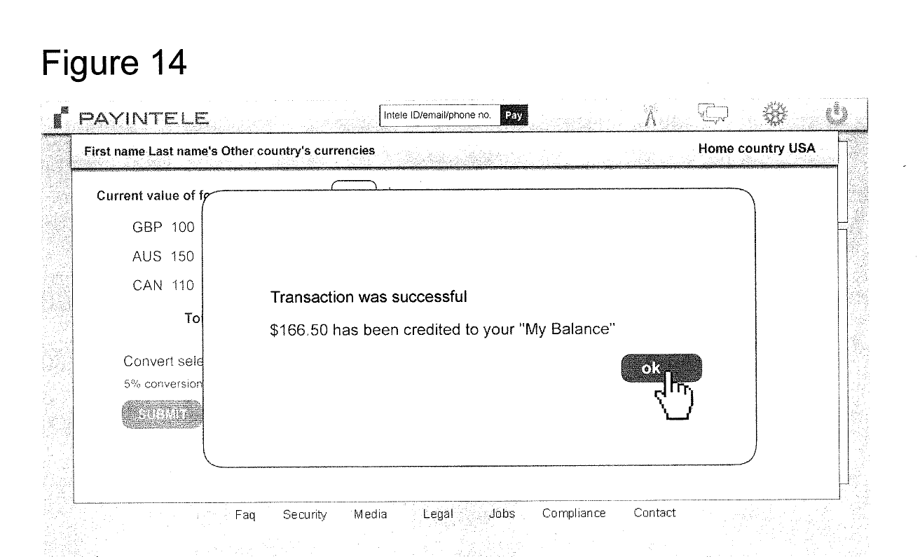

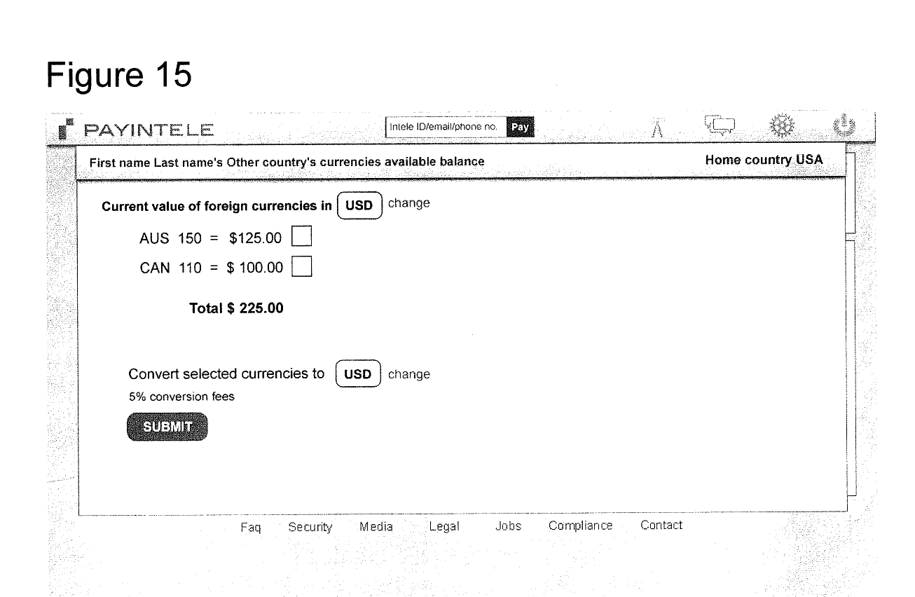

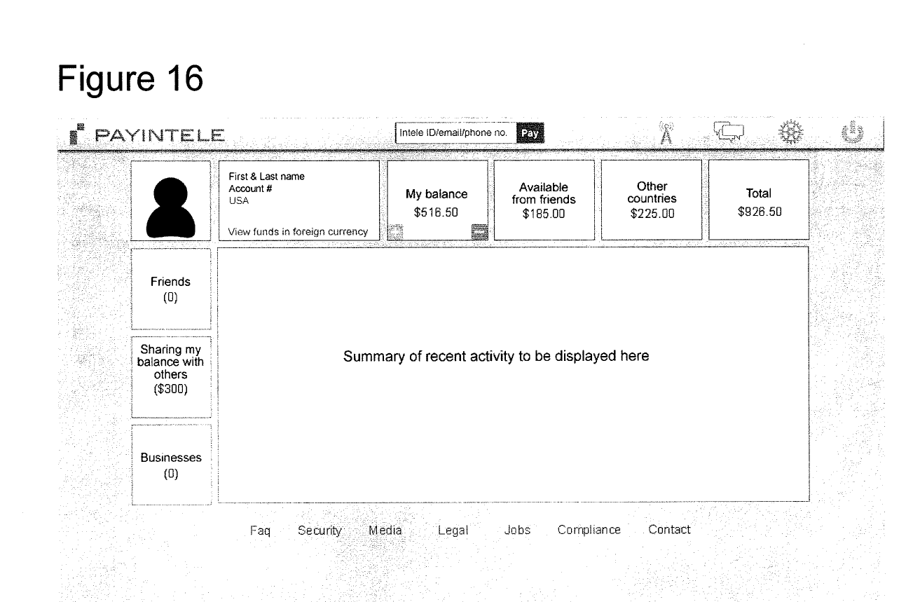

The Sharing My Balance With Others button 206 also allows a user to convert a specific or all foreign currency to a users' home country's currency by navigating and providing input via associated user interface windows, as shown in FIGS. 11-16.

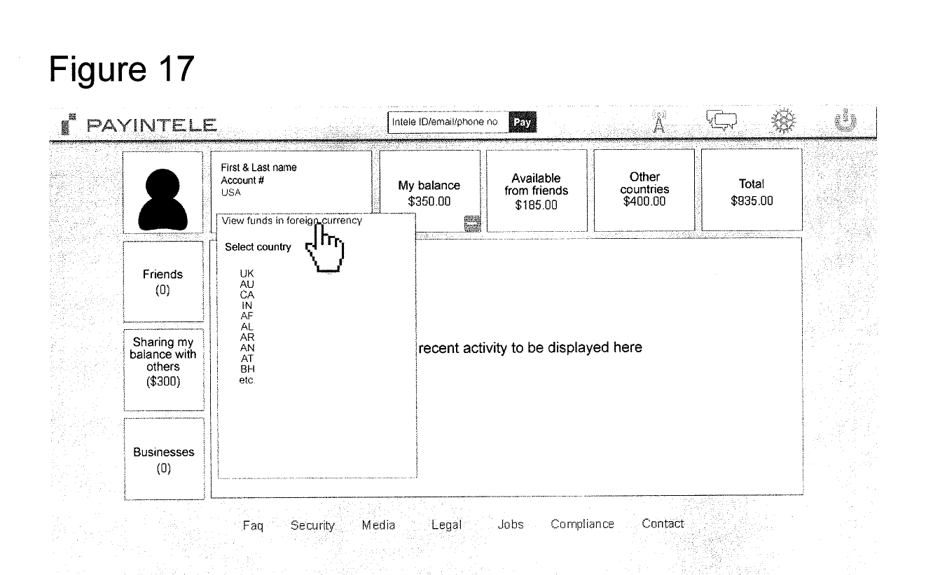

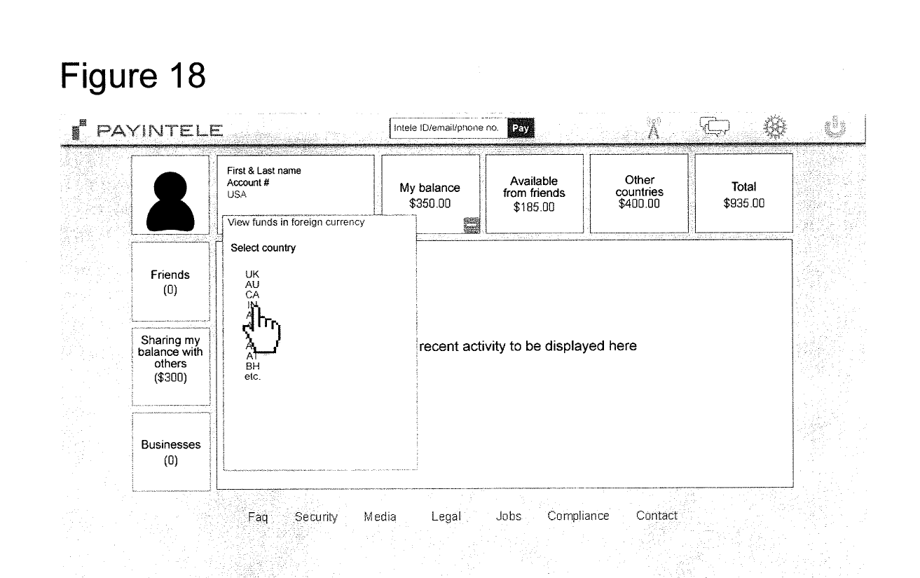

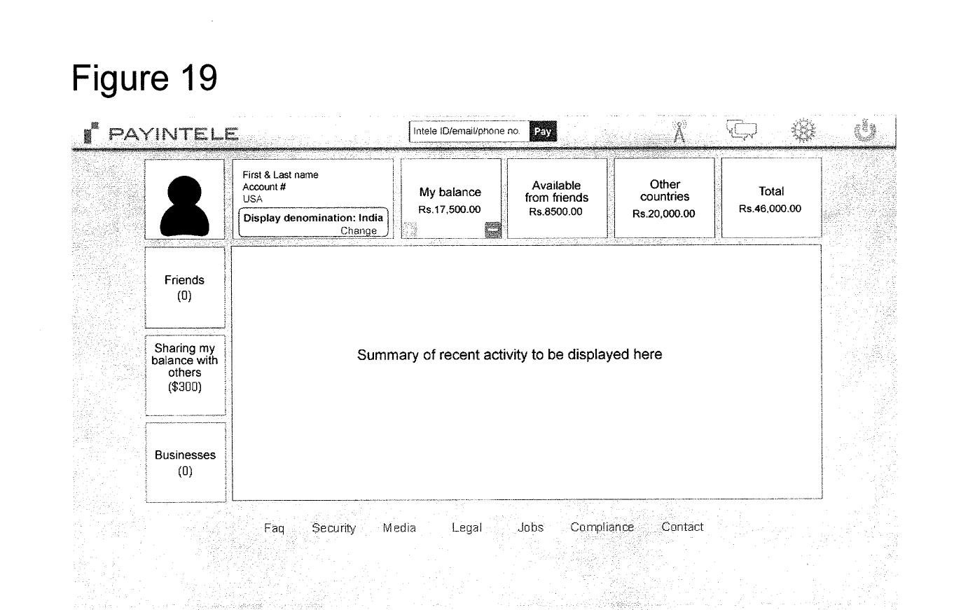

The View Funds in Foreign Currency button 205 allows a user to navigate user interface windows and to provide input to view the account balances in different countries denomination, as shown in FIGS. 17, 18 and 19. While a user travels to a foreign currency, it is convenient to see the account balances in the destination countries.

### Seamless Payment Across the Globe

The Payintele mobile wallet app is further designed to allow users to not only store different currencies but is also designed to make payments across the globe even if only a single county's currency is available in the user's wallet.

As discussed earlier, the Payintele mobile payment app will consider multiple factors and identify a preferred funding source from among the various available funding sources, for each transaction.

By way of example, the app may consider one or more of the following factors:

a) payee business information;
b) payee location details;
c) currency denomination accepted by the payee;
d) funding sources available in the payor's account;
e) available store credits;
f) available coupons;
g) funding denominations available in the payor's account;
h) payor's location;
i) payor's home country; and
j) transaction amount.

When a user initiates a transaction with a foreign business, the app may recognize the home country of the business from the Payintele account number (Payintele ID) of the business as soon as the payor scans the payee's Payintele QR code or enters the payee's Payintele account number. Once this information has been obtained, the application searches the available funding sources in the customer's Payintele account. If there is a matching funding source in a currency matching the payee's home country, the app suggests this funding source to the customer as the first choice, in addition to checking and presenting any coupons or store credits that may be available if it matches the business profile.

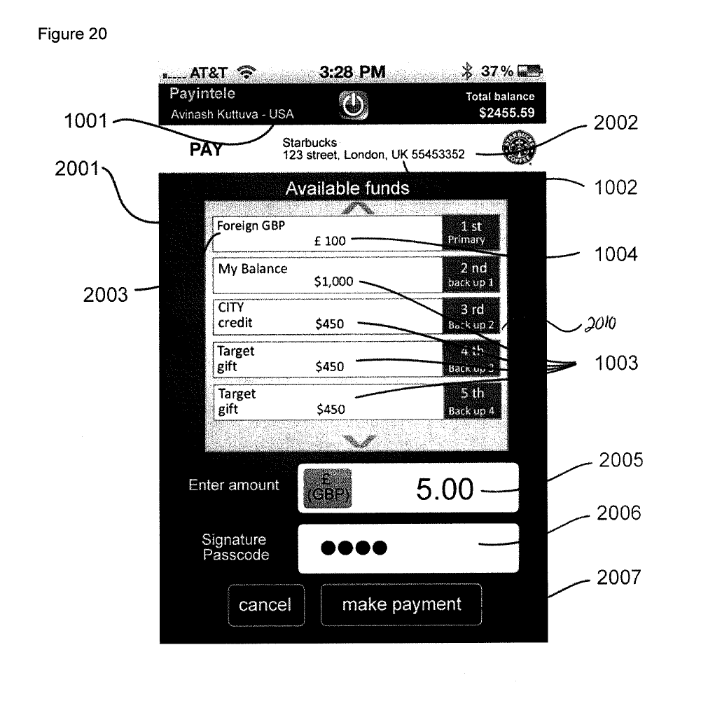

FIG. 20 shows the payment interface window 2001, in which the merchant information is displayed in a payee identified field 2002. The App automatically selects the preferred funding source 2003 that is most appropriate to use for this transaction. In this example, the app has selected a bank account having a balance in the same currency used by the vendor. In this example, the payment interface window 2001 displays in various fields the payor's home country (USA) 1001, the payee's home country (UK) 1002, the currency accepted by the payee/merchant (GBP), the currencies available in the payor's Payintele wallet (USD) 1003 and GBP 1004. In this example, the Payintele mobile app has automatically selected a preferred funding source (Foreign GBP) for completing the transaction and listed it first in the payment source list 2010, as shown at 2003. Accordingly, the payor/app user need only enter the payment amount (5.00) and pin in the corresponding windows 2005, 2006, click the “make payment” button 2007.

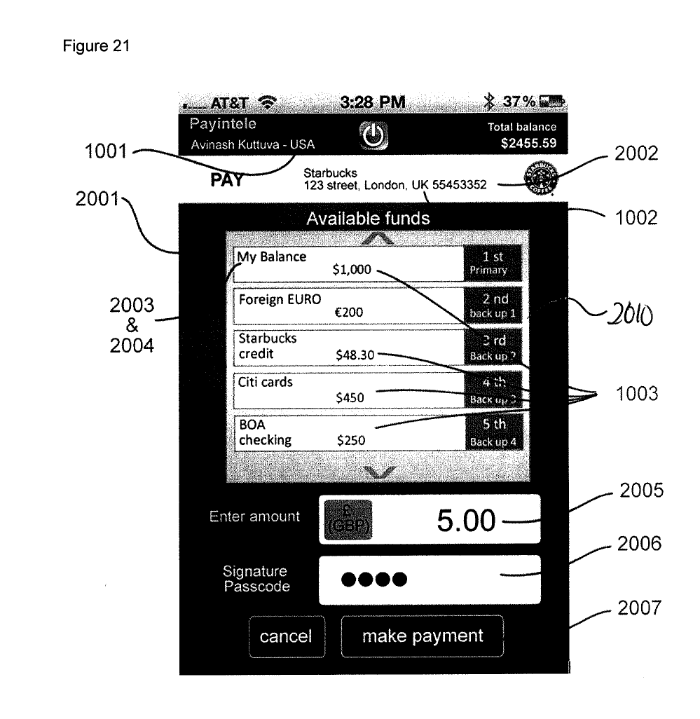

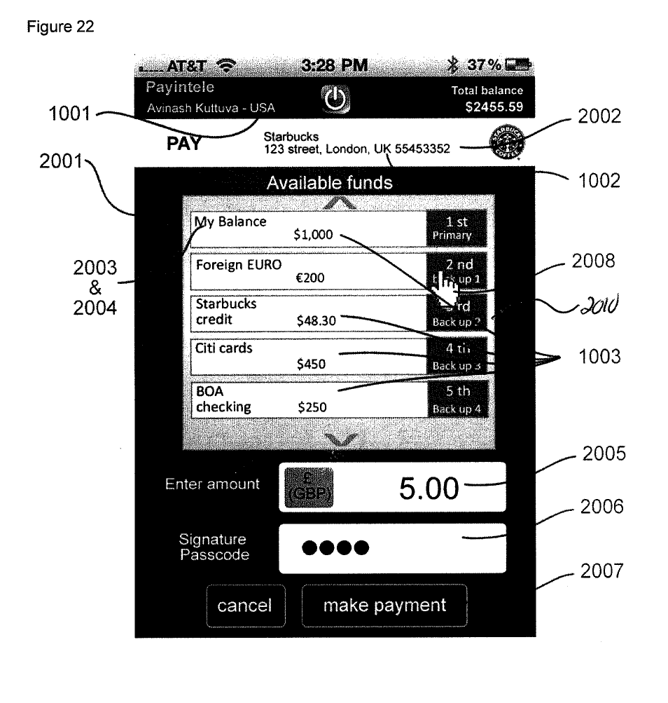

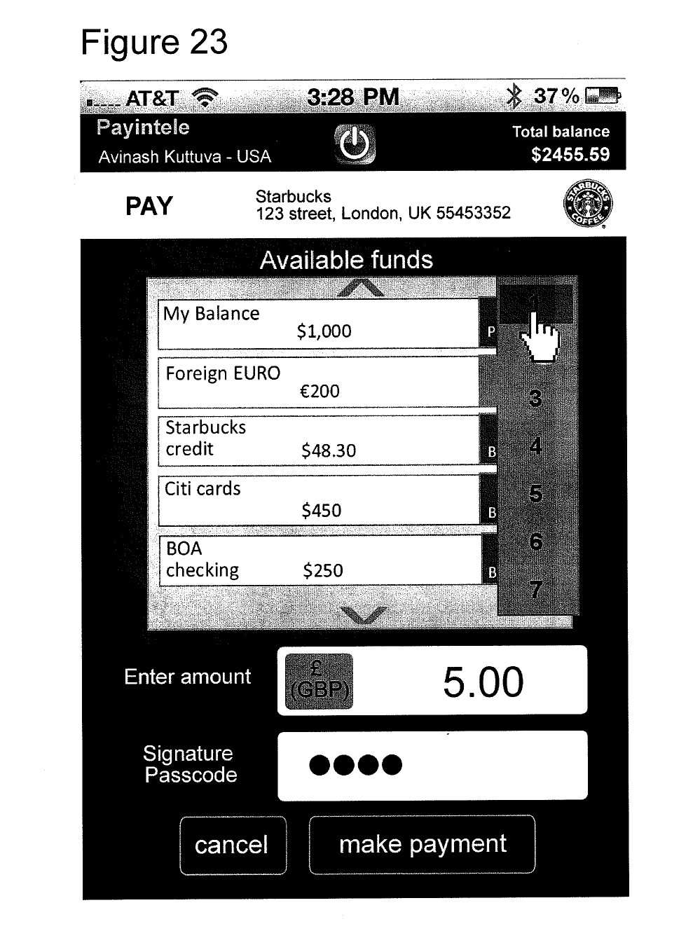

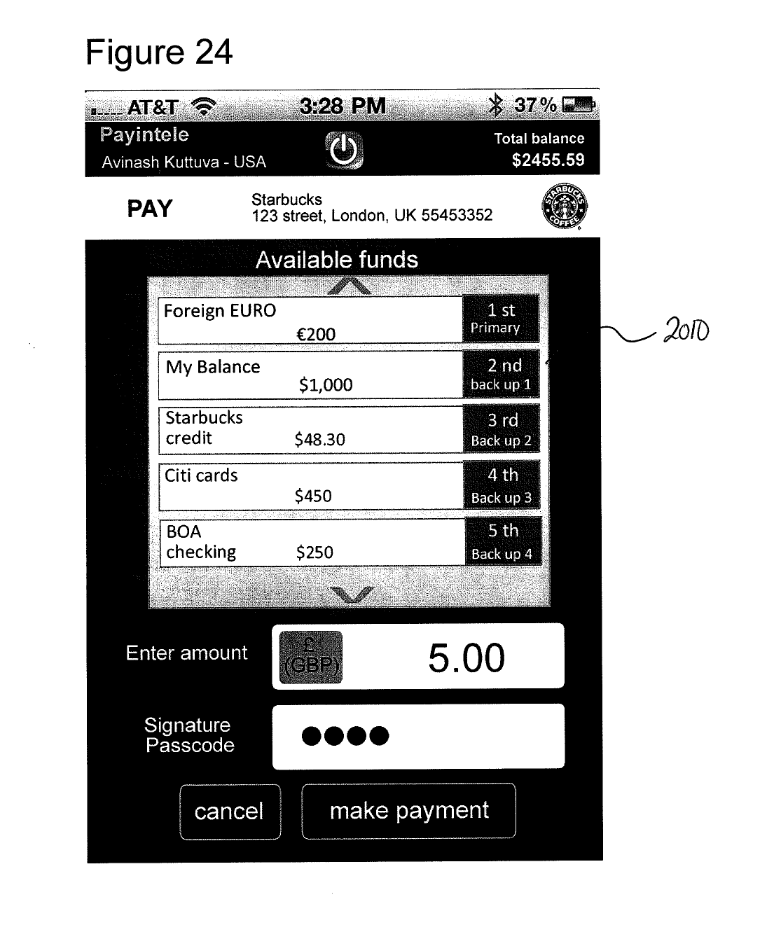

FIGS. 22-24 show a series the Mobile Payment Interfaces and how the user can easily override the default funds selected by the Mobile Payment App in accordance with an embodiment of the Payintele system. When no matching currency is available the app may present as the preferred funding source (listed first in the funding source list 2010) the user's default funding source (My Balance) as shown at 2003 in FIG. 21. In either case, the app user is free to override the choice selected by the Payintele mobile app, as shown in FIGS. 22, 23 and 24. This default funding source may be identified by the user when building a user profile, and may be stored as such by the Payintele app. In the example of FIGS. 22-24, the app user sees that EURO funds are available, and selects the EURO funding source to complete this transaction as shown in FIGS. 22, 23, 24. In this instance, the primary funding source has been changed to EURO, as shown in FIG. 24.

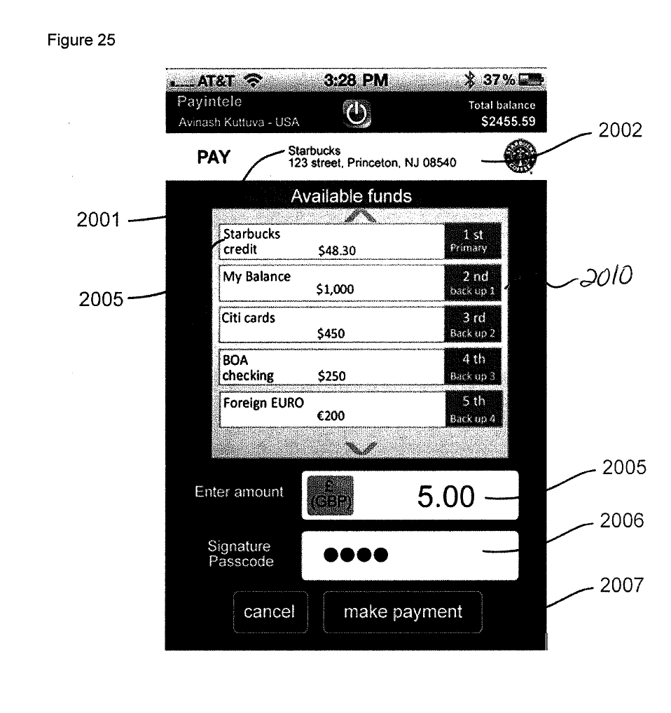

The app may also select an appropriate source to fund a transaction by matching the business to which payment is being made by selecting the store credit or gift card 2005 when available in the users account as shown in FIG. 25. FIG. 25 shows the Mobile Payment interface when used to make a payment at a particular business in accordance with an embodiment of the Payintele system, in which the Mobile Payment App auto selects the funds most appropriate for the transaction without any effort from the user. For example, if the payee is identified as Starbucks, and the payee has a store credit at Starbucks, the app may preferentially select the store credit as the preferred funding source, and list it first in the funding source list 2010, as shown in FIG. 25.

In the event that the currency accepted by a payee/merchant does not match the currency available in the customer's Payintele mobile wallet app, the payor may be warned that a currency conversion fee will be added to the payment transaction, (this feature can be turned off by the user) before completing the transaction.

Once the transaction is completed by the Payintele user, the payment will be promptly credited to the merchant's Payintele account, in the payee's country's denomination.

Alternatively, the Payintele user may override the payment denomination and complete the payment in the Payintele user's home country denomination, if the merchant is willing to accept payments in such a currency. In this situation, the user or the merchant will not be charged any conversion fees.

It should be appreciated that in certain embodiments, if the payment amount is greater than the amount available from a selected funding source, then the application may be specially-configured to automatically use the second-listed funding source as a back up to fund any balance of the payment amount in excess of the amount available from the selected funding source.

### Transaction Types

As discussed earlier, the Payintele mobile application can be used to perform a variety of function, including: (a) adding a person as a friend on a Payintele account; (b) making a payment; and (c) creating a custom module that will allow merchants to enhance the customer's shopping experience and business efficiency.

A custom module will allow the business user of the Payintele system not only to collect payments but also to offer a mobile shopping experience to its customers by creating promotional or advertising campaigns or a mobile shopping cart type of experience etc. within the Payintele app.

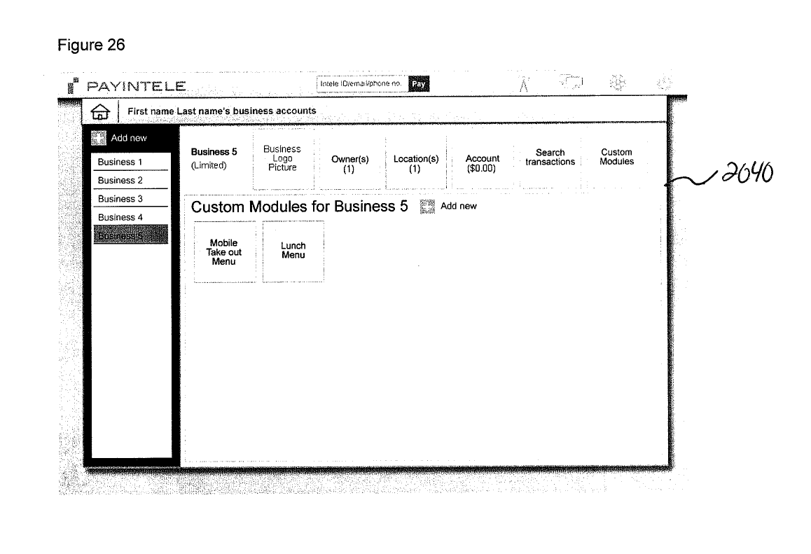

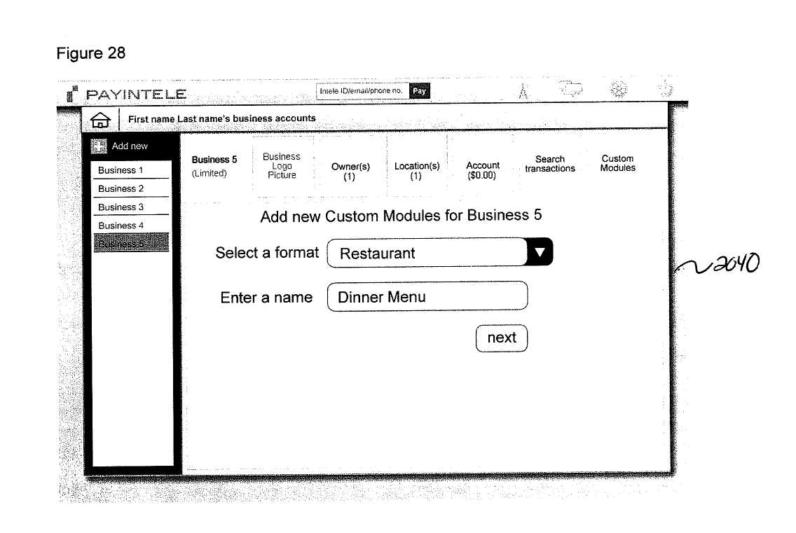

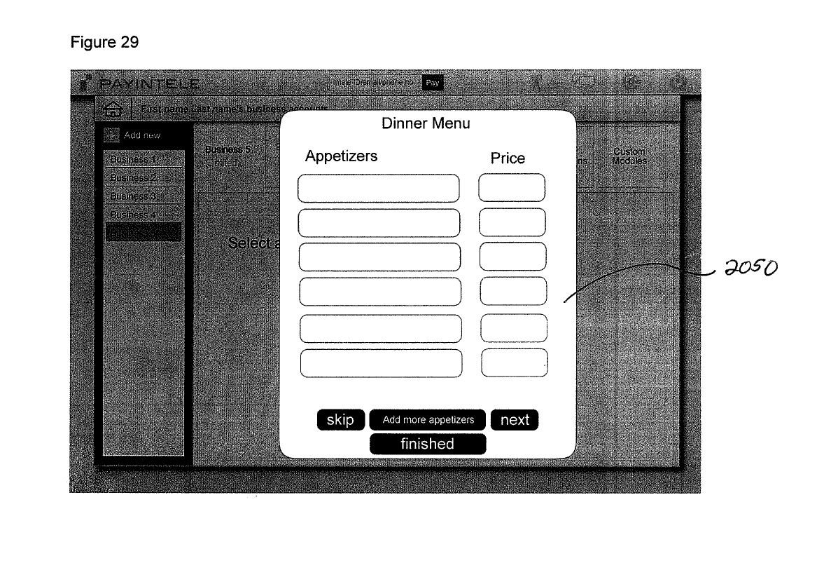

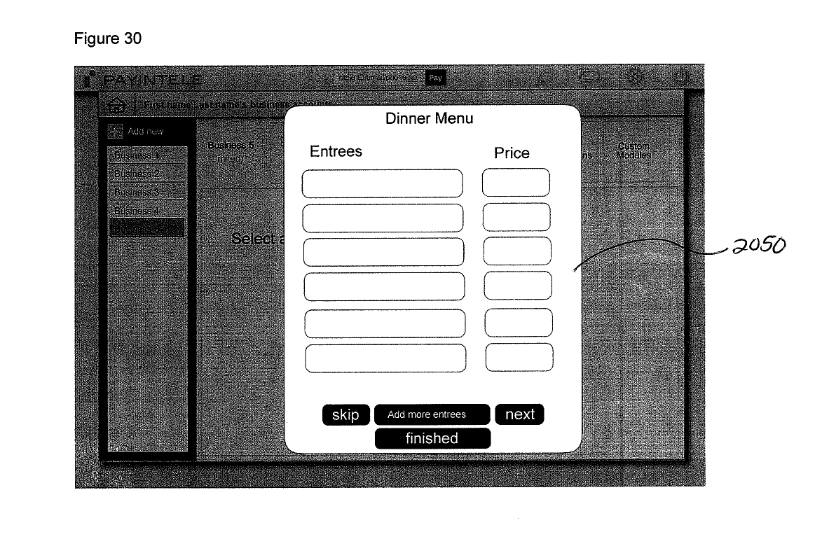

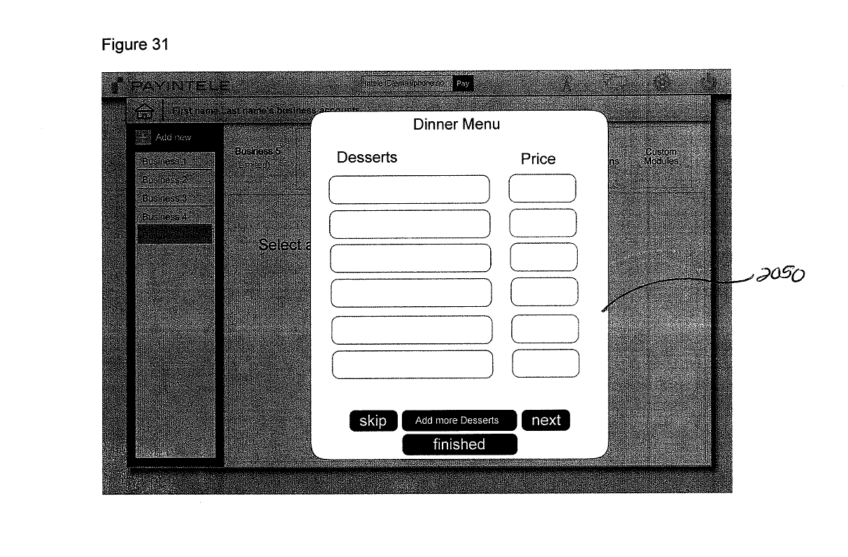

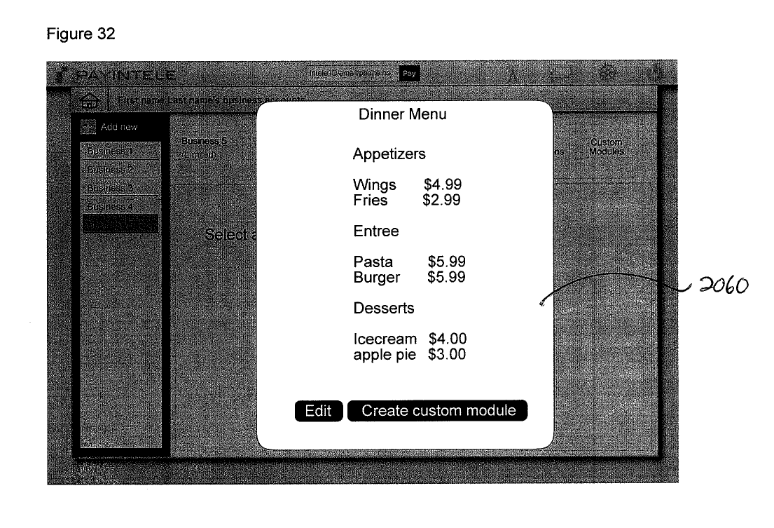

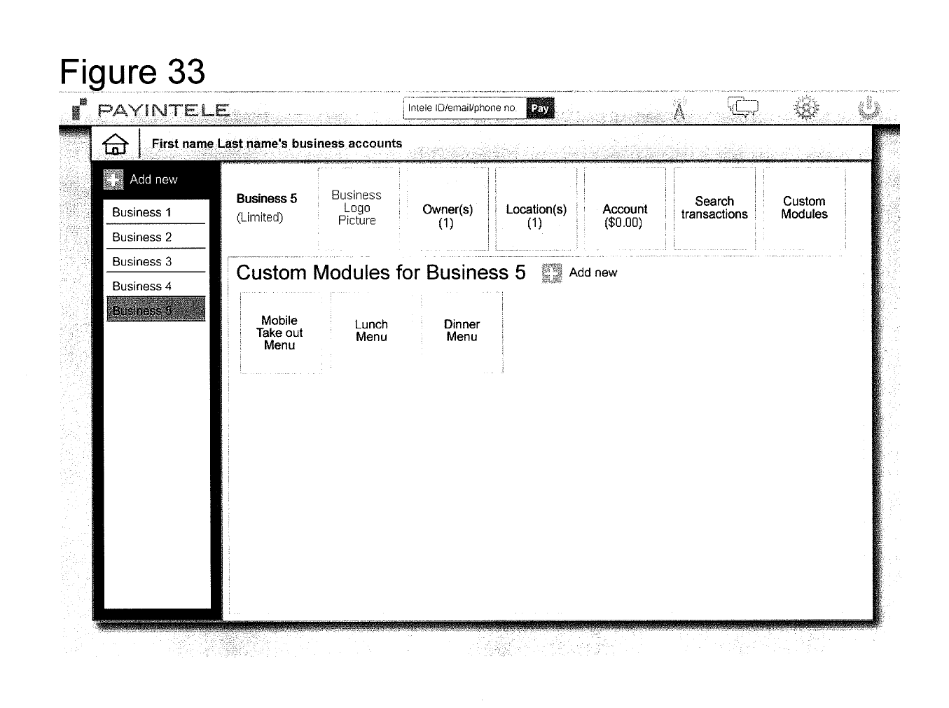

In general, the functionality of a custom module can vary as desired, as a function of the nature of the business involved and that business' requirements. Therefore, to facilitate a variety of functions that can be customized by the merchant users, web templates are provided that can be accessed by business users from their Payintele business account management interface. Optionally, these templates may be further customized by the business users. Exemplary business interface windows 2060 created from templates 2050 via the custom module creation are shown in FIGS. 26, 27, 28, 29, 30, 31, 32, 33, and 34.

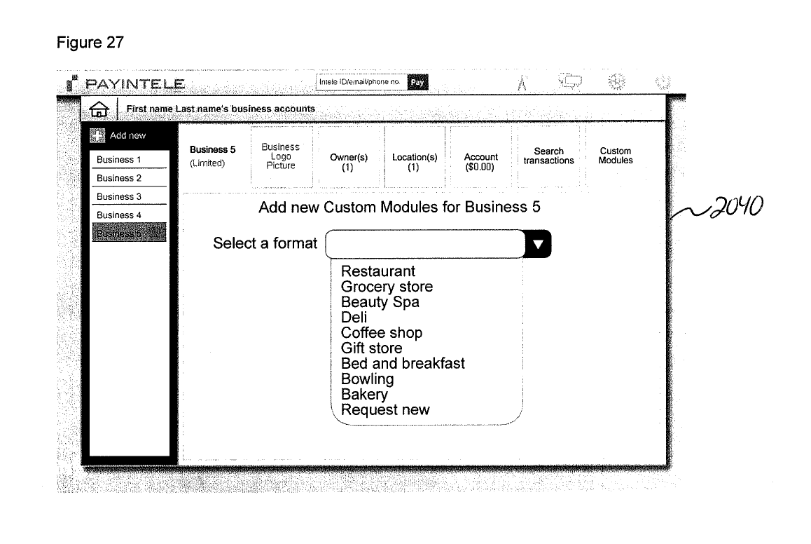

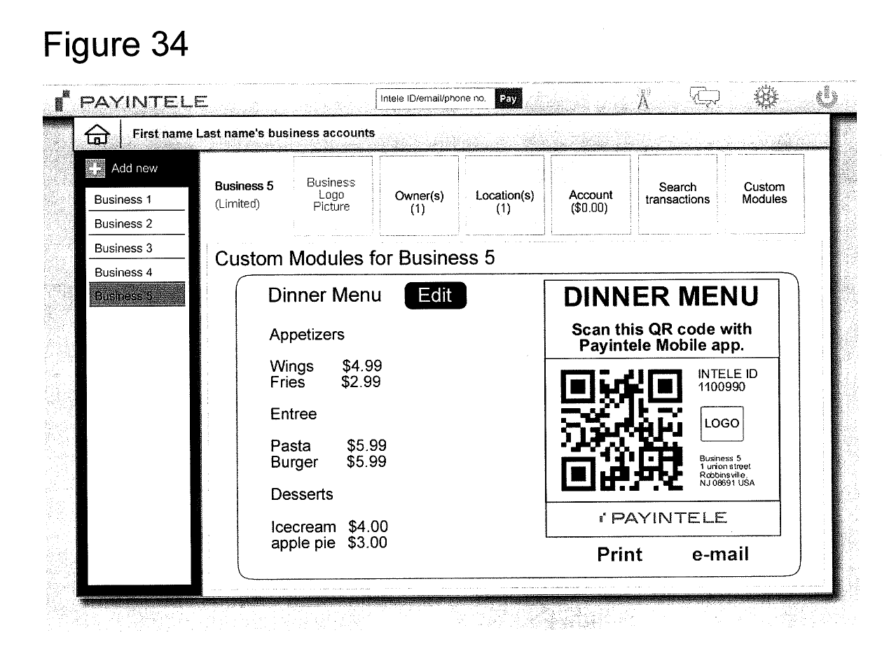

FIG. 26 shows the business interface with available custom modules in accordance with an embodiment of the Payintele system. FIGS. 27-33 show a series of graphical user interfaces demonstrating how a custom module is created by the business owner in accordance with an embodiment of the Payintele system. FIG. 34 shows the details of the custom module with the QR code that is specific for that businesses custom module in accordance with an embodiment of the Payintele system.

In use of the custom module, the business user selects a template that is appropriate for their business needs (or requests a new template from Payintele that is appropriate for their business needs). For example, A restaurant owner may select a “restaurant template”, a Beauty Spa owner may select a “spa template” etc. The user may do so via a web interface window 2040.

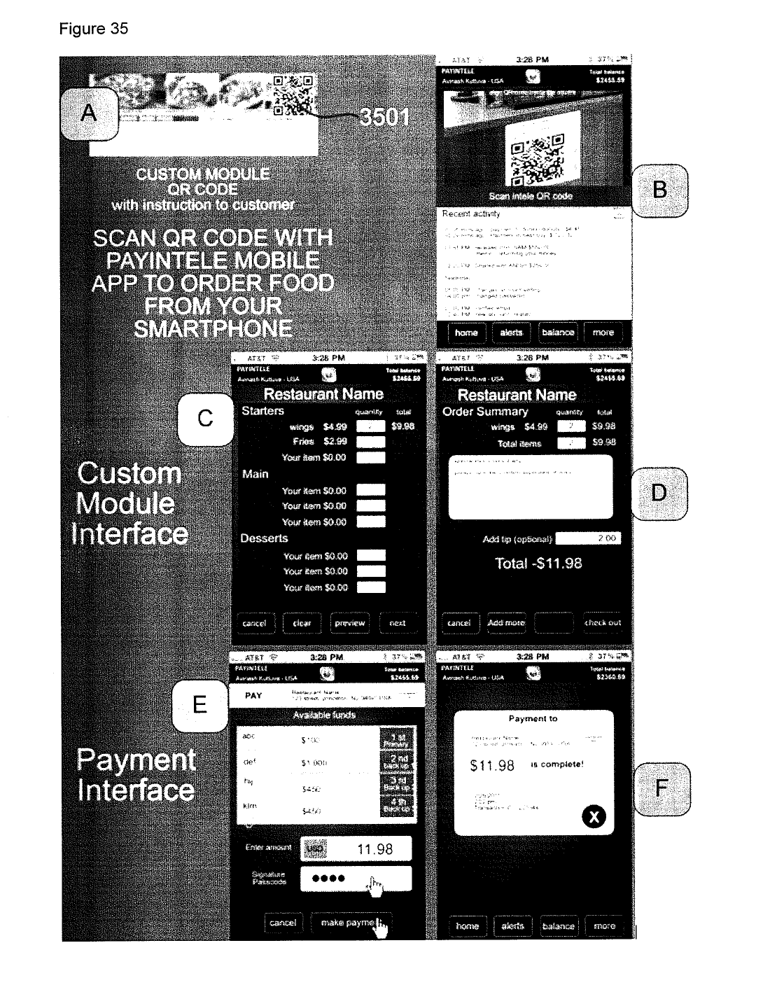

The template contains information and formatting specific to the merchant's business. For example, the restaurant template will allow the user to enter the food items sold at the restaurant and associated pricing information, and simply save the template to create a “custom module.” Once this process is completed, a separate QR code will be generated as shown in FIG. 34 that is specific to this Custom module. FIG. 35 shows how a business may use the custom module QR code (in this example) FIG. 35-A shows how a restaurant embeds the custom module QR code on their menu. FIG. 35-B shows how a QR code is installed by the counter so that it can be scanned by the customers with Payintele App. FIGS. 35-C, D, show mobile ordering interfaces of the Custom Module, and FIGS. 35-E, F show payment interfaces that proceeds after the customer completes the ordering process.

When this QR code is scanned with the Payintele App as shown in FIG. 35-A, the Payintele App will be instructed to: initiate a transaction with a particular business, and initiate the custom module interface that is specific to the scanned QR code.

In this example, the Payintele mobile application will then display the food items sold at the restaurant with the associated price information provided via the custom module, and will allow the payor to select food items, place an order with the Payintele mobile interface and complete payment for the same as show in FIGS. 35-B, C, D and E. Once the order is placed the merchant receives the order and payment notification on their Payintele mobile or desktop interface (not shown). Order and payment information may be transmitted from the user's computing device to a centralized Payintele server over a communications network, which may in turn communicate over the communications network to the merchant's computerized ordering system.

In FIG. 35, a custom module QR code 3501 is shown printed on a restaurant's take out menu. The QR code includes instructions that result in display of the custom module interface created by the restaurant/merchant, and that allows customers to scan the custom module QR code and place the order and make payment remotely as shown in the FIGS. 35-A, B, C, D, E.

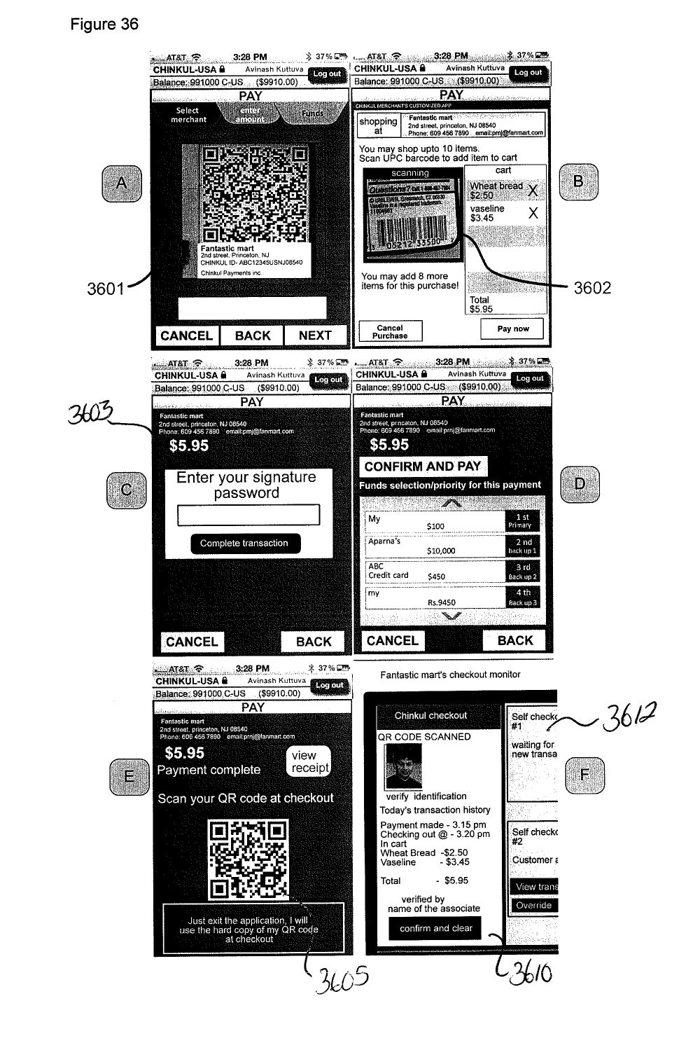

If the items sold by the business changes on a daily basis or the merchant sells a large number of items, it may not be practical to manage the inventory of such items via Payintele's custom module interface. In such circumstances, the custom module may be linked directly to the business inventory via an application program interface (API) service, and may contain a search interface or an enhanced browsing interface, etc. For example, FIG. 36 shows a custom module created for a grocery store. In this example, the grocery store may select a grocery store custom module similar to the previous example shown in FIG. 27. However, instead of the merchant entering the products manually and updating pricing on hundreds and thousands of products, the merchant will have the option to integrate the custom module directly with their inventory system. The technical process for such integration may vary on a case-by-case basis, but may be performed in a conventional manner, as will be appreciated by those skilled in the art.

FIG. 36 shows a Conceptual Mobile Interface series of a Custom Module designed to enable shopping, paying in the aisles, checking out of retail stores and an easy way for the associates to monitor shoppers using this method to shop and pay in accordance with an embodiment of the Payintele system.

When the shopper arrives at the grocery store, the payment process is initiated by the customer/payor's scanning of the custom module QR code that is displayed in an appropriate location as shown in FIG. 36-A, such as a shopping cart with the Payintele app's QR code 3601. The custom module interface in this scenario contains a barcode scanning interface 3602 for scanning UPC or other barcodes on items purchasable at a grocery store. The payor may scan the barcode of the products he wishes to purchase as he adds them to the shopping cart. Once all items are added, the payor may navigate to the payment screen 3603 of the app and complete the purchase without having to wait in line at a conventional grocery store checkout terminal. The store can also create an interface to verify purchases and payments.

Optionally, the purchase may be verified quickly by scanning the payor's QR code 3605 displayed via the Payintele app. Once the payment has been received, a transaction log 3610 may be created that helps the staff to monitor and manage the store's shopping and payment activity via the Payintele system. Such a verification message may be displayed via a computing device/cash register/terminal operated by a clerk of the grocery store.

The store interface window 3612 assists the store clerk in checking out customers who shop using Payintele. A checkout terminal for providing such a store interface window 3612 may include a QR code scanner (not shown) and a custom module that is build to display the transaction history of customers when the customer's Payintele QR code is scanned. The customers' Payintele account numbers may also be entered into the window manually. When the customers scan their QR codes, the store's interface responsively displays the transaction activity of the user for a that particular day, hour etc. as appropriate. The merchant's clerk may monitor customers using Payintele. Most stores already have an associate to check their receipt when the customers exit the stores.

### Reservations and Prepaid Services

A custom module can also be created to allow customers to schedule or reserve an appointment and complete payment for the same. For example, a beauty salon owner may create a custom module with a list of services, fees and hours and generate a custom module QR code. Customers may then scan the merchant's QR code from magazines, television ads, newspapers etc (or from their history or favorites that may be saved on their Payintele App) and can choose from the available services, schedule a time to receive the services and complete the payment for the services. The Payintele system responsively notifies the merchant and optionally enters the scheduled appointment into the vendor's business calendar, without the involvement of the merchant. When the customer arrives at the business location, the customer's QR code can be scanned (or the Payintele ID may be entered manually) in the merchant's Payintele Custom Module Interface to verify the transaction (service purchased, reserved time, payment and the customer's identity). This does not only automate the scheduling, but also prevents last minute cancellations and “no-shows,” since the customers are making payments at the time the appointments are scheduled, which makes the business process significantly more efficient.

The custom module feature helps merchants to create a mobile commercial presence for their business, and Payintele users/payors to readily access every business' mobile commercial application right from Payintele's mobile interface without having to download a separate mobile application for each business. Further the custom module feature increases a business' exposure, help merchants to save money that would be required if they were to build a mobile app for their business, and to afford a mobile presence even if they are not financially capable of building a custom mobile application for their business.

### Online Shopping

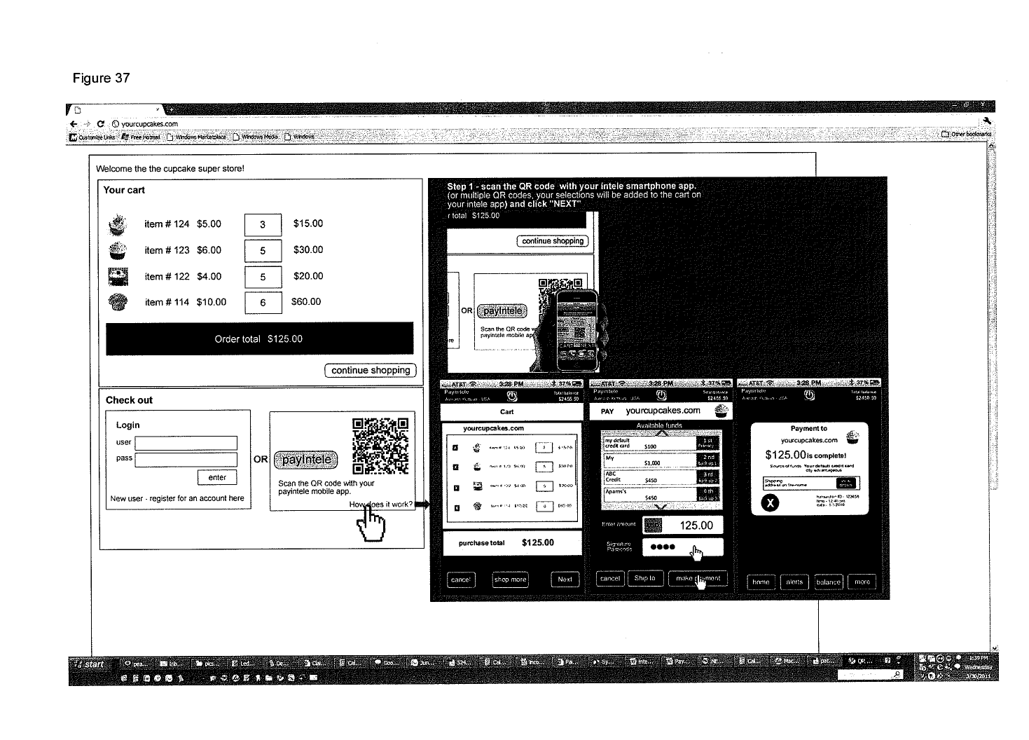

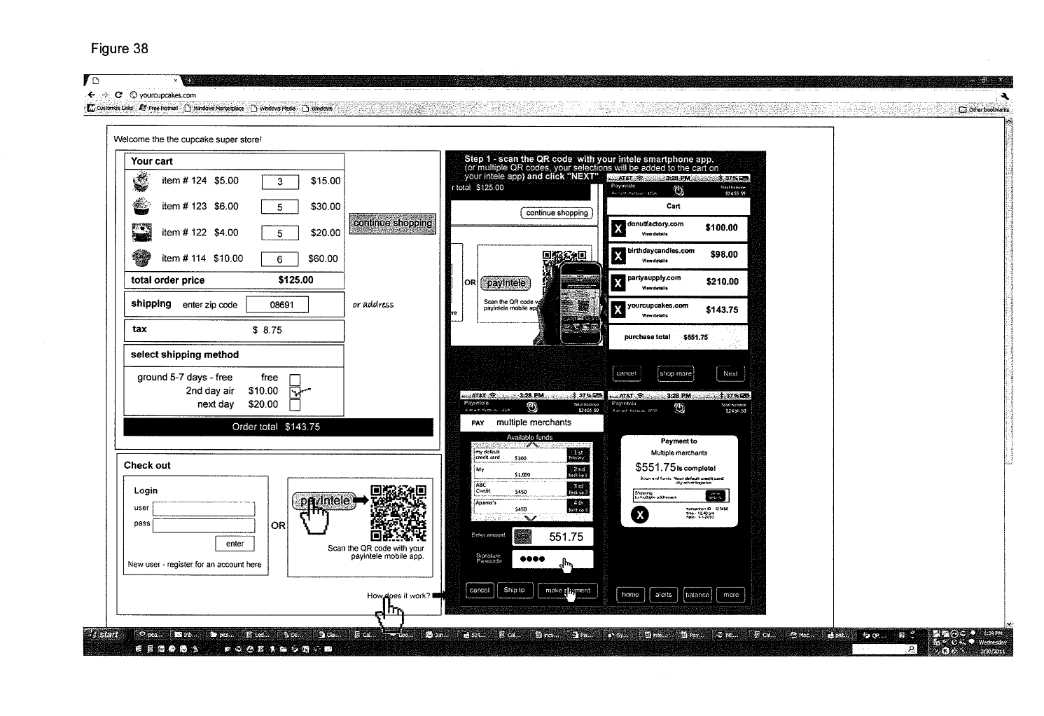

FIGS. 37-38 show screen shots of ecommerce sites and how the Mobile payment app can be used to make online payments in accordance with an embodiment of the Payintele system.

A mobile payment system is provided for eliminating the need to provide any personal and financial information on a public computer or an online merchant websites for the purpose of payments related to online purchases. The Payintele system eliminates the need to enter any personal information on the computer during online shopping as well as providing payment solutions for offline payments.

In one embodiment, the system utilizes optical transmission of shopping cart details from the merchant's website to the customers' mobile phone by communication such details into a corresponding QR code that can be scanned by the Payintele app. The details transmitted via the QR code include the shopping cart ID that is unique for each session, the online merchant's ID. The merchant stores the shopping cart detail, which includes the description of the items the customer intends to purchase, the shipping method, shipping address, shipping cost and applicable taxes on the merchant's server for a certain period of time and can be located within that time frame using the merchant ID and the shopping cart ID.

Once the QR code has been scanned by the Payintele app and the merchant ID and the shopping cart ID have been received by the Payintele mobile app, the App locates the cart details from the merchants server and presents the shopping cart details to the customer for verification before completing the payment on Payintele Mobile App as shown in FIG. 37.

The payment process can be conducted as described above. After the payment process has been completed, the order details are sent to the merchant for processing and the merchant account is credited for the transaction.

This method also allows consumers to shop from multiple websites and consolidate the payment part in a single step as shown in FIG. 38. In other words, payments due to multiple websites may be aggregated an may be paid for by scanning a single QR code.

Online Payments Using Payintele

In accordance with the present invention, a merchant accepting Payintele payments displays the Payintele QR code module on their web-based shopping cart using a shopping cart plug-in (a computer programming code provided by Payintele that shall be integrated with the shopping cart software that is used by the Online Merchant). This module simply bundles the merchants Payintele ID and the shopping cart details and stores it at the merchant's server. Alternatively, such information may be stored at Payintele's server.

It should be noted that an internet connection on the mobile device is not required to scan and receive the shopping cart details, although an internet connection is required to complete the transaction. This can benefit the consumer by enabling them to continue to browse and shop online and store the cart information on their mobile device via the Payintele mobile app. The transaction will be automatically completed when internet connectivity becomes available.

Similarly, shopping can be done from offline catalogs such as magazines, newspapers and other offline catalogs stored on a CD, DVD or other media.

Consistent Payment Processing in Various Situations

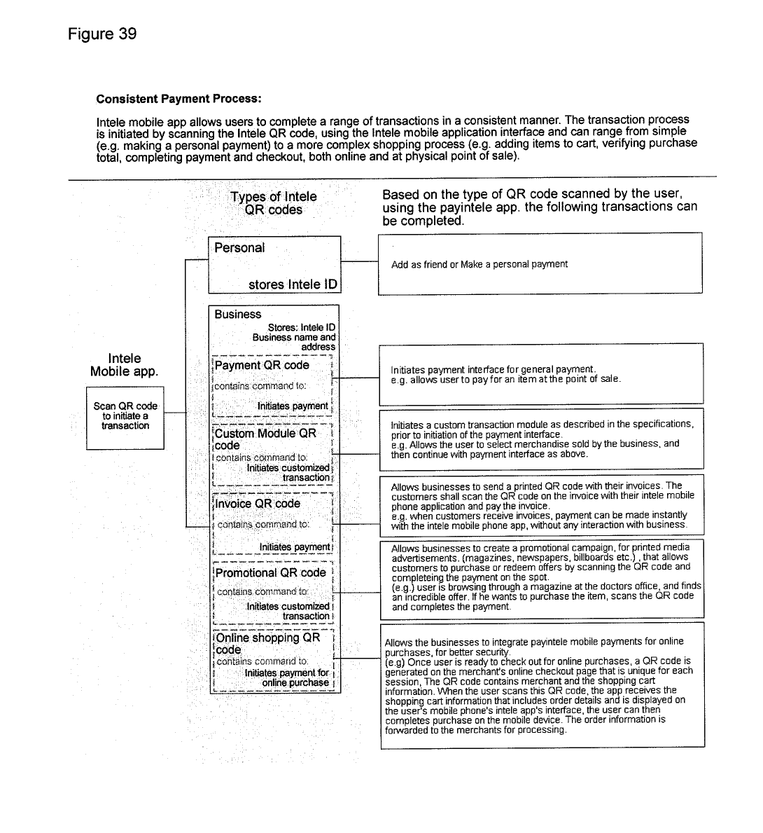

FIG. 39 is a flow chart of payment process in a variety of examples demonstrating the payment process can be completed in a consistent manner in accordance with an embodiment of the Payintele system. The mobile payment concept enables users to follow a consistent procedure to make and accept payments as shown in FIG. 39.

Transactional Fees

A fee calculated as a percentage of each transaction may be charged to merchants for each payment received, similar to a credit card system. However, no recurring monthly fees or equipment expenses may be incurred. Since merchants do not receive critical financial information, merchants are relieved from Payment Card Industry Data Security Standards (PCI DSS) issues. The system is comprised of (1) a mobile or non-mobile application that functions as an interface, on which users can carry out their actions, such as sending and receiving money to and from other users and making payments to businesses for purchases and services, receiving notifications, checking balances, adding and withdrawing funds, etc., (2) a server to host the service, database systems and a backend application to facilitate transactions between user interfaces, (3) a web browser interface to connect the users to the system from devices that do not have the client application, (4) a reserve (float) account, in which funds received from the users are deposited and withdrawn when users would like to transfer the funds back to their banks, (5) a payment gateway, partner bank and accounts to contain the money, and (6) user's electronic device or devices, owned by the users, and used to access the online application (which serves as the platform to carryout various functions of this method.)

Enhanced Security

Most mobile devices today have a variety of rich features, like a front facing camera in addition to a microphone and speakers. The consumer interface may involve voice and facial recognition features by taking advantage of these biometric input devices, mainly the front facing camera and the microphone, to (1) enable execution of financial tasks with voice commands in addition to providing voice reports and feedbacks, (2) accept a user's face and voice as biometric authentication methods to enable login, (3) access account data and execute transactions, and (4) enter into standby mode as soon the authorized user moves away from the front facing camera's field of capture.

Though it should be apparent and is described in greater detail in the commonly owned parent patent application identified herein, it is restated here that the inventive system includes a front end web server, a back end application server, and a database. The front end server facilitates connection between the end user (and the Payintele mobile app) and the back end application server through an internet connection.

A web and proprietary mobile client interface (PayIntele app) to provide users access to their account details via the web and/or web browsers is loaded on the end user's device.

The system is also connected to external entities such as partner banks, payment gateways, and other entities that may be required to provide various transactional services. Users can create accounts by registering themselves and creating their usernames and passwords by visiting the Payintele website or from a Payintele mobile phone application installed on a mobile device.

A payment gateway infrastructure may support the transfer of funds from credit and debit accounts from which users may fund their Payintele account as well as withdraw from their Payintele account to their bank accounts. In addition, the payment gateway may store users' card and banking information.

A merchant account service provider may process credit cards from users who wish to instantly preload their Payintele account.

An ACH service provider may support transfer of funds to and from user's bank accounts. Merchants who accept Payintele may be able to transfer their receipts to their business bank accounts.

This platform can function as an open source for banking institutions and credit card companies to provide their customers access to the customer's credit and deposit accounts so the money can be spent through this platform's mobile and non-mobile interfaces, instead of using credit cards, debit card or checks.

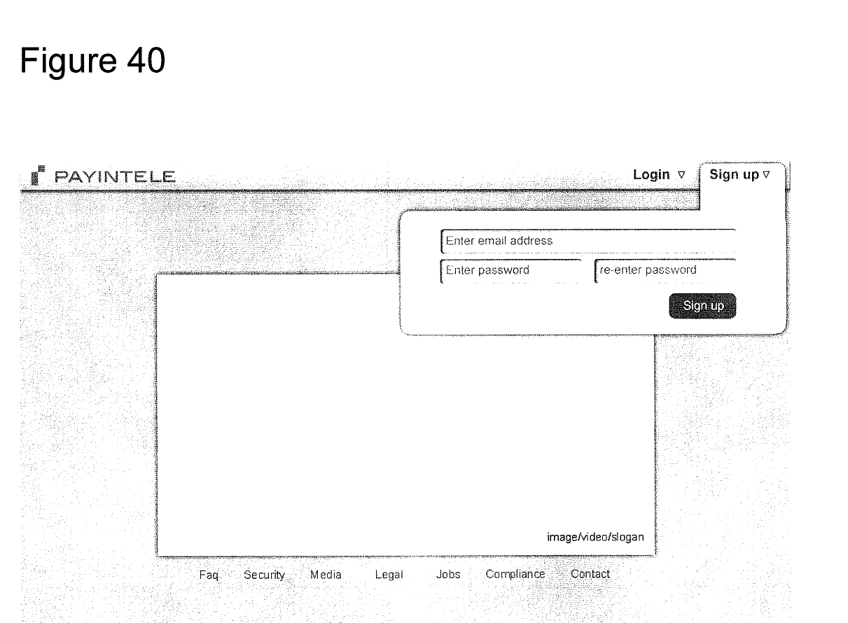

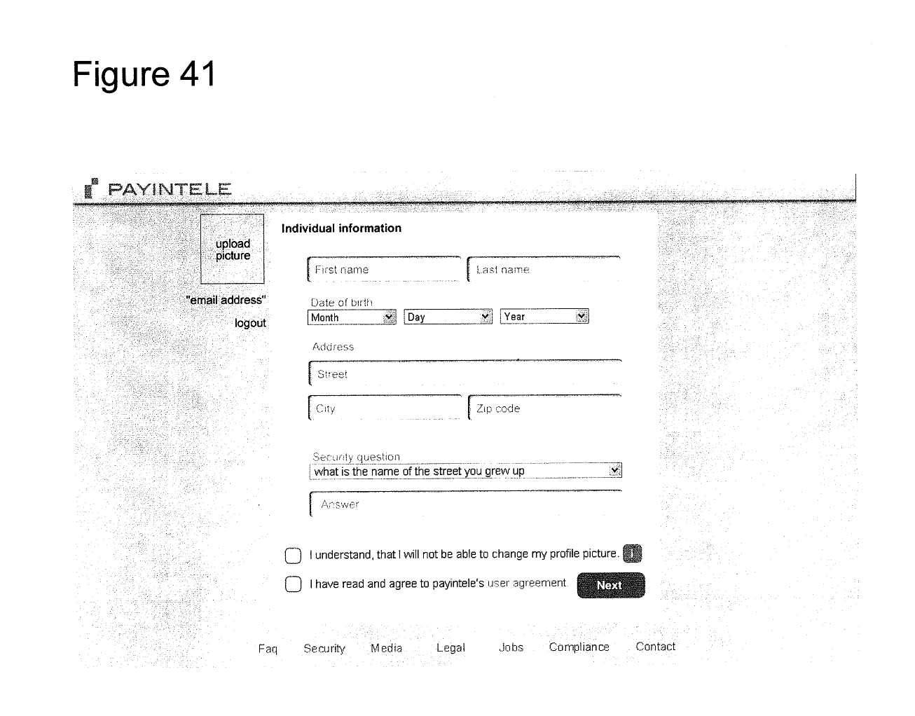

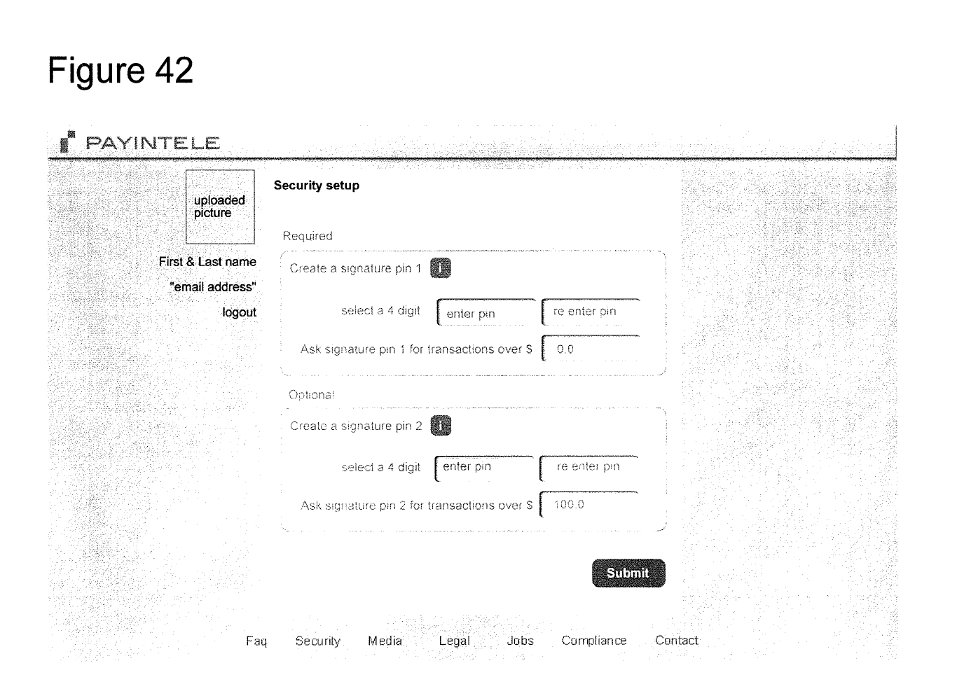

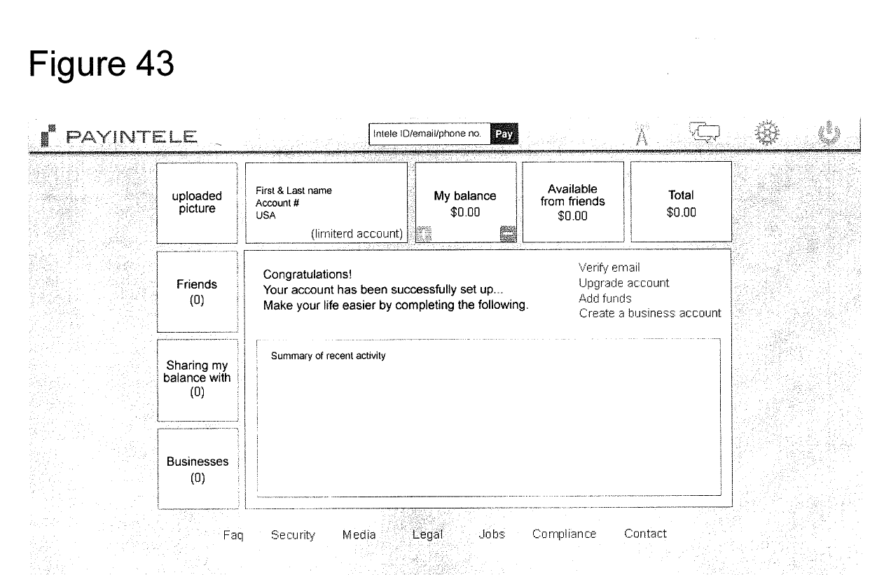

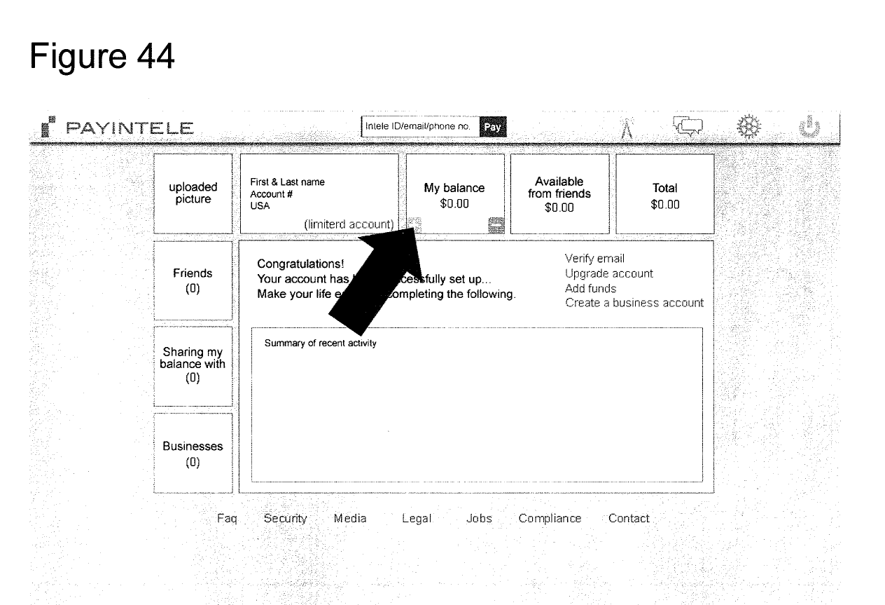

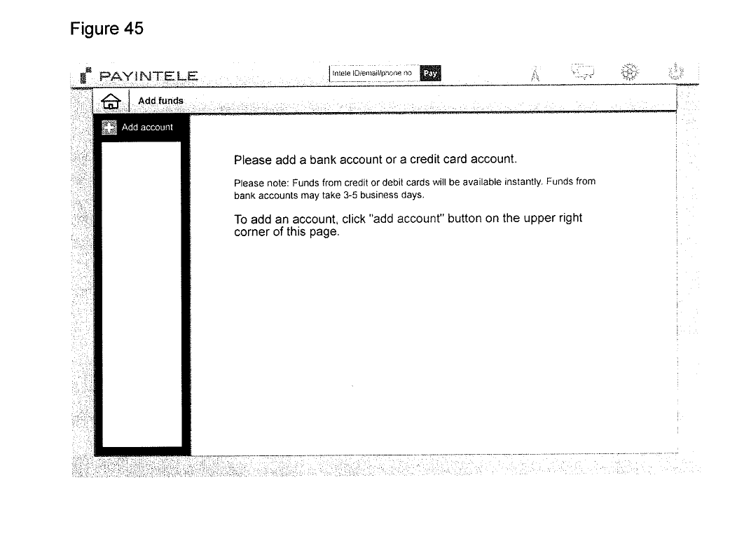

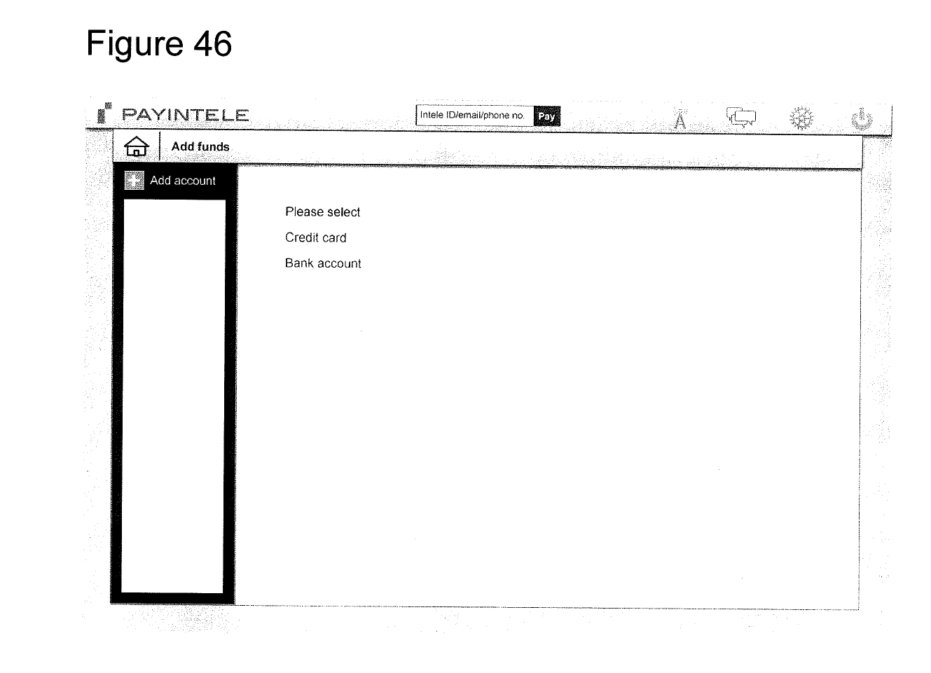

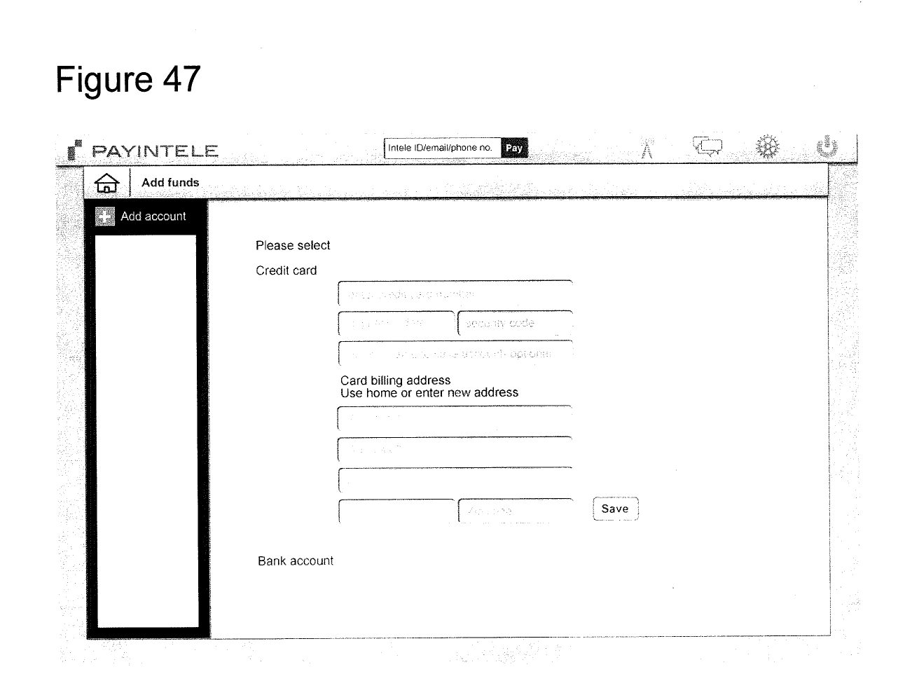

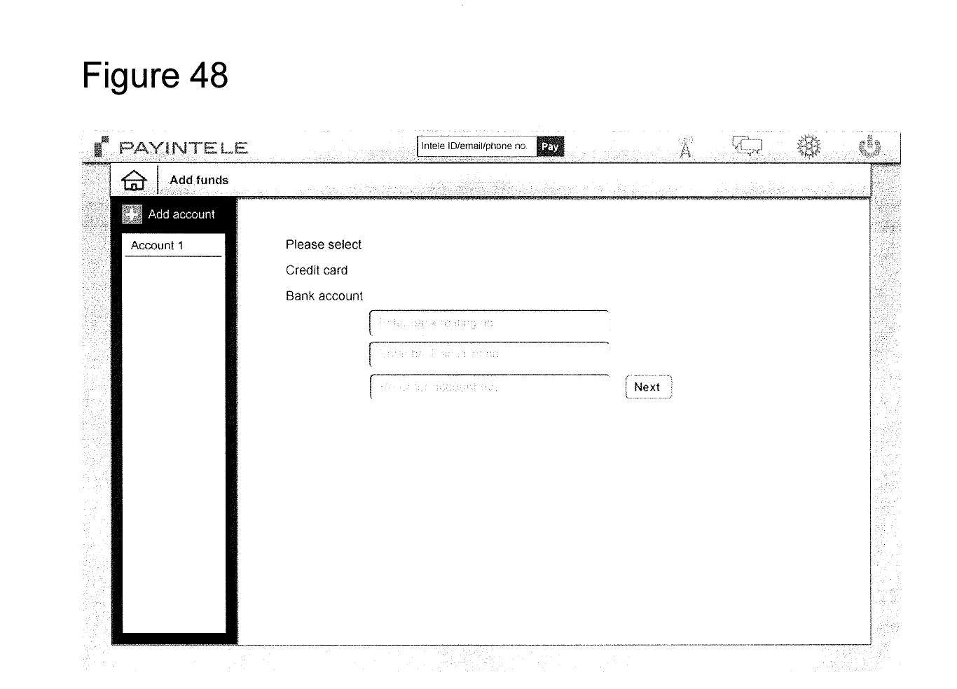

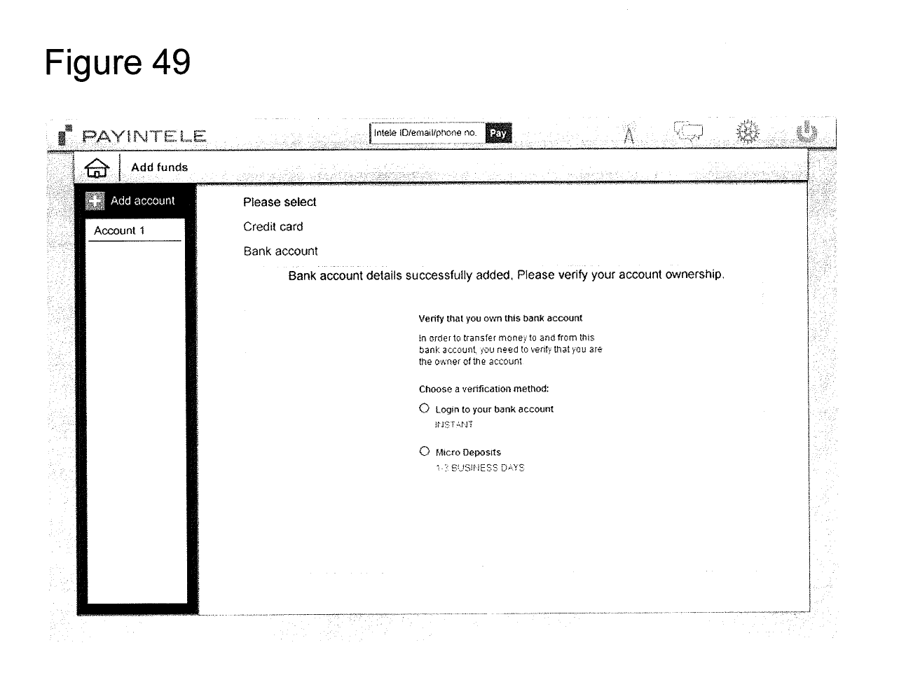

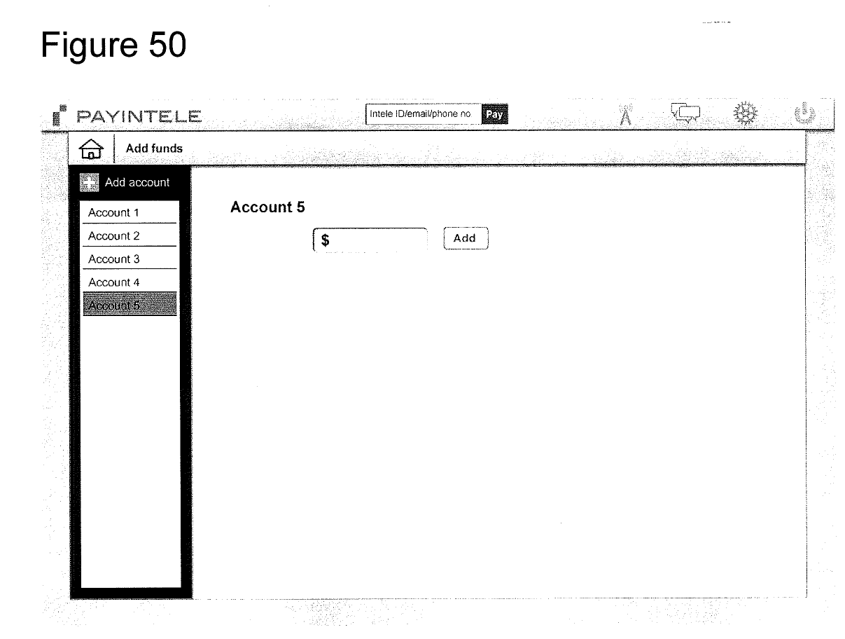

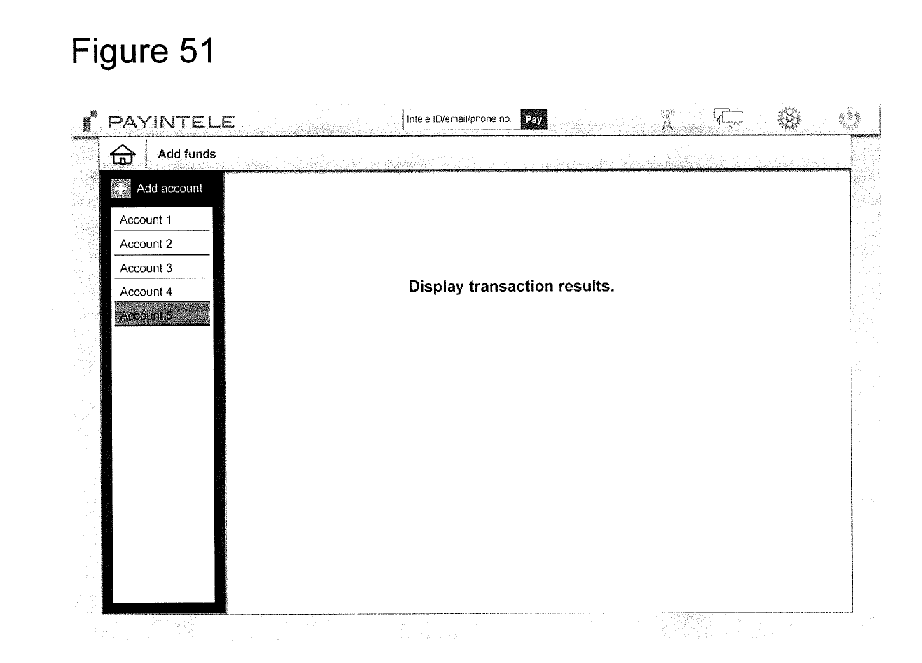

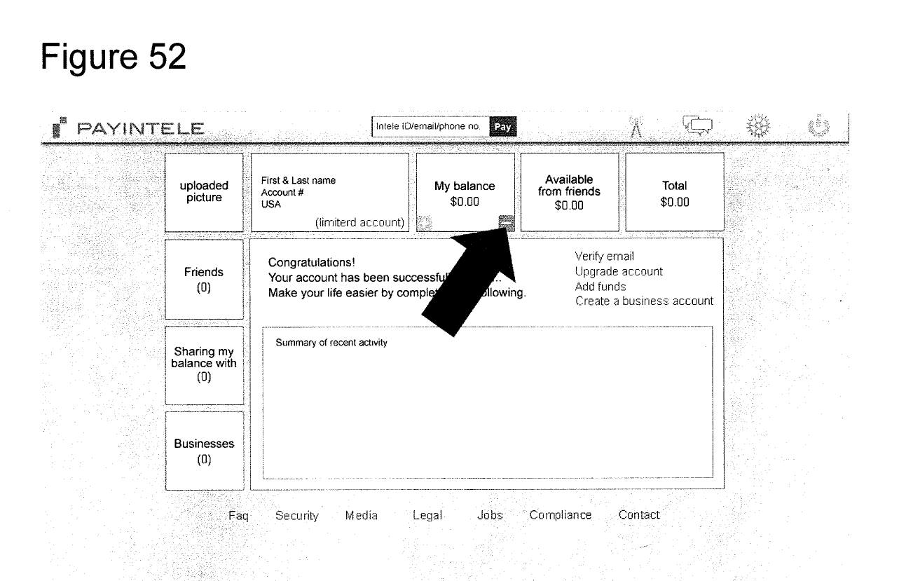

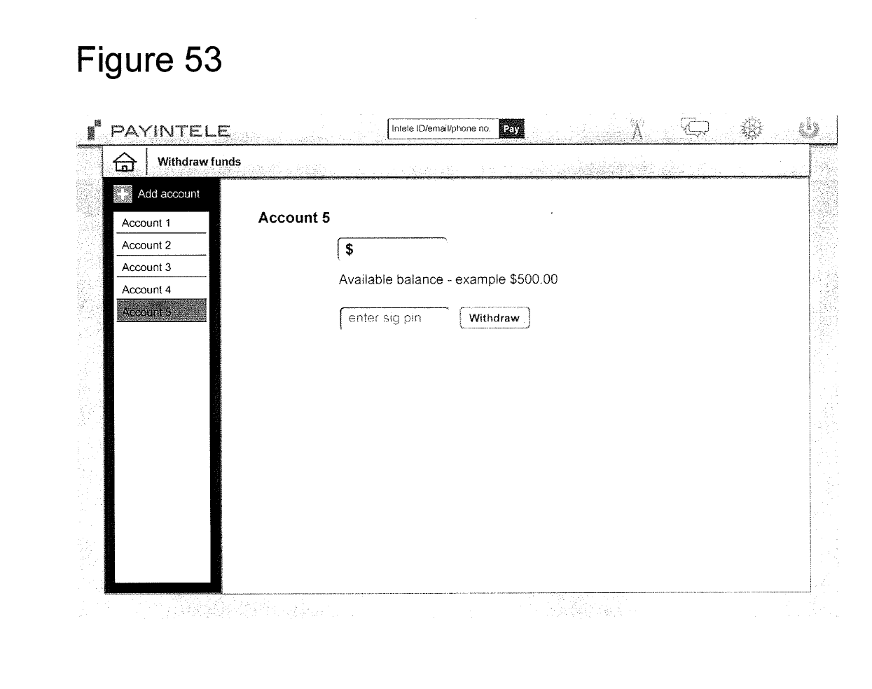

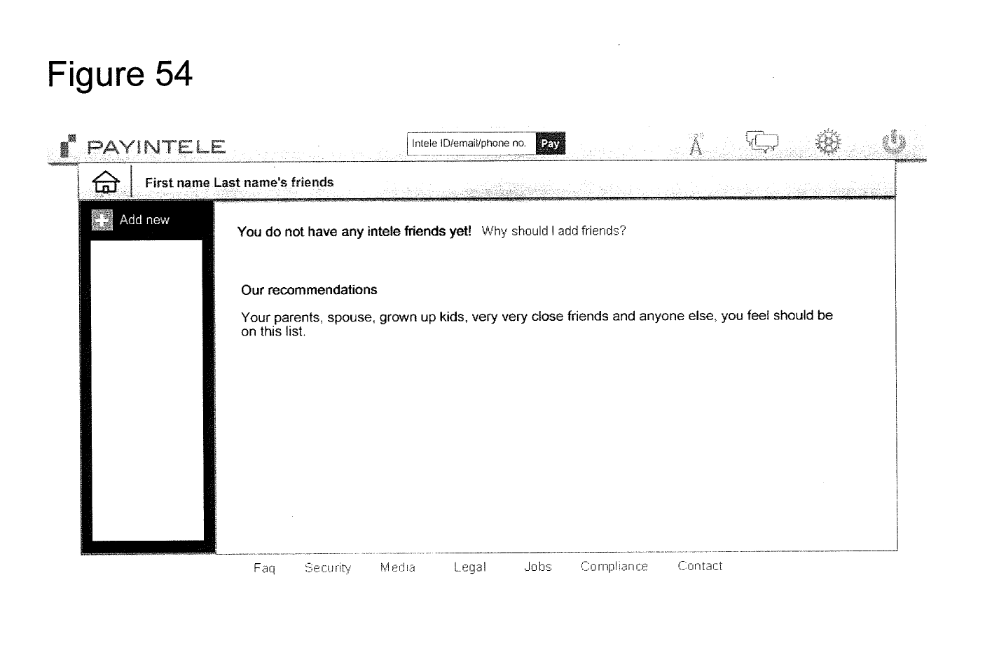

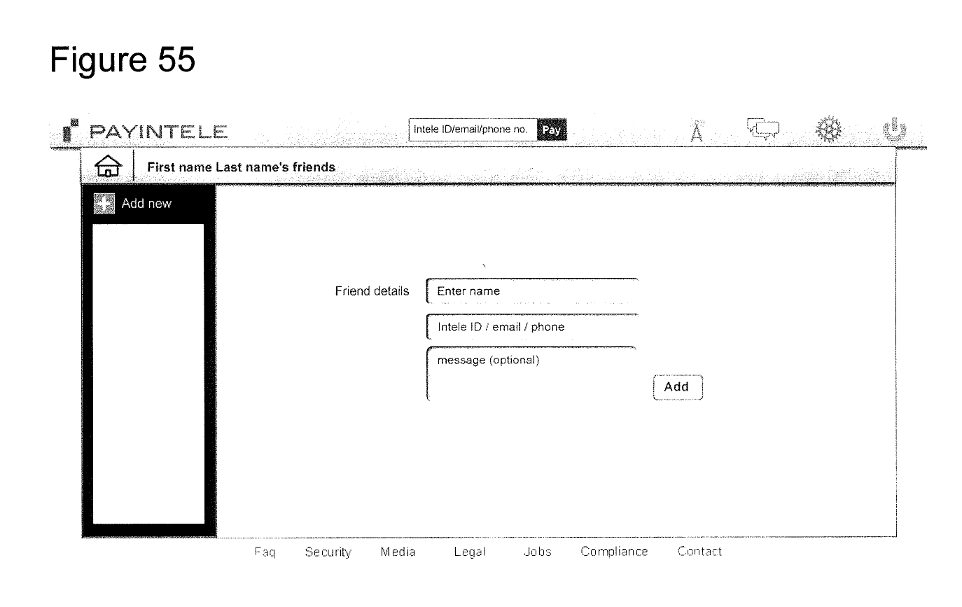

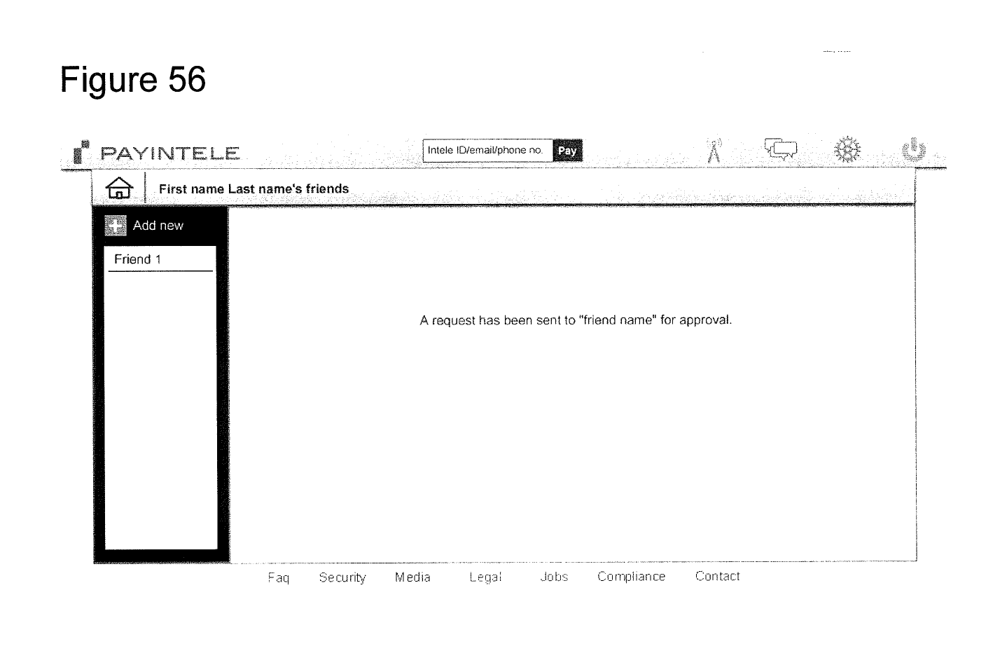

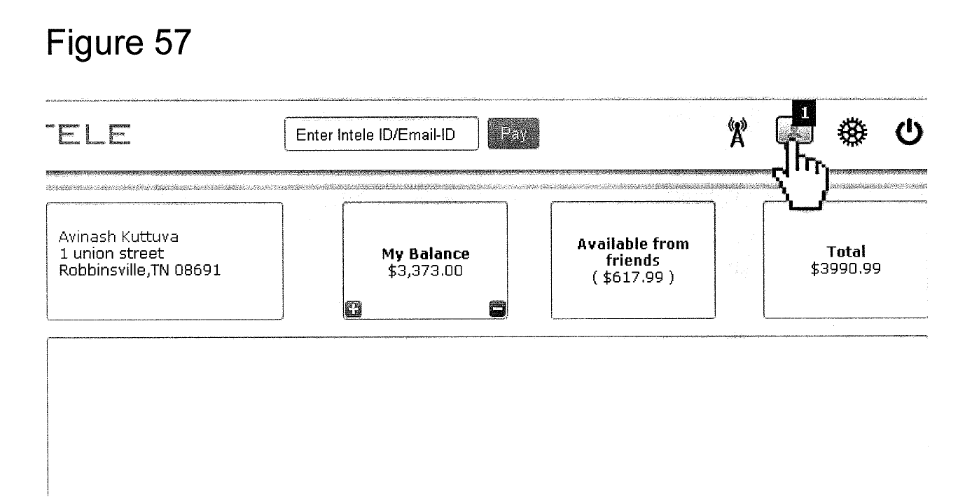

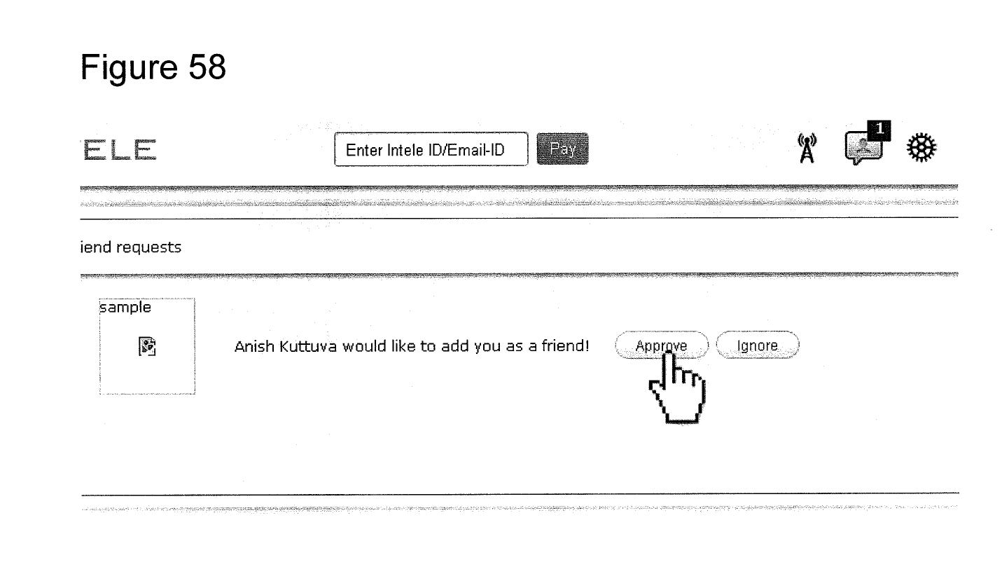

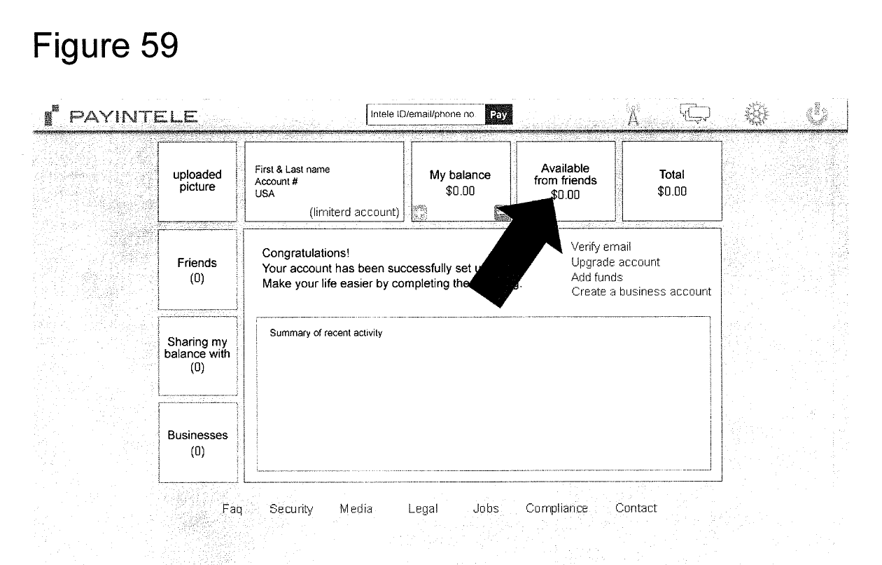

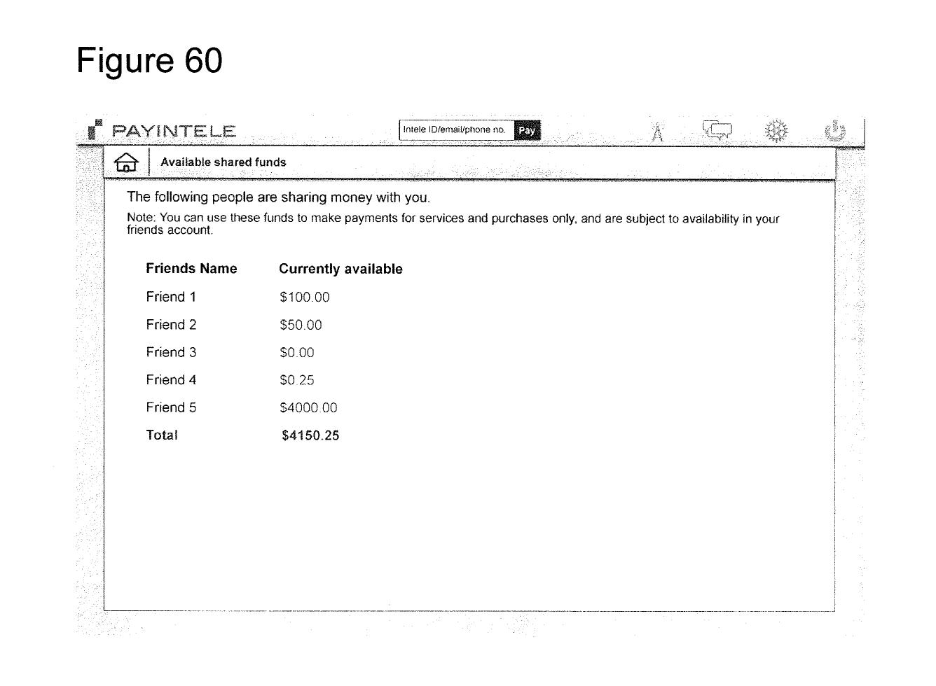

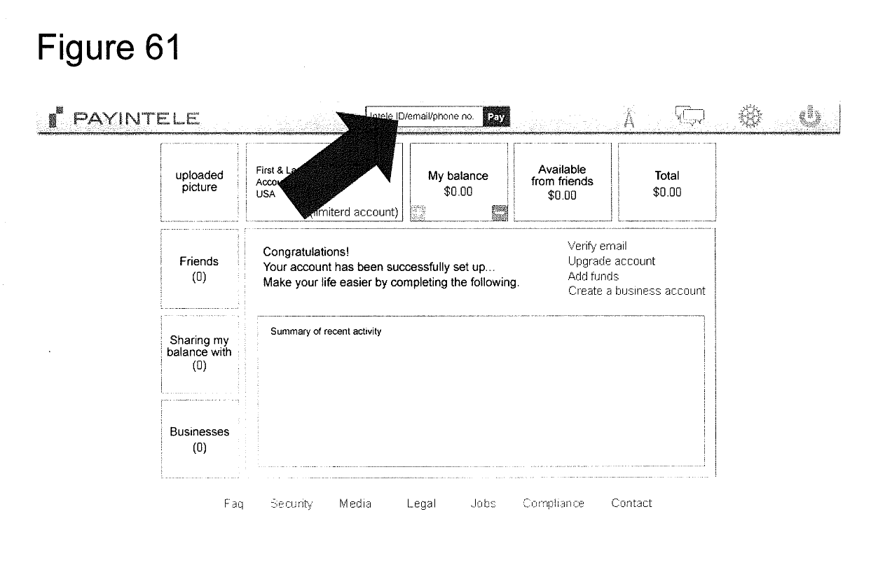

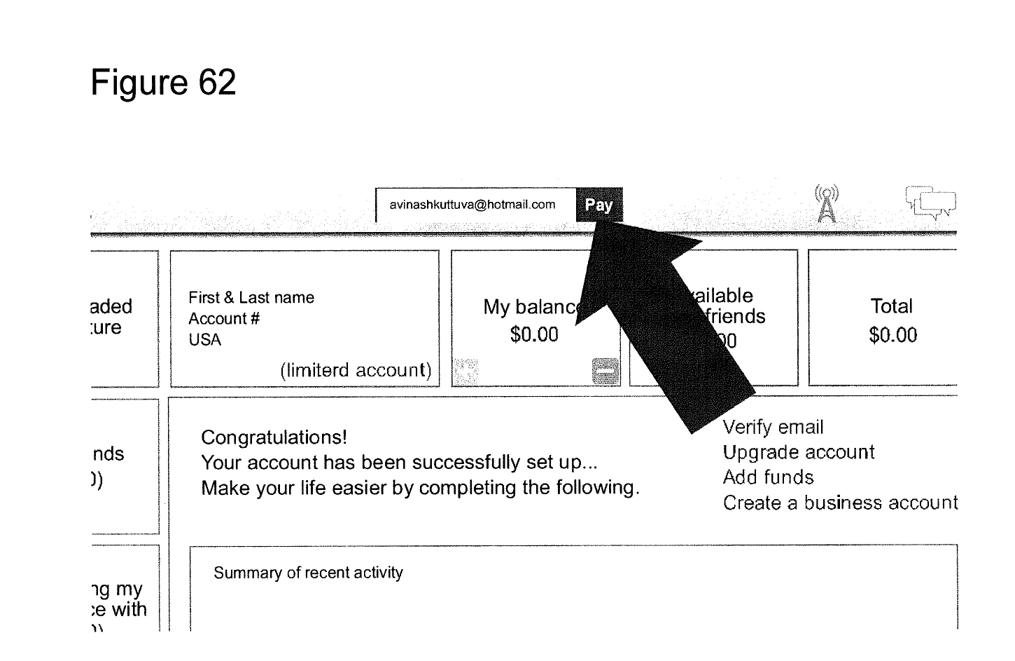

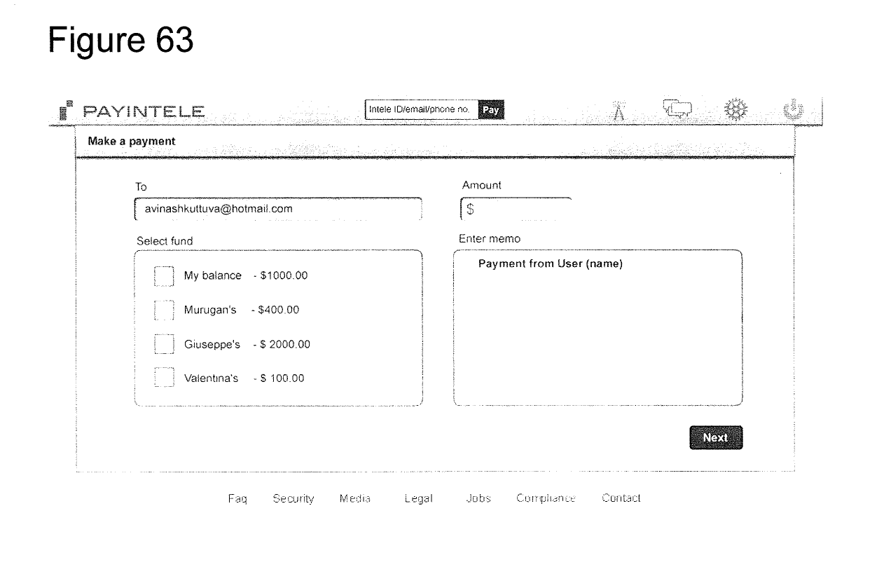

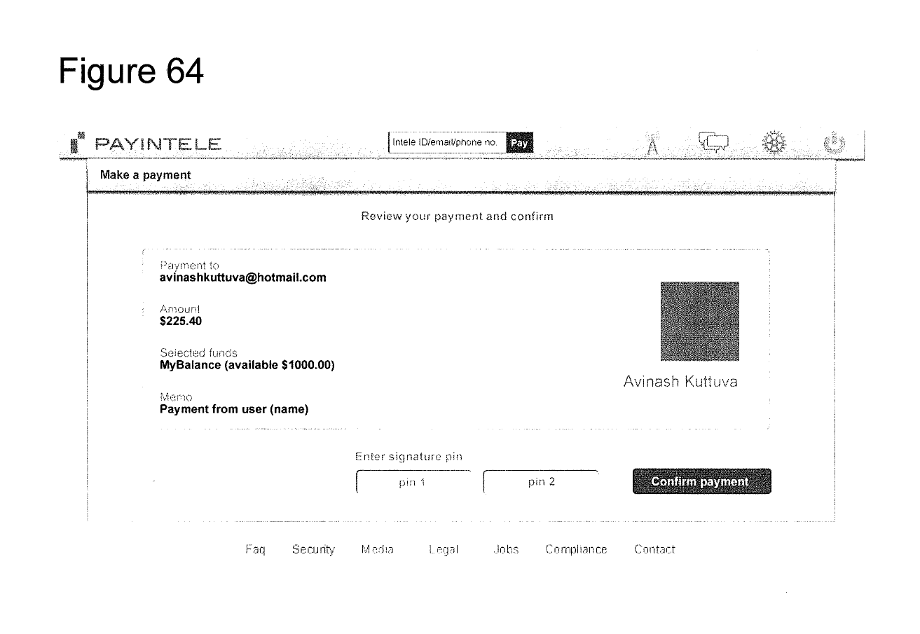

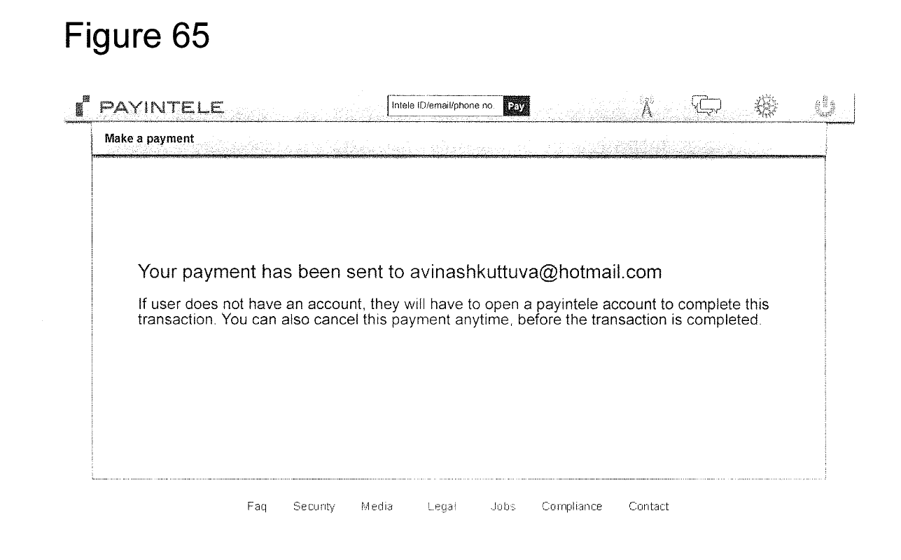

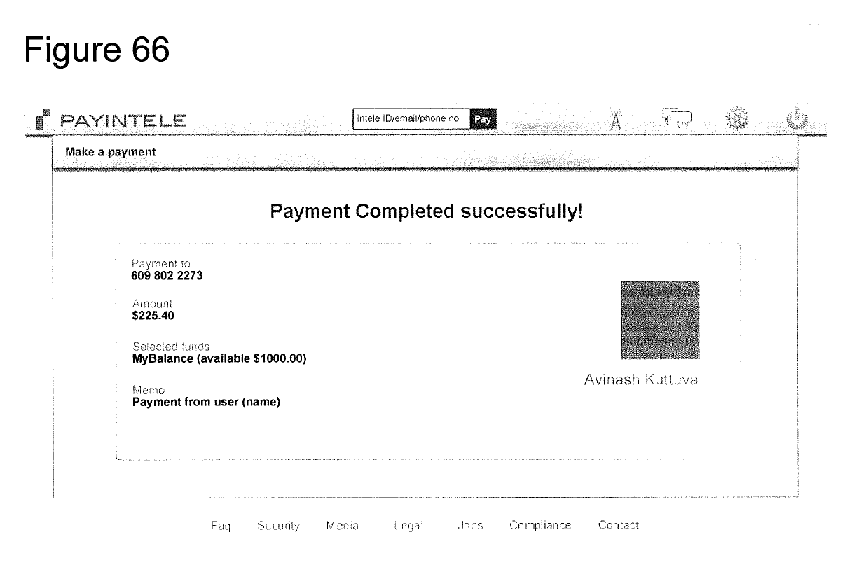

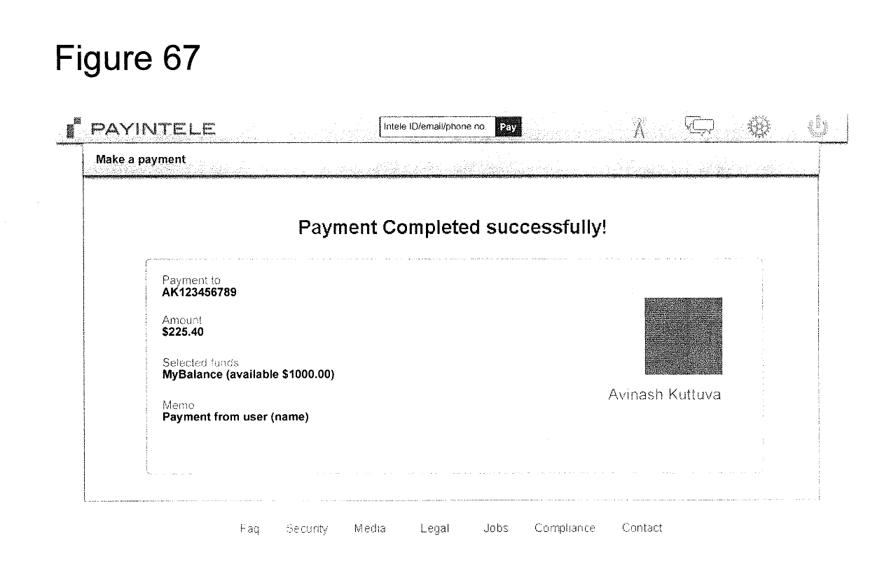

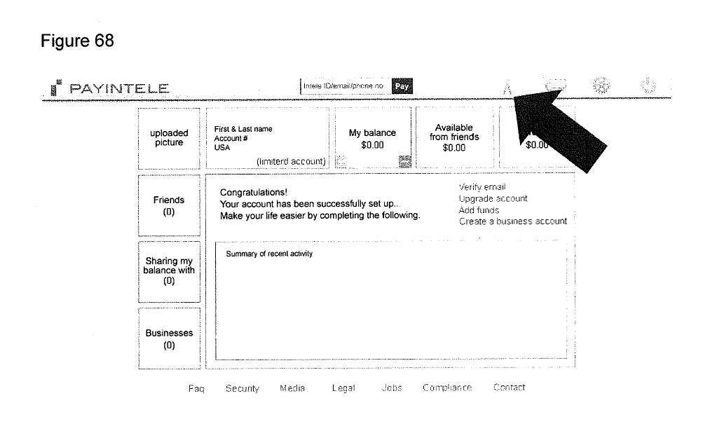

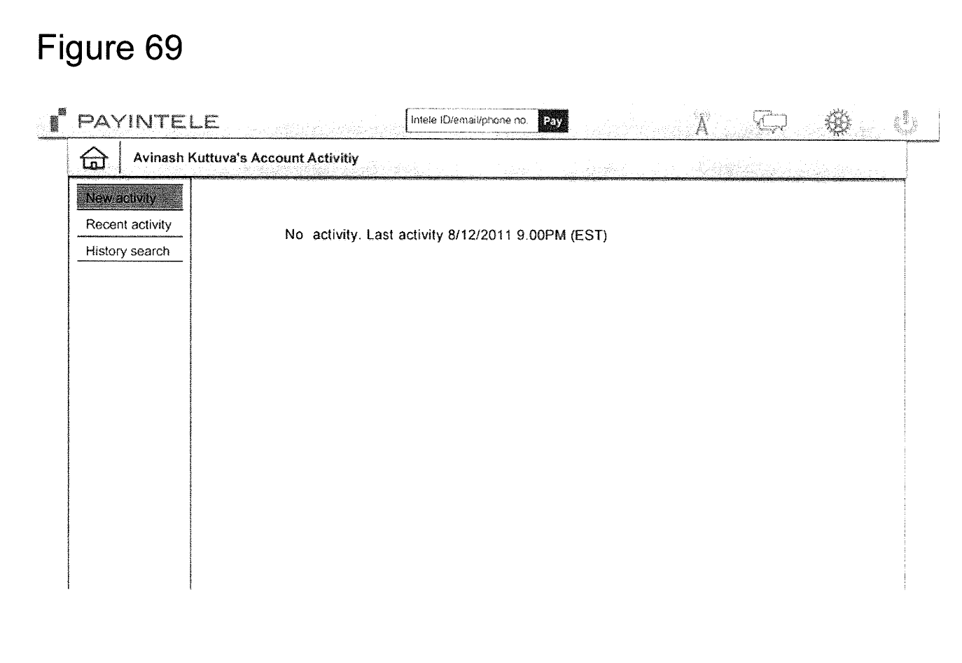

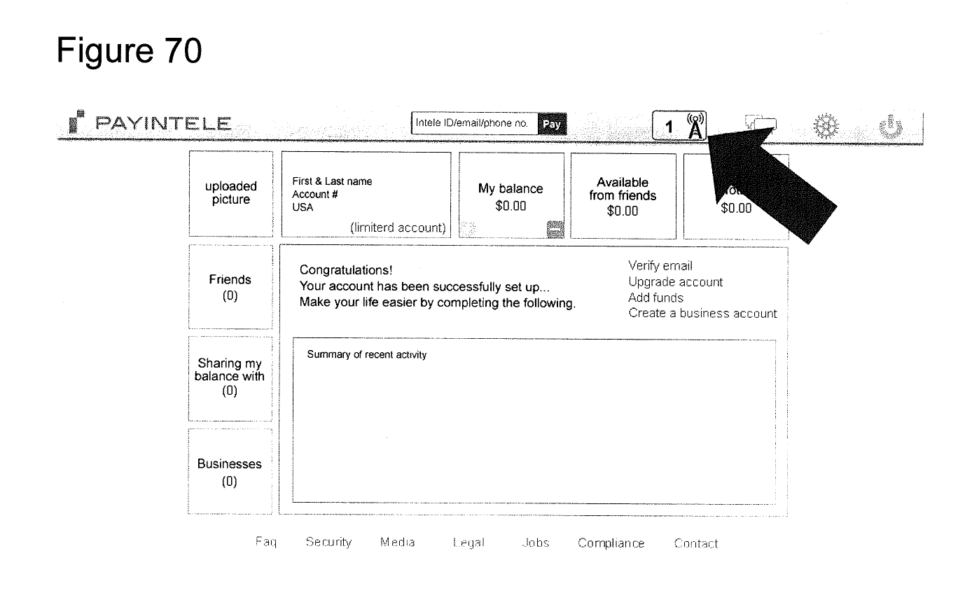

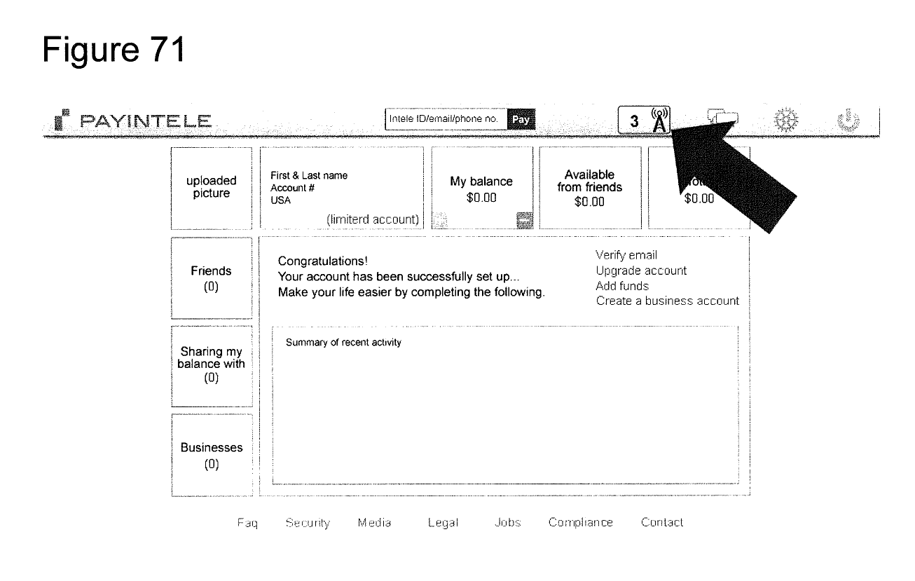

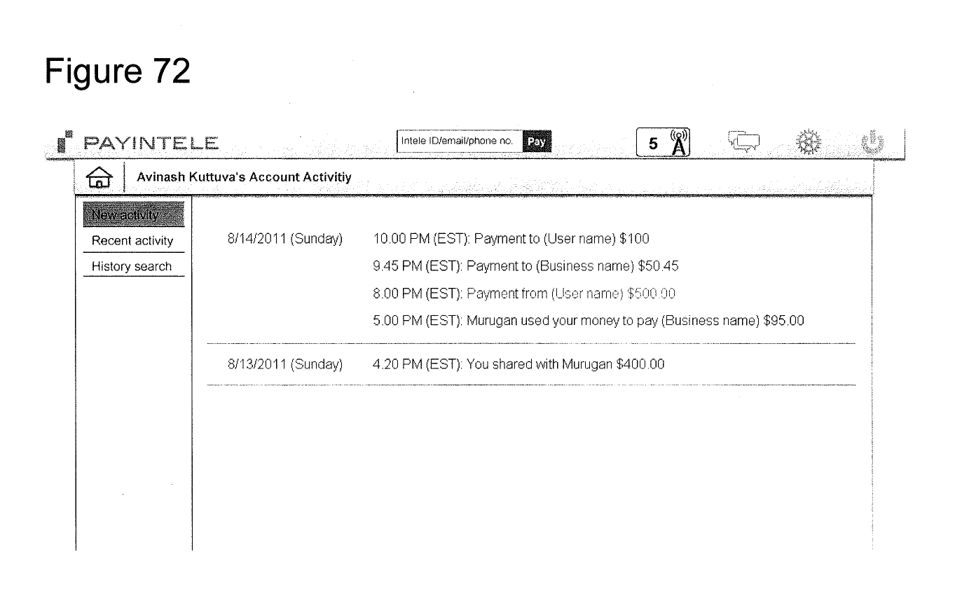

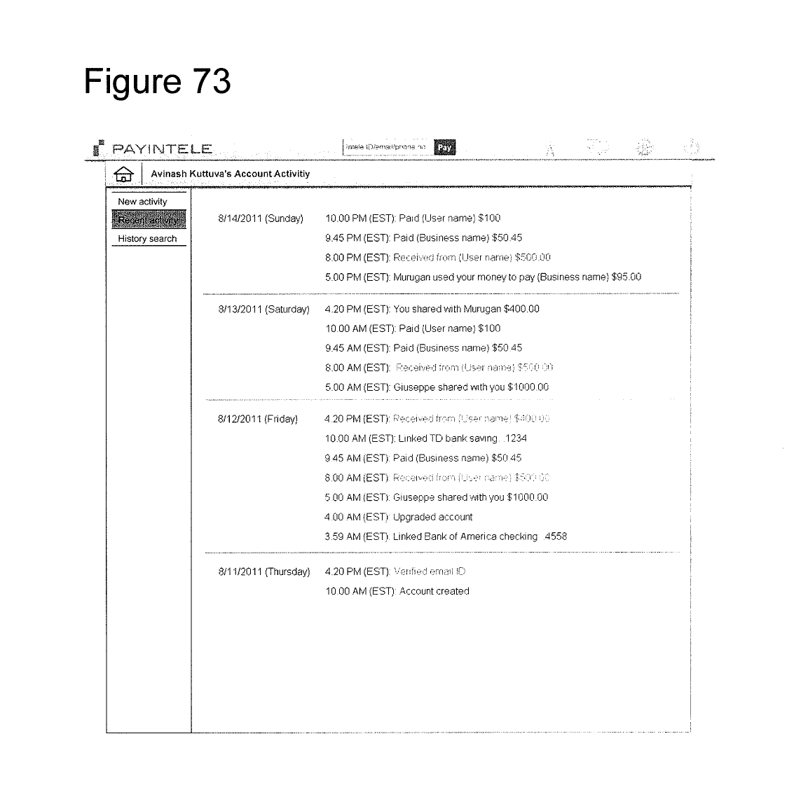

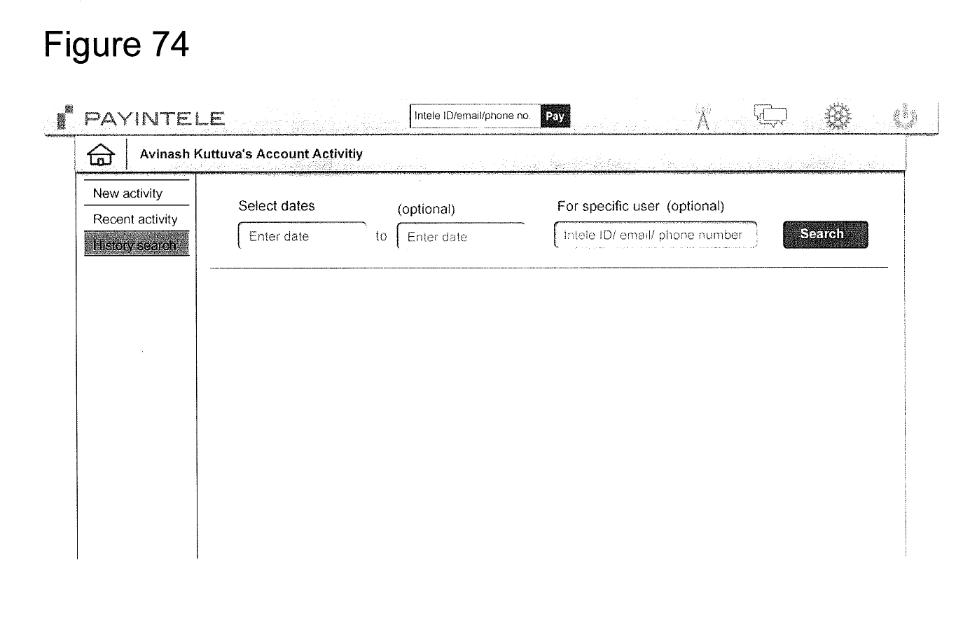

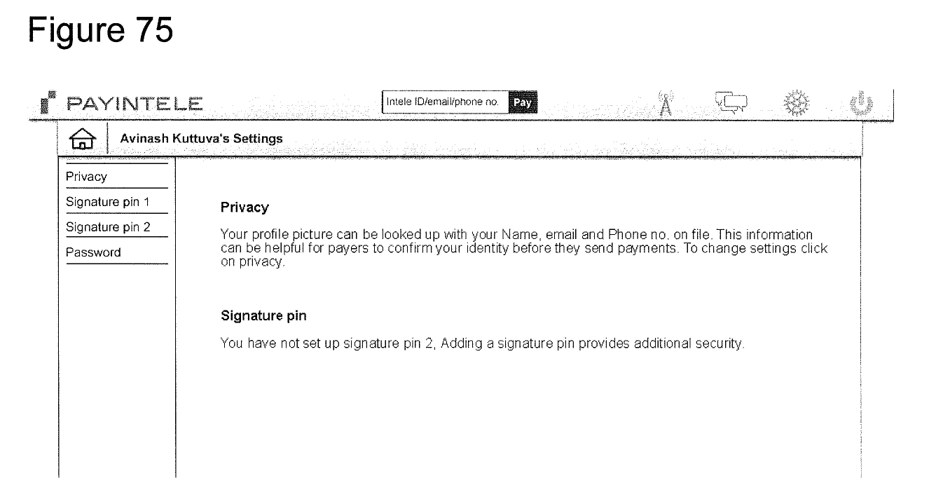

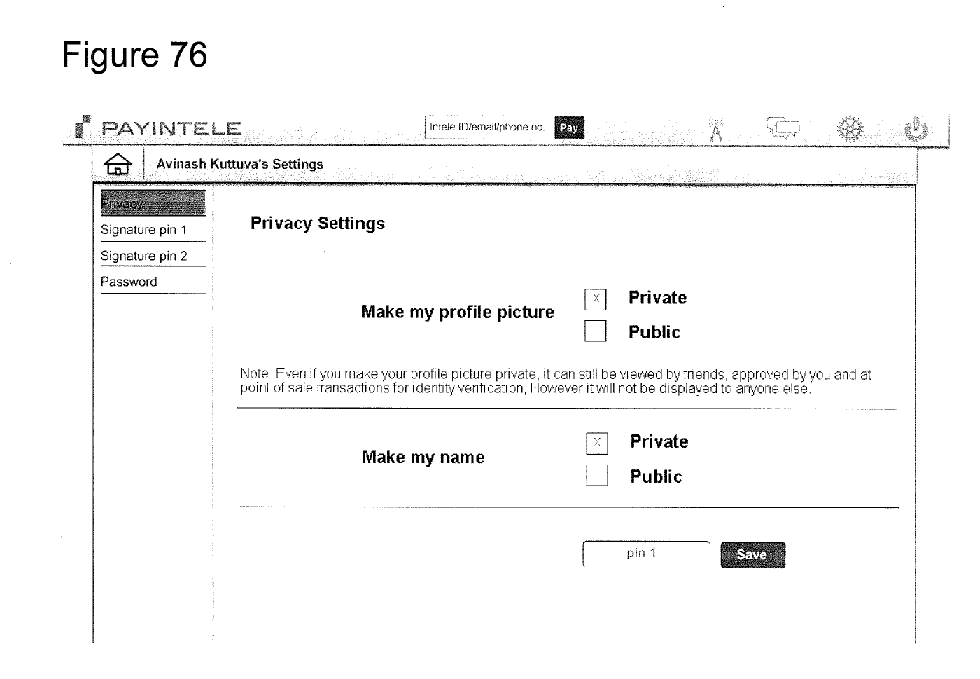

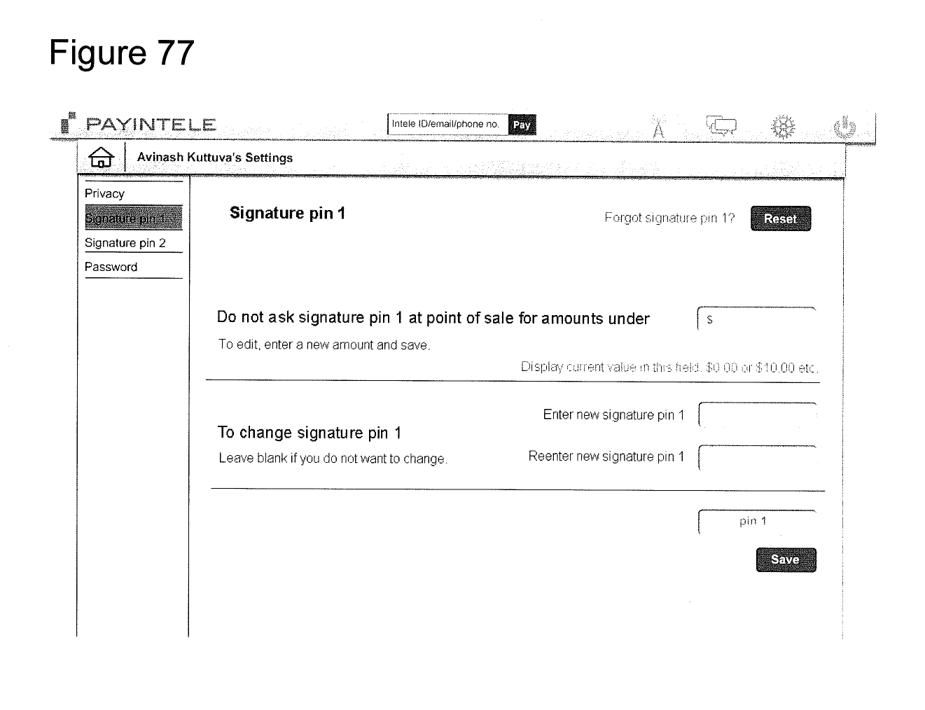

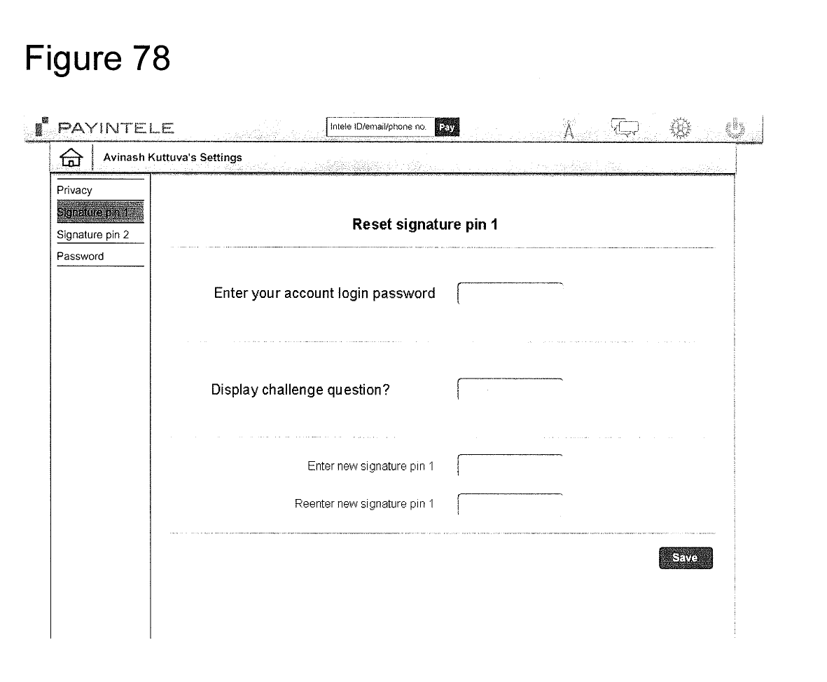

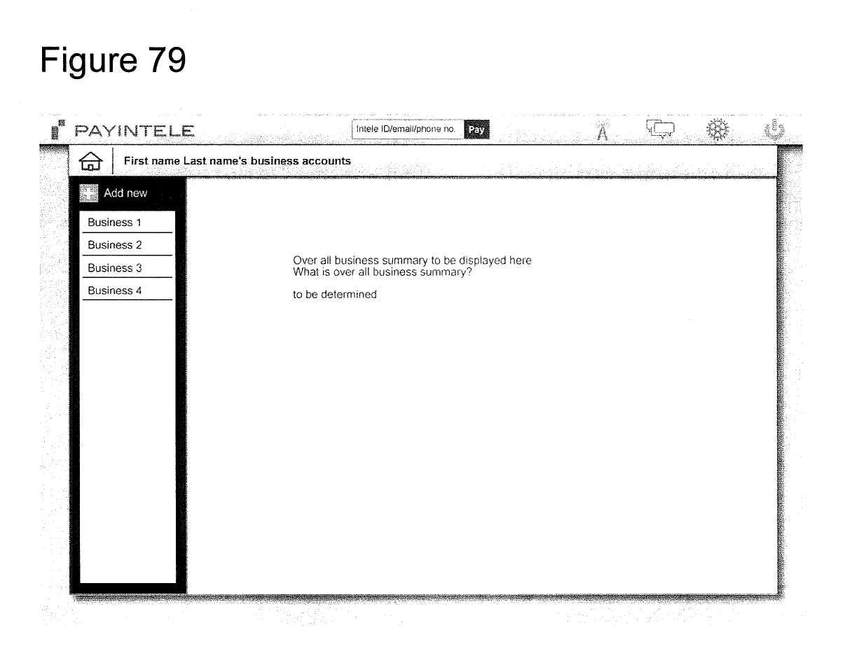

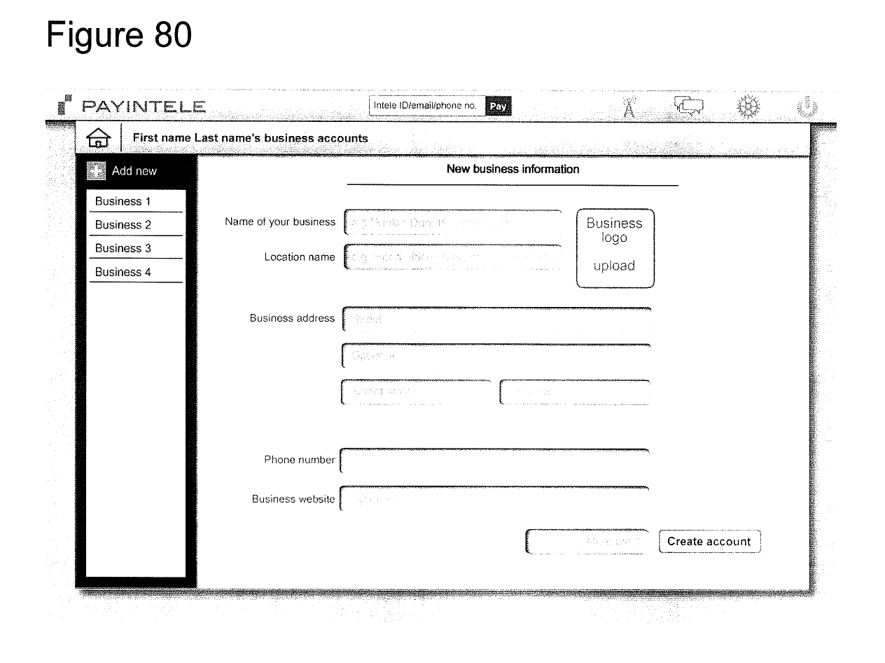

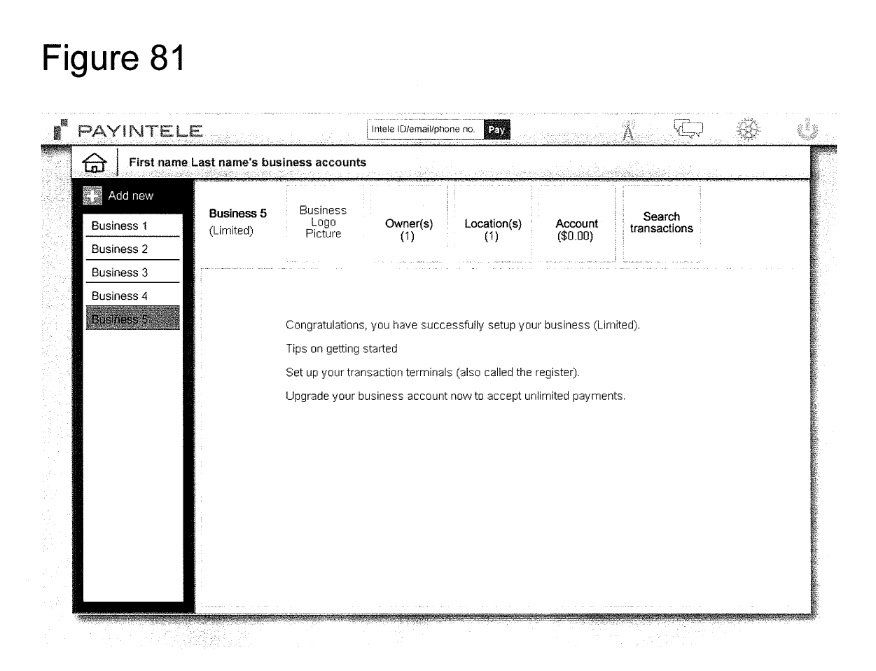

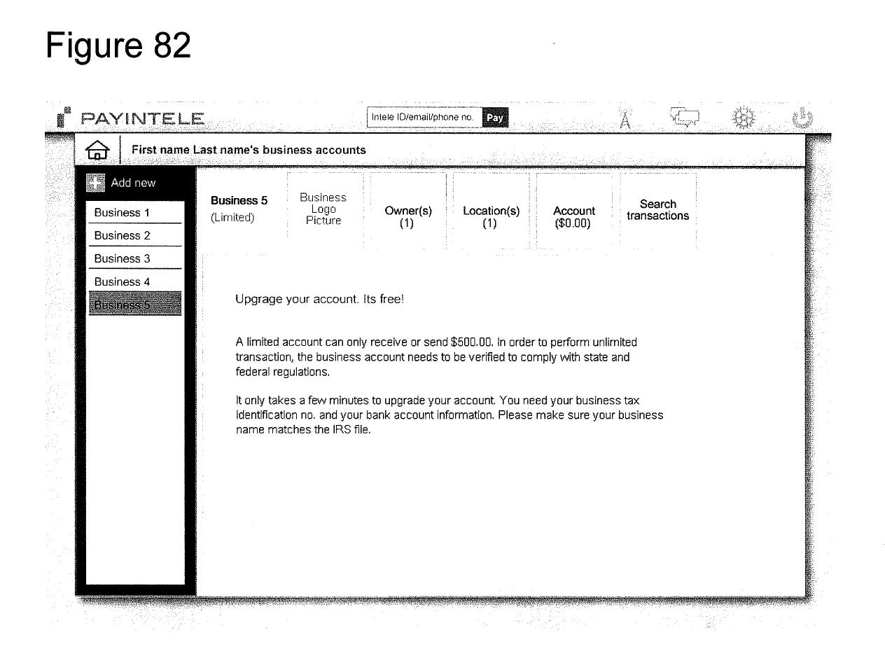

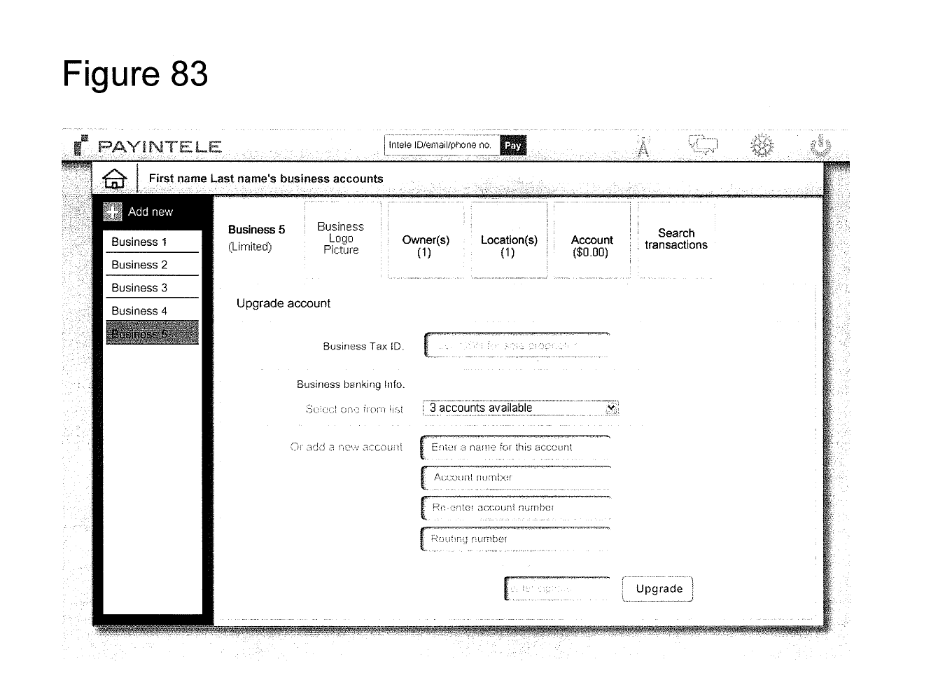

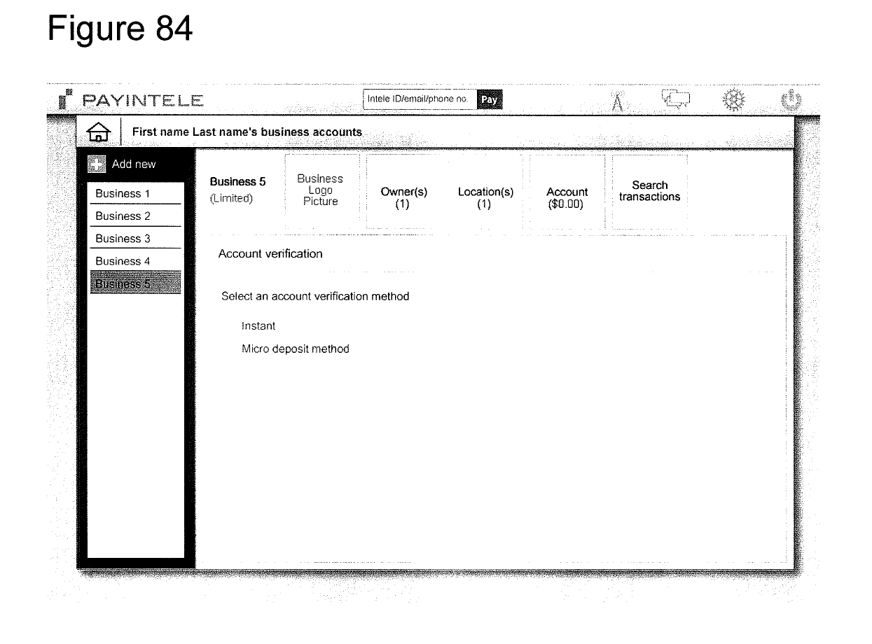

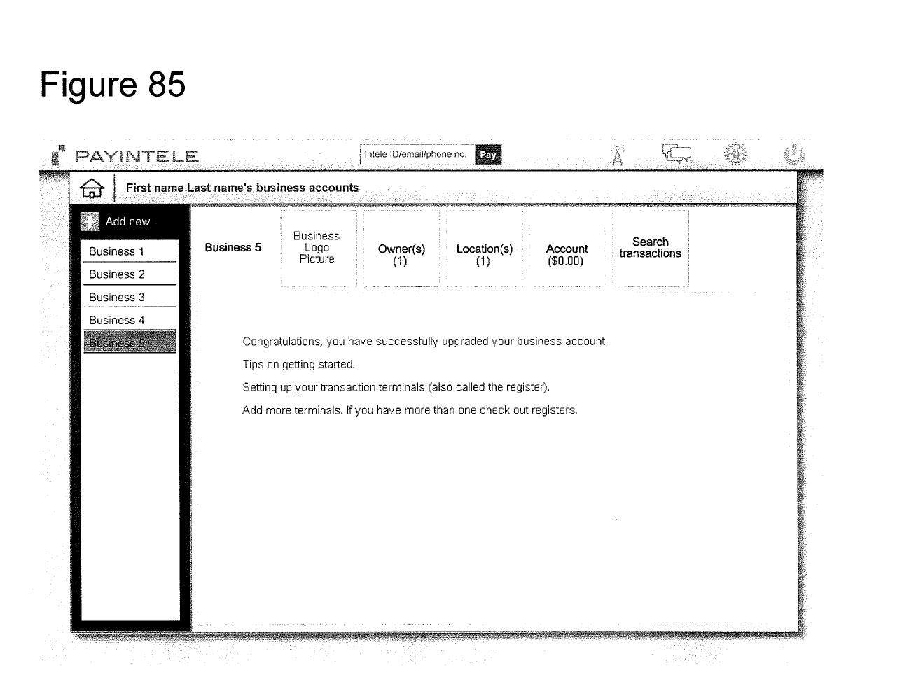

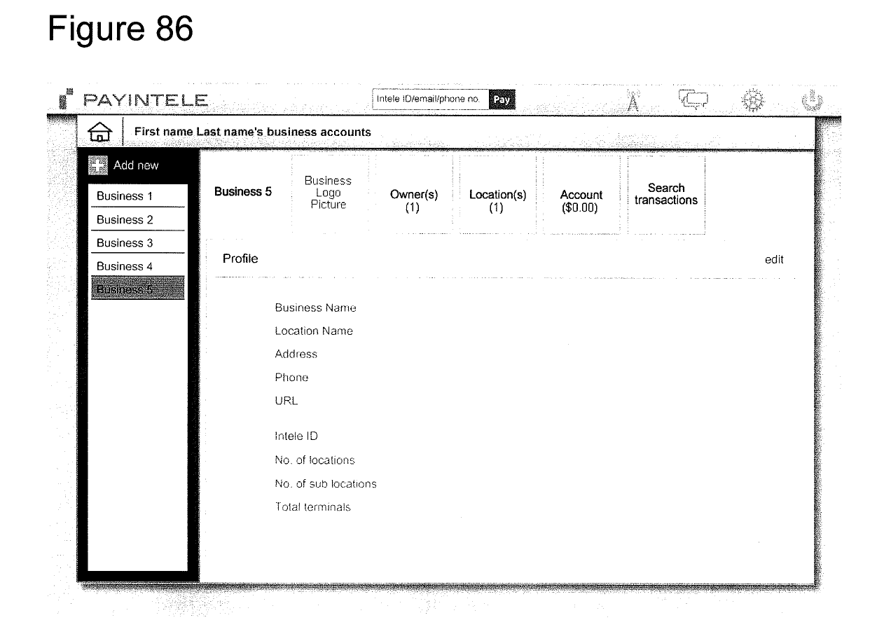

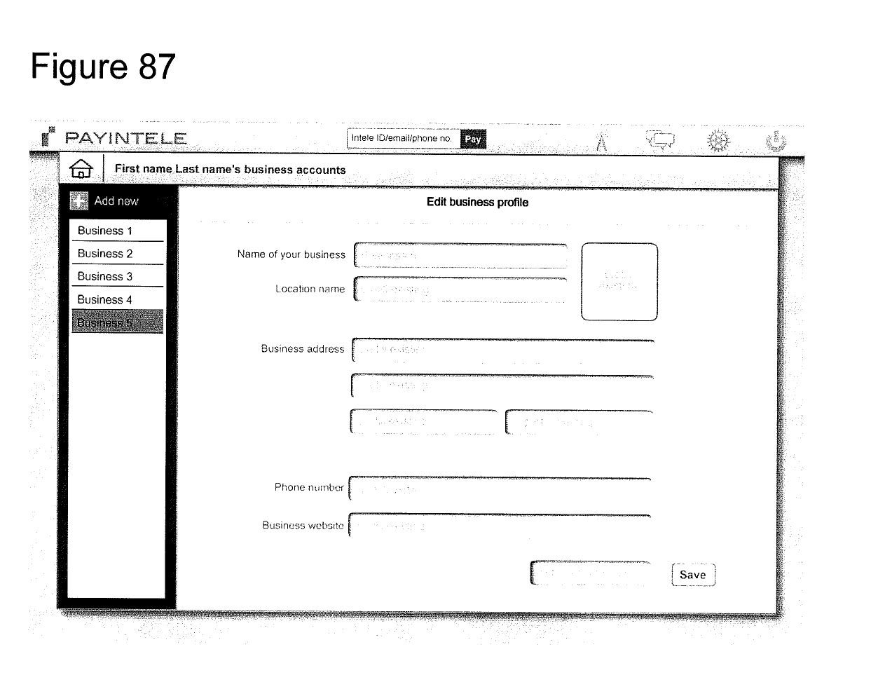

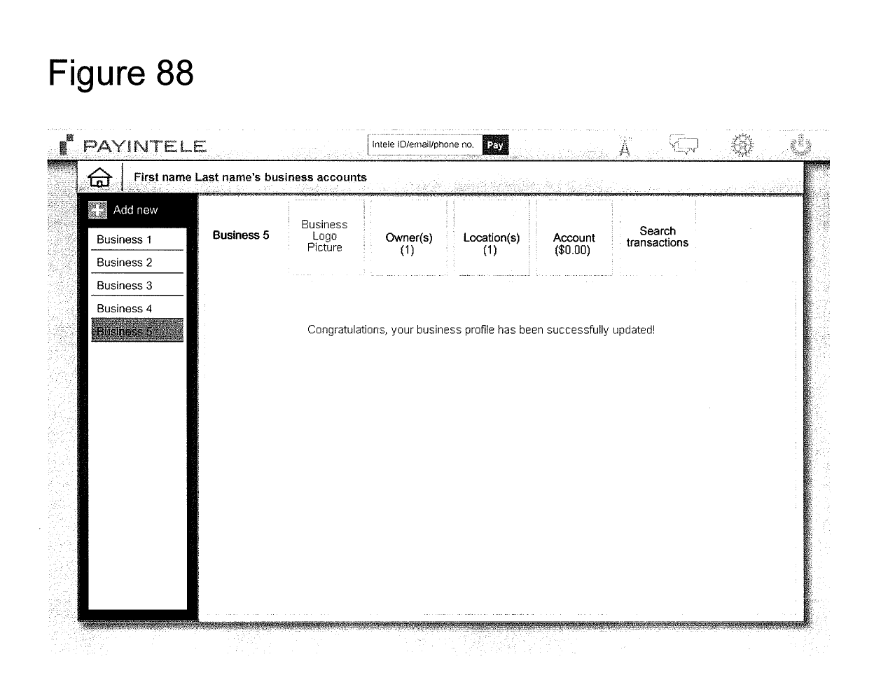

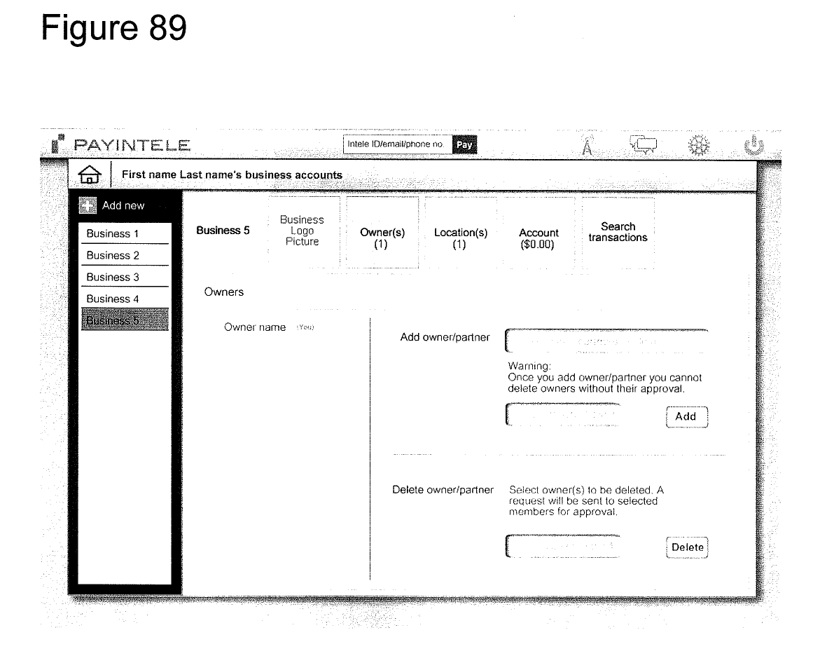

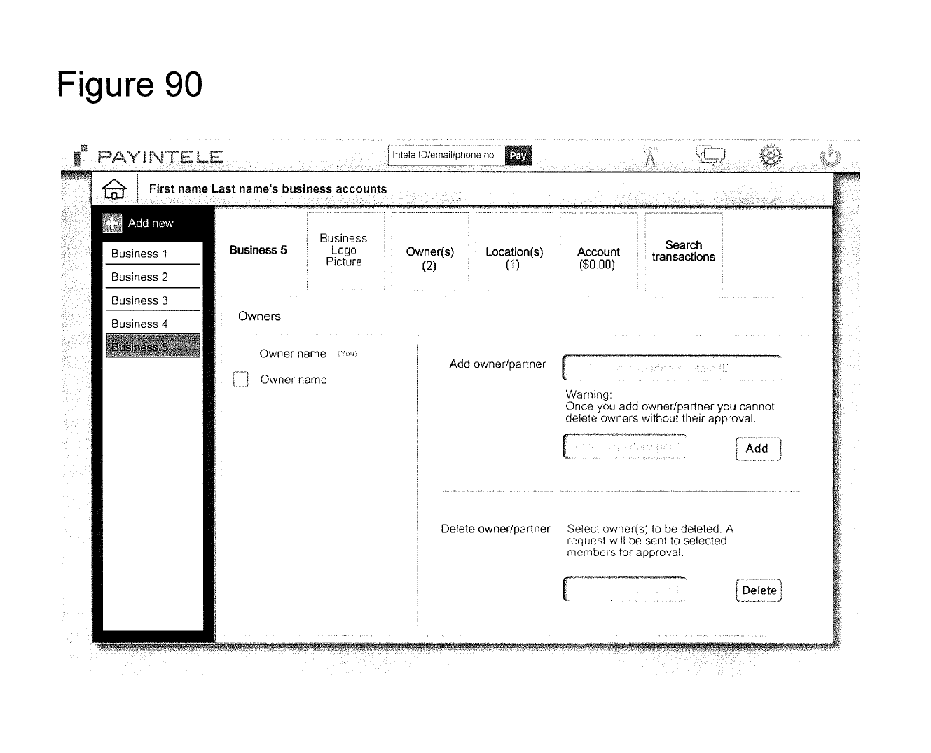

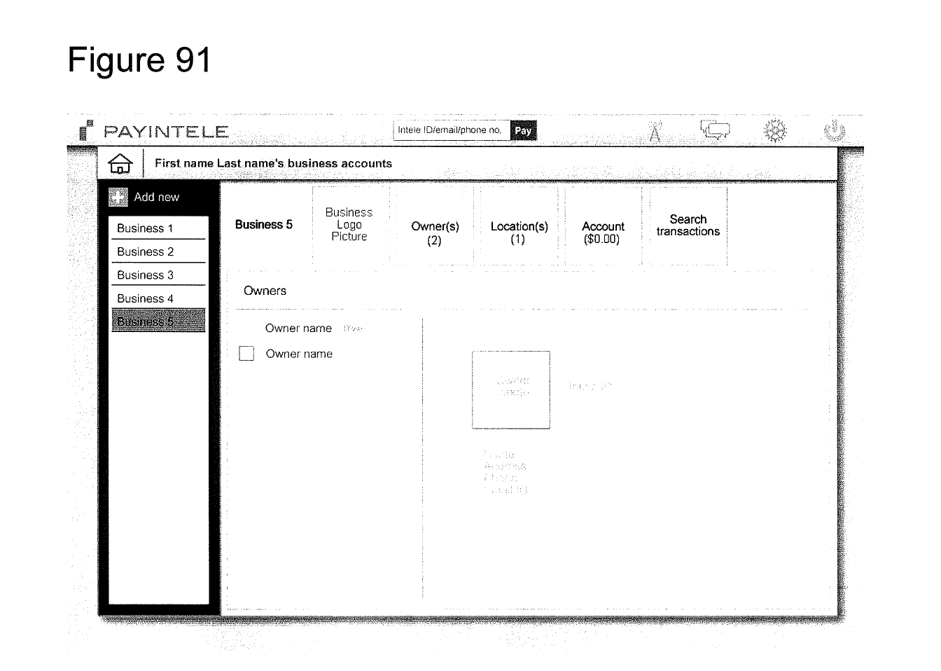

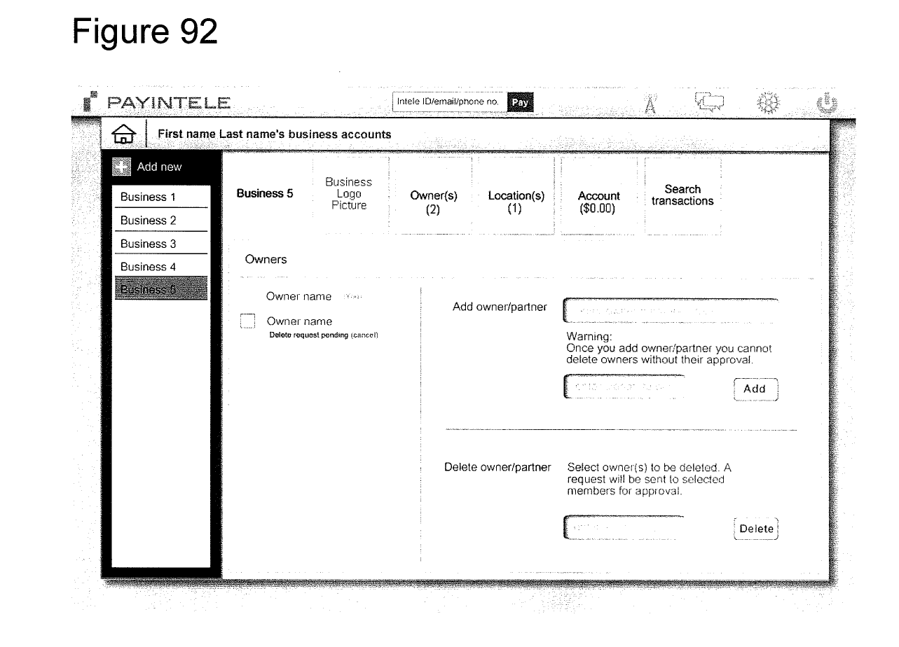

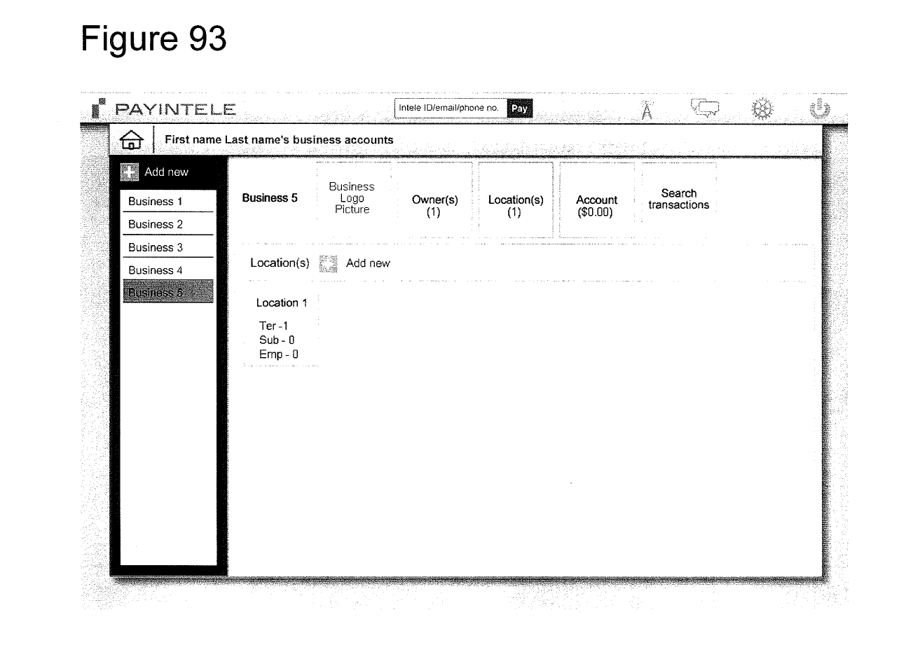

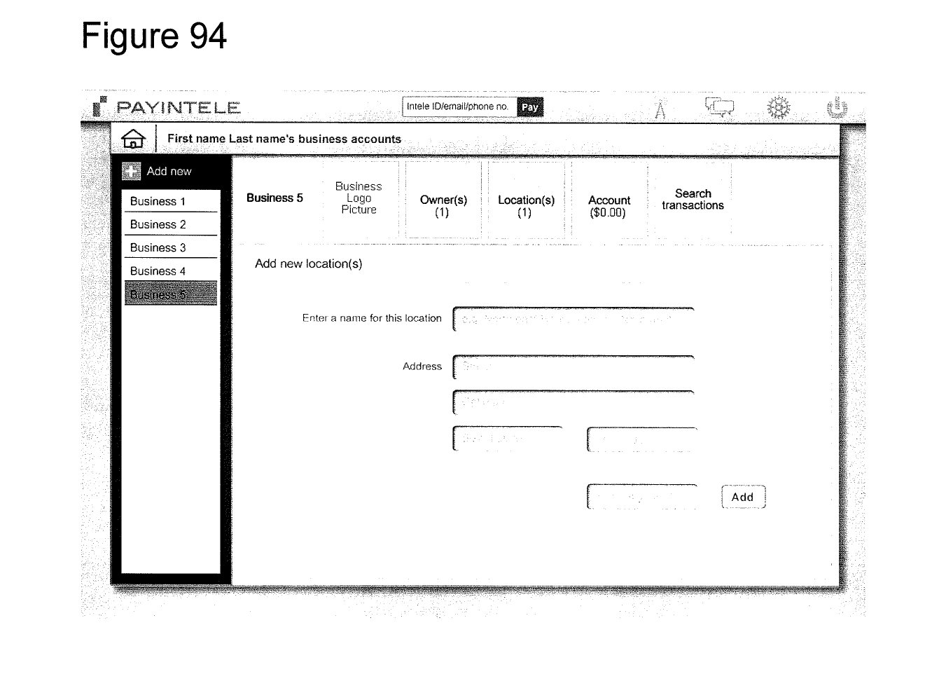

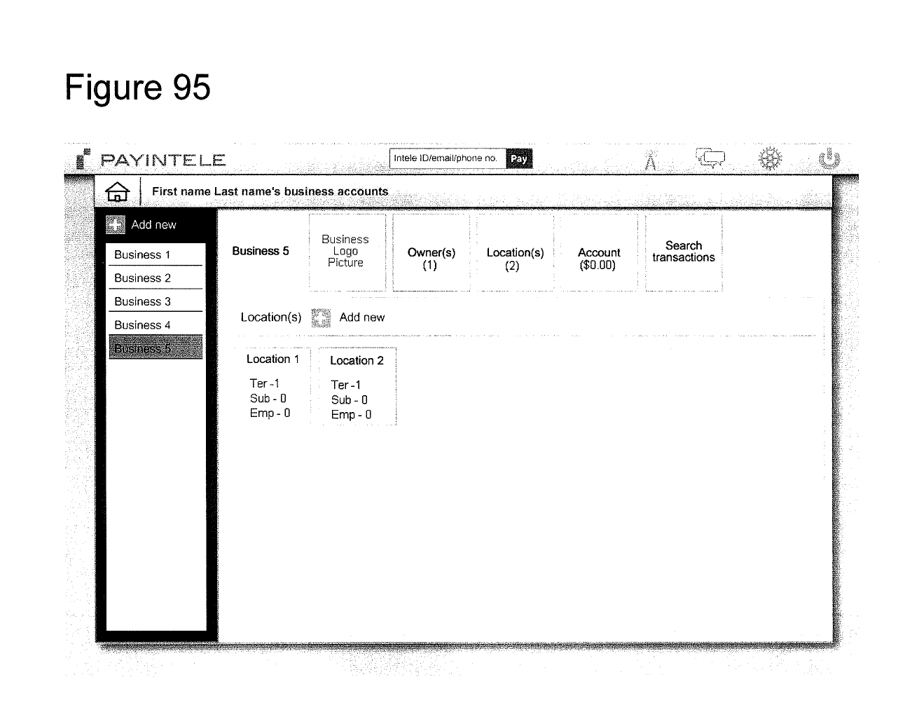

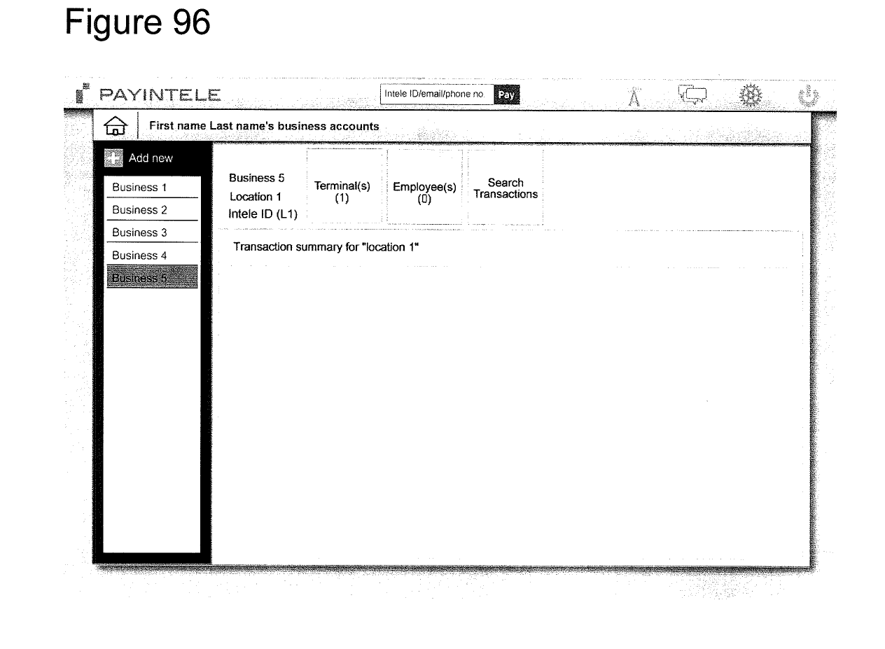

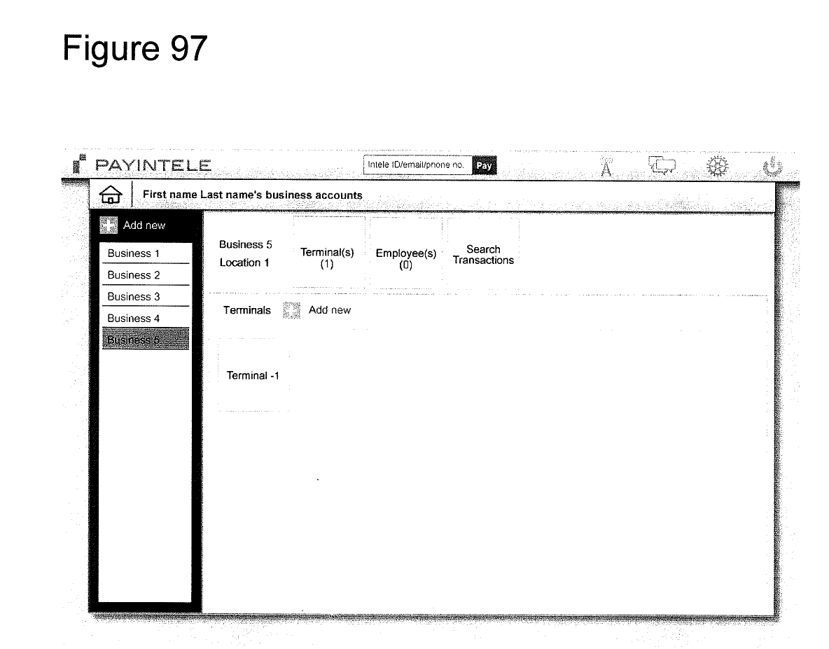

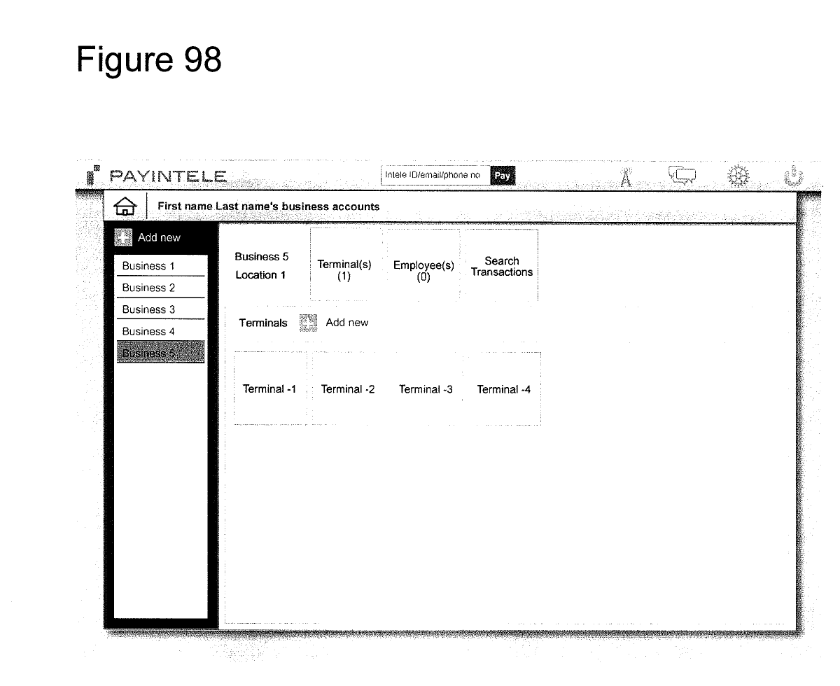

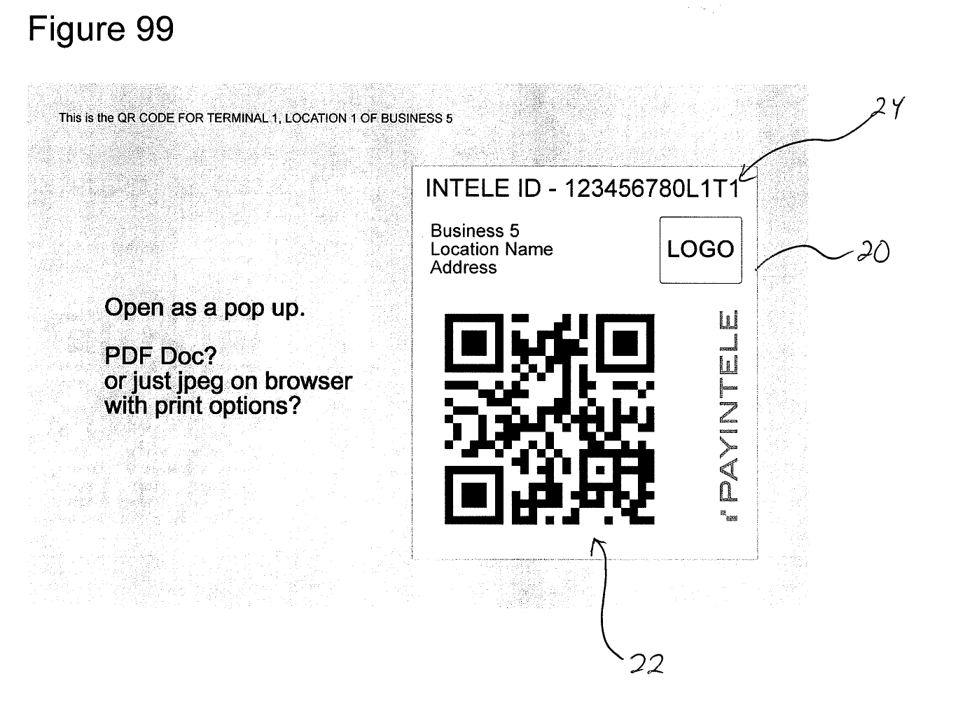

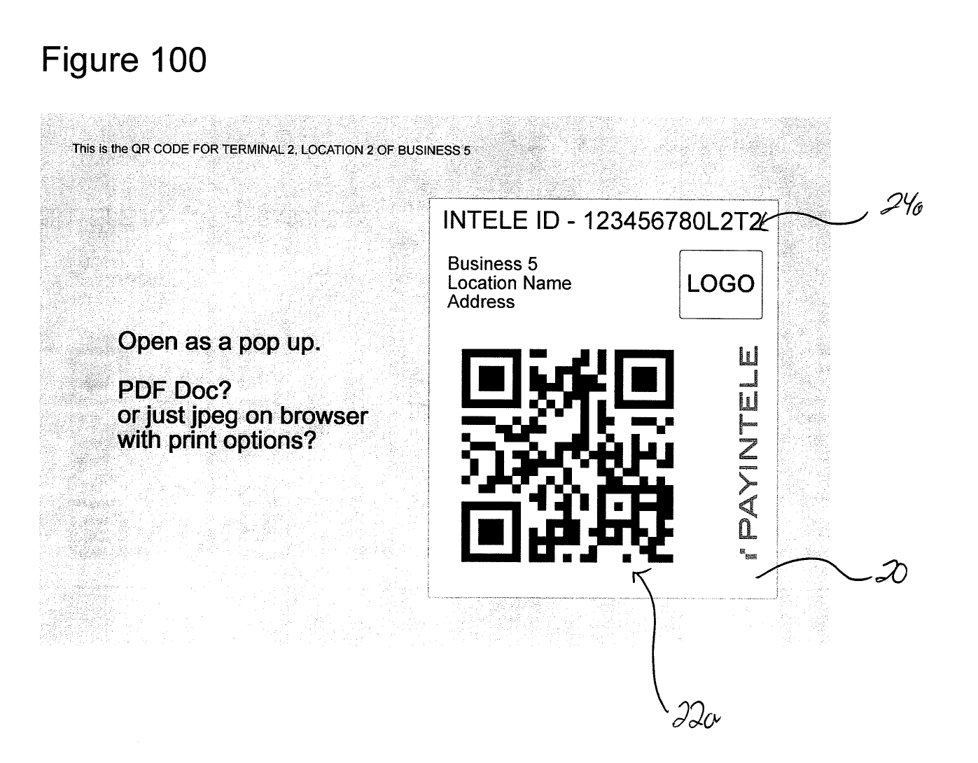

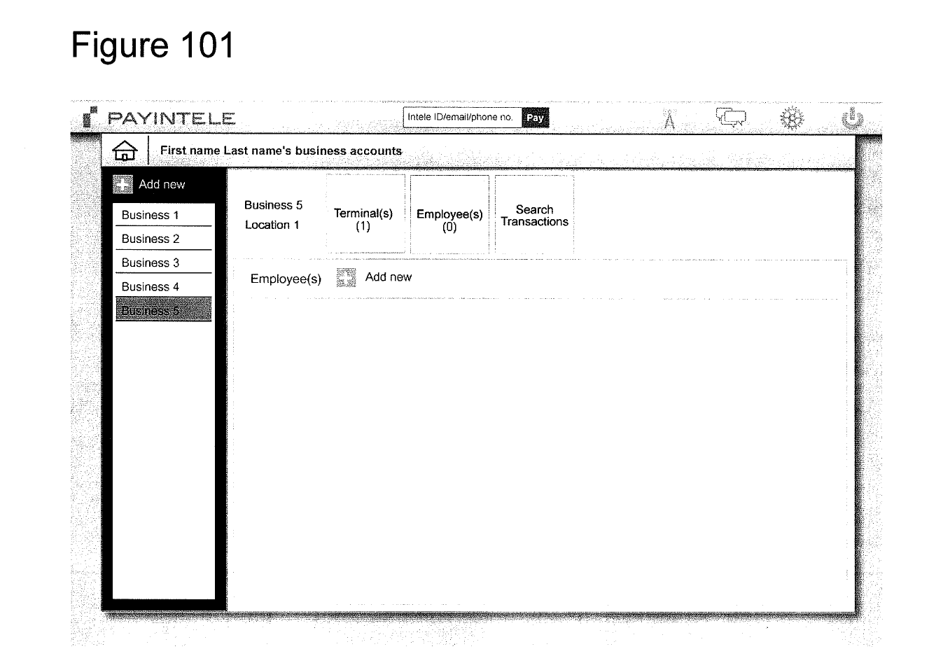

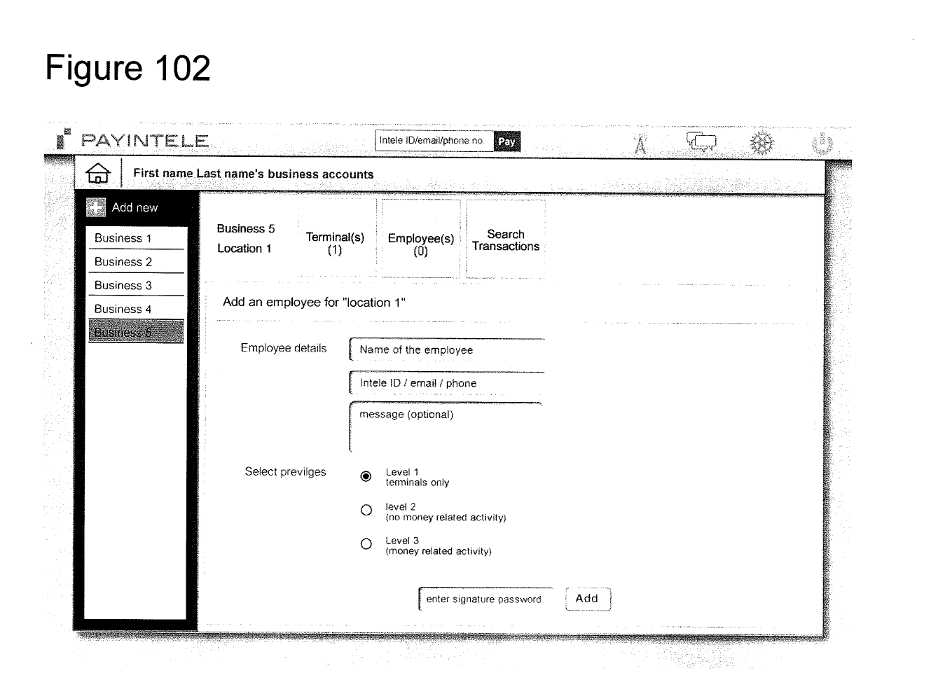

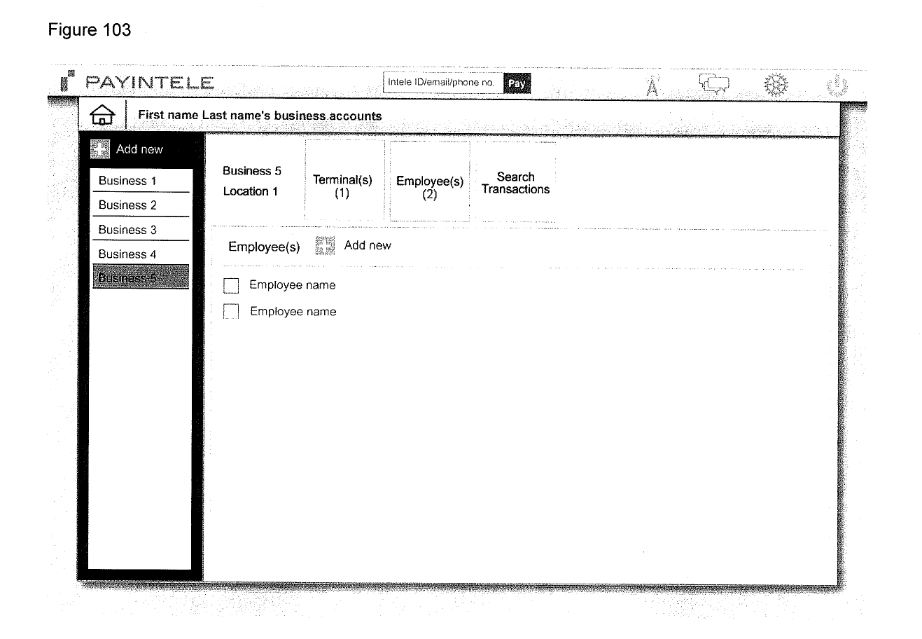

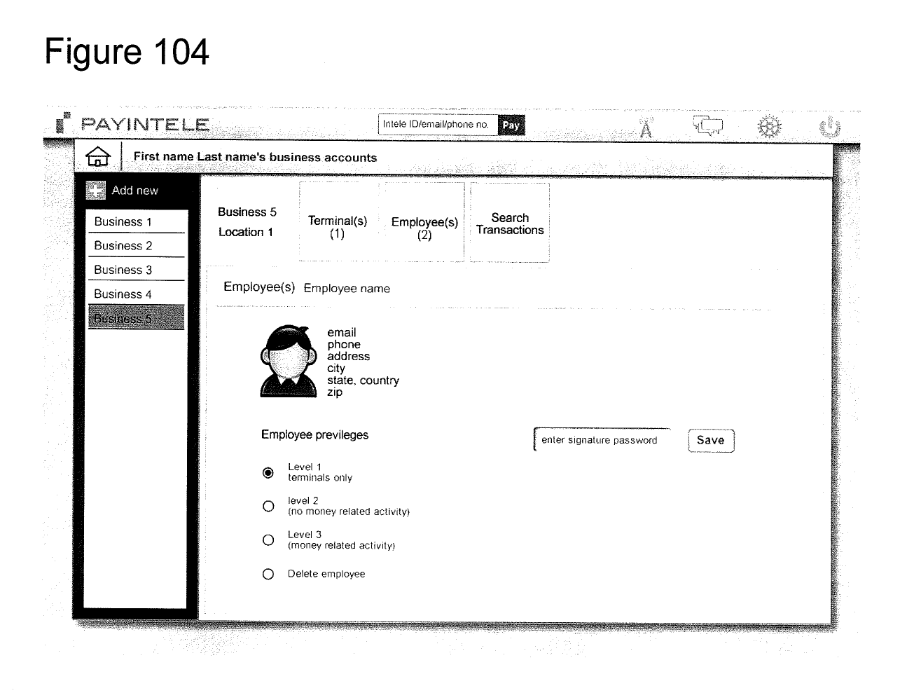

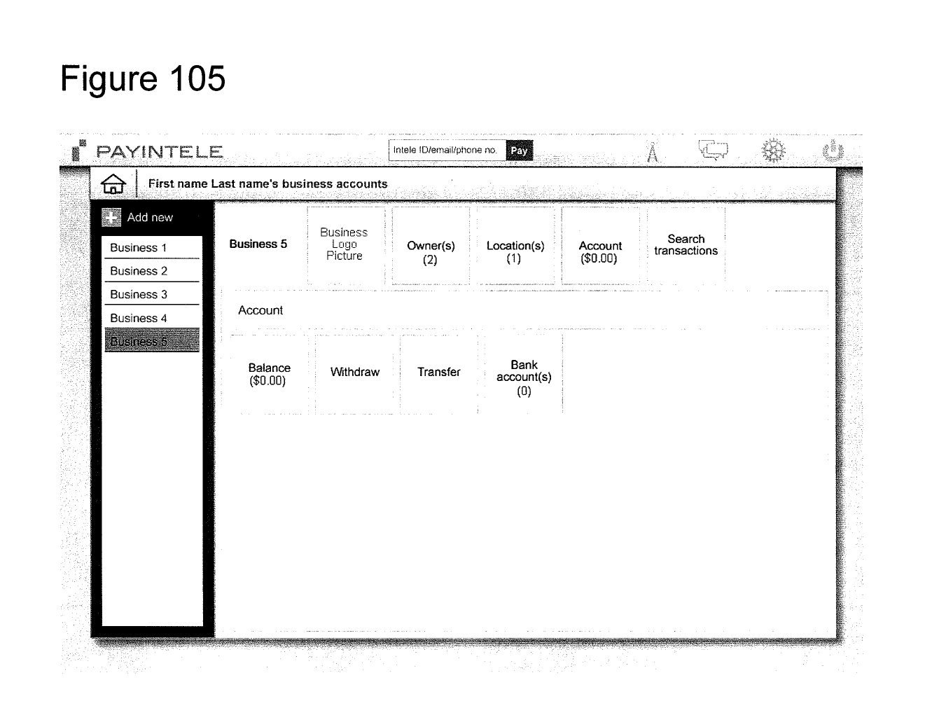

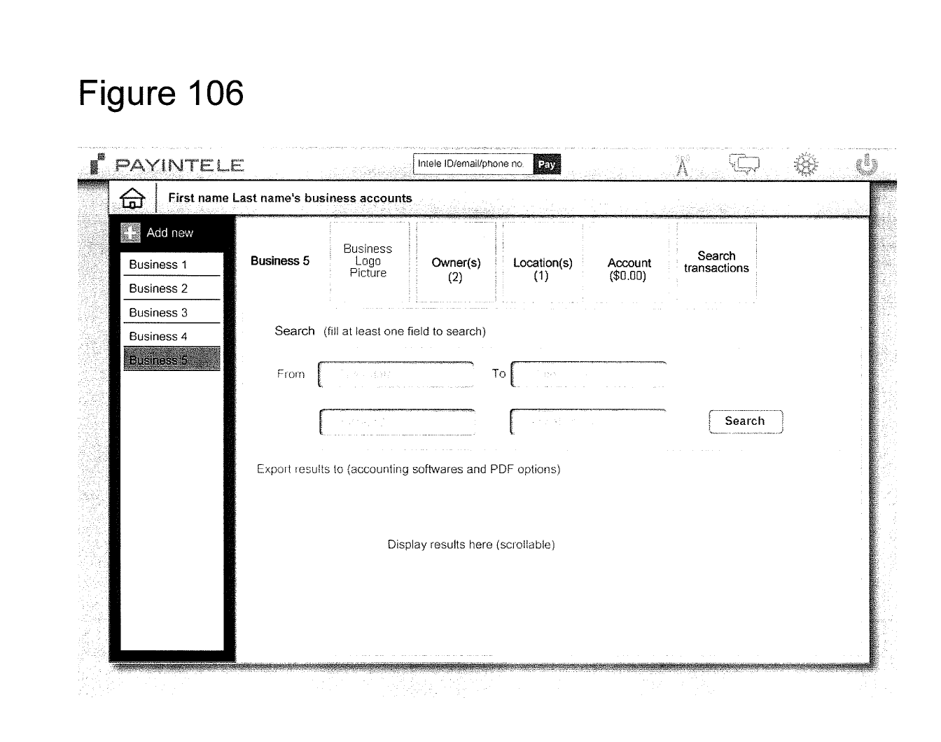

FIGS. 40-106 illustrate exemplary and self-explanatory user interface screens of a mobile device for payment transactions in accordance with exemplary embodiments of the Payintele system.

Provided below is a summary of how different payment methods work in comparison to the Payintele mobile payment system described herein.

Payment type - Person to person

| Payment | | | Payment | |
|---|---|---|---|---|
| method | Requirements | Procedure | settlement | Issues/Risks |
| Payintele | Receiver and | Payer shall scan | Instant. Receiver | Requires a |
| | payer create | QR code (or enter | can use funds | smart |
| | free accounts. | user ID manually), | instantly via | phone. |
| | Obtains | enter payment | Payintele. | Follow a |
| | unique user ID | amount, enter pin, | | modified |
| | and QR code | complete | | procedure |
| | from Payintele. | payment. | | when a |
| | | | | smartphone |
| | | | | is |
| | | | | unavailable. |
| Credit | N/A | N/A | N/A | Not available |
| card | | | | |
| Check | Payer must | Write a check, | Takes 1-3 days. | Trip to bank. |
| | purchase | Mail hard copy, or | | Checks may |
| | checks | deliver in person. | | be lost or |
| | | Receiver has to | | bounced. |
| | | deposit check at | | Exposure of |
| | | receiver's bank. | | payer's |
| | | | | complete |
| | | | | identity and |
| | | | | banking |
| | | | | information. |
| | | | | ID Theft. |
| Cash | Carry cash in | In person delivery | Instant. Receiver | Theft. |
| | hand | only. | can use funds to | Time |
| | | | make only | consuming to |
| | | | payments in | count |
| | | | person. | relatively |
| | | | | large |
| | | | | amounts. |
| | | | | Fake bills. |
| | | | | Safety. |
| Paypal | Payer and | Require user email | Instant. Receiver | |
| | receiver create | ID | can use funds | |
| | free accounts. | | instantly via | |
| | | | paypal. | |

Payment type - Retail, restaurants and similar POS.

| Payment | | | Payment | |
|---|---|---|---|---|
| method | Requirements | Procedure | settlement | Issues/Risks |
| Payintele | Receiver and | Payer shall scan | Instant. | Requires a smart |
| | payer create | QR code (or enter | Receiver | phone. |
| | free accounts. | user ID manually), | can use | Follow a modified |
| | Obtains | enter payment | funds | procedure when a |
| | unique user ID | amount, enter pin, | instantly via | smartphone is |
| | and QR code | complete | Payintele. | unavailable. |
| | from Payintele. | payment. | | |
| Credit | Receiver must | Varies widely. | Payment | Inconsistent |
| card | have a | Payer or merchant | settlement | processing |
| | merchant | swipes credit card. | overnight | methods. |
| | account. And | Payer signs | via bank | Cards may be |
| | obtain | receipt. Payers | accounts. | taken away from |
| | hardware or a | identity may be | | customers for |
| | software | verified | | processing |
| | service. Payer | | | (restaurants). |
| | must have a | | | Subject to frauds. |
| | credit account, | | | PCI compliance |
| | and a valid ID | | | issues. |
| | at all times. | | | Identity validation |
| | | | | protocols are |
| | | | | cumbersome and |
| | | | | not usually |
| | | | | practiced. |
| Check | Payer must | Write a check. | Takes 1-3 | Trip to bank. |
| | purchase | Receiver has to | days. | Checks may be |
| | checks | deposit check at | | lost or bounced. |
| | | receiver's bank. | | Exposure of |
| | | Instant check | | payer's complete |
| | | processing | | identity and |
| | | requires hardware | | banking |
| | | and merchant | | information. |
| | | service. | | ID Theft. |
| | | | | Checks are not |
| | | | | guaranteed |
| | | | | payment method. |
| Cash | Carry cash in | In person | Instant. | Theft. |
| | hand. | payment, Count | Receiver | Time consuming to |
| | | and verify amount. | can use | count relatively |
| | | Check for fake | funds to | large amounts. |
| | | bills. | make only | Fake bills. |
| | | | payments | Safety. |
| | | | in person. | |
| Paypal | Payer and | Require user email | Instant. | Generally not |
| | receiver create | ID | Receiver | accepted for POS |
| | free accounts. | | can use | payments due to |
| | | | funds | various issues. |
| | | | instantly via | Not designed for |
| | | | paypal. | this purpose. |

Payment type - Invoice payment

| Payment | | | Payment | |
|---|---|---|---|---|
| method | Requirements | Procedure | settlement | Issues/Risks |
| Payintele | Receiver and | Payer shall | Instant. Receiver | Requires a smart |
| | payer create | scan QR code | can use funds | phone. |
| | free accounts. | (or enter user | instantly via | Follow a modified |
| | Obtains unique | ID manually), | Payintele. | procedure when a |
| | user ID and QR | enter payment | | smartphone is |
| | code from | amount, enter | | unavailable. |
| | Payintele. | pin, complete | | |
| | | payment. | | |
| Credit | Receiver must | Varies widely. | Payment | Inconsistent |
| card | have a | credit card | settlement | processing methods. |
| | merchant | numbers are | overnight via | Subject to frauds. PCI |
| | account. And | received via | bank accounts. | compliance issues. |
| | obtain hardware | phone, fax, | | Identity validation |
| | or a software | email etc. | | protocols are |
| | service. Payer | | | cumbersome and not |
| | must have a | | | usually practiced. |
| | credit account, | | | |
| | and a valid ID at | | | |
| | all times. | | | |
| Check | Payer must | Write a check, | Takes 1-3 days. | Trip to bank. |
| | purchase | Mail hard copy, | | Checks may be lost or |
| | checks | or deliver in | | bounced. |
| | | person. | | Exposure of payer's |
| | | Receiver has to | | complete identity and |
| | | deposit check | | banking information. |
| | | at receiver's | | ID Theft. |
| | | bank. | | Checks are not |
| | | | | guaranteed payment |
| | | | | method. |
| Cash | Carry cash in | In person | Instant. Receiver | Theft. |
| | hand. | payment, Count | can use funds to | Time consuming to |
| | | and verify | make only | count relatively large |
| | | amount. Check | payments in | amounts. |
| | | for fake bills. | person. | Fake bills. |
| | | | | Safety. |
| Paypal | Payer and | Require user | Instant. Receiver | Rare used for various |
| | receiver create | email ID | can use funds | reasons. |
| | free accounts. | | instantly via | |
| | | | paypal. | |

Payment type - Home delivery and at home service.

| Payment | | | Payment | |
|---|---|---|---|---|
| method | Requirements | Procedure | settlement | Issues/Risks |
| Payintele | Receiver and | Payer shall | Instant. | Requires a smart |
| | payer create | scan QR code | Receiver can | phone. |
| | free accounts. | (or enter user | use funds | Follow a modified |
| | Obtains unique | ID manually), | instantly via | procedure when a |
| | user ID and QR | enter payment | Payintele. | smartphone is |
| | code from | amount, enter | | unavailable. |
| | Payintele. | pin, complete | | |
| | | payment. | | |
| Credit | Receiver must | Varies widely. | Payment | Inconsistent processing |
| card | have a | Payer or | settlement | methods. |
| | merchant | merchant | overnight via | Subject to frauds. PCI |
| | account. And | swipes credit | bank accounts. | compliance issues. |
| | obtain hardware | card. Payer | | Identity validation |
| | or a software | signs receipt. | | protocols are |
| | service. Payer | Payer's identity | | cumbersome and not |
| | must have a | may be verified. | | usually practiced. |
| | credit account, | When hardware | | Service professional are |
| | and a valid ID at | is unavailable, | | not trained on best |
| | all times. | credit card | | practice protocols for |
| | | numbers are | | credit card handling. |
| | | noted down or | | |
| | | relayed via | | |
| | | phone call by | | |
| | | the service | | |
| | | professional to | | |
| | | back office | | |
| | | personnel. | | |
| Check | Payer must | Write a check. | Takes 1-3 | Trip to bank. |
| | purchase | Receiver has to | days. | Checks may be lost or |
| | checks | deposit check | | bounced. |
| | | at receiver's | | Exposure of payer's |
| | | bank. | | complete identity and |
| | | Instant check | | banking information. |
| | | processing | | ID Theft. |
| | | requires | | Checks are not |
| | | hardware and | | guaranteed payment |
| | | merchant | | method. |
| | | service. | | |
| Cash | Carry cash in | In person | Instant. | Theft. |
| | hand. | payment, Count | Receiver can | Time consuming to count |
| | | and verify | use funds to | relatively large amounts. |
| | | amount. Check | make only | Fake bills. |
| | | for fake bills. | payments in | Safety. |
| | | | person. | Need reliable employees. |
| Paypal | Payer and | Require user | Instant. | Generally not accepted. |
| | receiver create | email ID | Receiver can | Not designed for this |
| | free accounts. | | use funds | purpose. |
| | | | instantly via | |
| | | | paypal. | |

Payment type - In-flight payment

| Payment | | | Payment | |
|---|---|---|---|---|
| method | Requirements | Procedure | settlement | Issues/Risks |
| Payintele | Receiver and | Payer shall scan | Instant. Receiver | Requires a smart |
| | payer create | QR code (or | can use funds | phone. |
| | free accounts. | enter user ID | instantly via | Follow a modified |
| | Obtains unique | manually), enter | Payintele. | procedure when a |
| | user ID and QR | payment amount, | | smartphone is |
| | code from | enter pin, | | unavailable. |
| | Payintele. | complete | | |
| | | payment. | | |
| Credit | Receiver must | Varies widely. | Payment | Inconsistent |
| card | have a | credit card | settlement | processing methods. |
| | merchant | numbers are | overnight via | Subject to frauds. PCI |
| | account. And | received via | bank accounts. | compliance issues. |
| | obtain hardware | phone, fax, email | | Identity validation |
| | or a software | etc. | | protocols are |
| | service. Payer | | | cumbersome and not |
| | must have a | | | usually practiced. |
| | credit account, | | | May incur additional |
| | and a valid ID at | | | convenience fees. |
| | all times. | | | |
| Check | Payer must | Write a check. | Takes 1-3 days. | Generally not |
| | purchase | Receiver has to | | accepted. |
| | checks | deposit check at | | Trip to bank. |
| | | receiver's bank. | | Checks may be lost or |
| | | | | bounced. |
| | | | | Exposure of payer's |
| | | | | complete identity and |
| | | | | banking information. |
| | | | | ID Theft. |
| | | | | Checks are not |
| | | | | guaranteed payment |
| | | | | method. |
| Cash | Carry cash in | In person | Instant. Receiver | Theft. |
| | hand. | payment, Count | can use funds to | Time consuming to |
| | | and verify | make only | count relatively large |
| | | amount. Check | payments in | amounts. |
| | | for fake bills. | person. | Fake bills. |
| | | | | Safety. |
| | | | | Exact change |
| | | | | preferred. |
| | | | | All currencies may not |
| | | | | be accepted. |
| Paypal | Payer and | Require user | Instant. Receiver | Not designed for this |
| | receiver create | email ID | can use funds | purpose. |
| | free accounts. | | instantly via | |
| | | | paypal. | |

Payment type - Online shopping

| Payment | | | Payment | |
|---|---|---|---|---|
| method | Requirements | Procedure | settlement | Issues/Risks |
| Payintele | Receiver and | Payer shall | Instant. | Requires a smart |
| | payer create | scan QR code | Receiver can | phone. |
| | free accounts. | (or enter user | use funds | Follow a modified |
| | Obtains unique | ID manually), | instantly via | procedure when a |
| | user ID and QR | enter payment | Payintele. | smartphone is |
| | code from | amount, enter | | unavailable. |
| | Payintele. | pin, complete | | |
| | | payment. | | |
| | | Merchant | | |
| | | receives | | |
| | | payment | | |
| | | notification with | | |
| | | order details. | | |
| Credit | Receiver must | Credit card | Payment | Inconsistent processing |
| card | have a | number is | settlement | methods. Subject to |
| | merchant | transmitted | overnight via | frauds. PCI compliance |
| | account. And | online. Users | bank accounts. | issues. |
| | obtain a | may be unable | | Identity validation |
| | software | to verify the | | protocols are not usually |
| | service. Payer | merchant's | | practiced. |
| | must have a | website's trust | | |
| | credit account. | worthiness. | | |
| Check | Payer must | Electronic | Takes 1-3 | Order may not be |
| | purchase | check | days. | processed until check |
| | checks | processing may | | clears. |
| | | or may not be | | Exposure of account |
| | | available on all | | details. |
| | | sites. | | |
| Cash | N/A | N/A | N/A | Not available |
| Paypal | Payer and | Payer has to | Instant. | Consumers do not trust |
| | receiver create | login to paypal | Receiver can | or use this method |
| | free accounts. | account to | use funds | unless merchant is well |
| | Merchant | authorize | instantly via | known. |
| | account is | payments. | paypal. | Since paypal is designed |
| | required. | | | mainly for online |
| | | | | transactions, and not |
| | | | | generally used at brick |
| | | | | and mortar locations, this |
| | | | | method lacks wide |
| | | | | adaption. |

Accordingly, it should be appreciated that the Payintele payment system described here provides a mobile wallet application that can be used by users across the globe seamlessly. The app allows users to initiate and complete a payment transaction, whether it is just to make a payment or to complete the entire shopping process including payment in a consistent manner. Further, users can seamlessly make payments to merchants and other users across the globe, regardless of the currency denomination and source of funds in the user's wallet account. Further, the app can integrate a business user's mobile interface to allow customers to purchase products, services, perform other activities and make a payment when required, without having to: download different mobile applications for different businesses, register for an account with those businesses, register for a new third party account, or provide personal and financial information to the businesses when this information is not relevant to the transaction.

In certain embodiments, the system each user first creates a user account, and then under each individual's account, permits creation of a number of business profiles for the purpose of conducting business transactions, a number of locations and sub-locations under each business profile, a number of terminals for each location, for the purpose of accepting payments and receiving payment notifications, and employee profiles and assign employee privileges, to effectively manage business payments and payment notifications.

Further, mobile wallet app users can efficiently manage their available source of funds and prevent accumulation of stale funds by taking other factors into consideration for the purpose of suggesting an ideal payment source for each transaction. Those factors include, but are not limited to: payment receiver business information; payment receiver's location details; currency denomination accepted by the receiver; funding sources available in the payor's account; available store credits; available coupons; funding denominations available in the payor's account; payer's location; payor's home country; and transaction amount.

Further still, the payment system may use a static QR code or any other scannable code, not only to reduce data entry, but also to deliver the information required to initiate a specific type of transaction that is intended by the payment receiver.

It should further be noted that the mobile wallet application can also allow customers to add items to a web shopping cart, but to complete the payment portion of the online web order from the customer's mobile device, without entering any information on the website.

Further, the application does not require the customers to exchange personal and financial information with the merchant to complete a payment transaction, regardless of the proximity of the transacting parties.

Further still, customers may shop with many merchants without registering for an account with any merchant.

Further still, the app allows customers to purchase products and services from printed catalogs and other similar without contacting the merchants and without visiting the merchant's websites.

Accordingly, it will be understood that the mobile app literally allows a user to replace his physical wallet by enabling the user to store various funding sources such as credit accounts, debit accounts, preloaded funds, funds from other users, coupons, merchant credit and gift credits etc. in association with his user account, and to access them via the app, without the need for physical cards, checks, etc. Further, the app makes available the combined value of all available funds from all their funding sources that are linked to the user's wallet. Users who have created a business profile can also create customized mobile shopping interfaces for their businesses that are specific to their business needs that are integrated to the mobile wallet application for easy access by customers that use the mobile wallet application.

Advantageously, the inventive payment system allows customers to stay anonymous (with respect to the vendor) during purchase transactions, thus protecting their personal and financial information while shopping online for goods that need to be delivered by mail. Accordingly, the system protects a consumer's personal and financial data by preventing businesses from storing consumer information on businesses databases. Further, the system allows its users to access any businesses mobile interface instantly without downloading or installing additional mobile applications.

The above examples should be considered to be exemplary embodiments, and are in no way limiting of the present invention. Thus, while the description above refers to particular embodiments, it will be understood that many modifications may be made without departing from the spirit thereof. To keep the document concise and avoid repetition, some descriptions are not included under the title “Detailed Description” if the explanation is included with the drawings.

1. A payment system comprising:
a payor electronic computing device comprising:
a microprocessor for executing instructions;
a memory operably connected to the microprocessor;
an imaging device; and
instructions stored in the memory and executable by the microprocessor to:
interpret a code scanned by the imaging device to identify a payee identification code associated with a payee;
interpret a code scanned by the imaging device to identify instructions for conducting a payment transaction to transfer funds to the payee;
gather payment information from a payor via the payor electronic computing device in accordance with the instructions; and
initiate a payment transaction for transferring funds from the payor to the payee.

2. The payment system of claim 1, further comprising a system electronic computing device for creating a code encapsulating the payee identification code.

3. The payment system of claim 1, wherein the code comprises a QR code.

4. The payment system of claim 3, wherein the QR code encapsulates the payee identification code.

5. The payment system of claim 3, wherein the QR code encapsulates the instructions for conducting a payment transaction.

6. The payment system of claim 1, further comprising:
a payment processing system for receiving from the payor electronic computing device instructions for completing a transaction involving tendering a payment to a payee.

7. The payment system of claim 1, further comprising:
a payee notification system configured to receive confirmation of completion of the transaction from the payment processing system, and to signal completion of the payment transaction to the payee.

8. The payment system of claim 7, wherein the payee notification system is configured to display a confirmatory message via a payee electronic computing device.

9. The payment system of claim 1, further comprising instructions stored in the memory and executable by the microprocessor for selecting from a list of payment sources available to the payor a recommended payment source for use in making a payment to the payee.

10. The payment system of claim 9, further comprising instructions stored in the memory and executable by the microprocessor for displaying via the payor electronic computing device the recommended payment source as a preferred payment source in a list of available payment sources.

11. The payment system of claim 1, wherein the list of payment sources comprises a plurality of payment sources in a plurality of distinct currencies.

12. A payment system comprising:
a payor electronic computing device comprising:
a microprocessor for executing instructions;
a memory operably connected to the microprocessor; and
instructions stored in the memory and executable by the microprocessor to:
receive a code uniquely associated with a particular payee;
gather payment information from a payor via the payor electronic computing device; and
initiate a payment transaction for transferring funds from a funding source associated with the payor to the particular payee identified by the code.

13. A payment system comprising:
a payor electronic computing device comprising:
a microprocessor for executing instructions;
a display operably connected to the microprocessor;
a memory operably connected to the microprocessor; and
instructions stored in the memory and executable by the microprocessor to:
receive a code uniquely associated with a particular payee;
gather payment source information from a payor via a user interface window displayed via the display of the payor electronic computing device; and
communicate payment instructions to a payment processing system, the payment instructions identifying at least the particular payee identified by the code; and
the payment processing system comprising:
a microprocessor for executing instructions;
a memory operably connected to the microprocessor and storing payee information in association with a payee identification code, and payor funding source information in association with a payor; and
instructions stored in the memory and executable by the microprocessor to:
initiate the payment transaction for transferring funds from a funding source associated with the payor to the particular payee identified by the code.

14. A payment system comprising:
a payor electronic computing device comprising:
a microprocessor for executing instructions;
a display operably connected to the microprocessor;
a memory operably connected to the microprocessor; and
instructions stored in the memory and executable by the microprocessor to:
receive a code uniquely identifying a particular payee;
gather payment amount information from a payor via a user interface window displayed via the display of the payor electronic computing device; and
communicate payment instructions to a payment processing system, the payment instructions identifying at least the payment amount and the particular payee identified by the code; and
the payment processing system comprising:
a microprocessor for executing instructions;
a memory operably connected to the microprocessor and storing payee financial information in association with a payee identification code, and payor funding source information in association with a payor; and
instructions stored in the memory and executable by the microprocessor to:
upon receipt of payment instructions from a payor, to initiate the payment transaction for transferring funds from a funding source associated with the payor to the particular payee identified by the code in the amount identified by the received payment instructions.
